(19) United States
(12) Patent Application Publication
(10) Pub. No.: US 2024/0117984 A1
(43) Pub. Date: Apr. 11, 2024

(54) AIR CONDITIONER, AIR-CONDITIONING SYSTEM, COMMUNICATION SYSTEM, AND DEVICE MANAGEMENT SYSTEM

(71) Applicant: DAIKIN INDUSTRIES, LTD., Osaka (JP)

(72) Inventors: Kousuke TSUBOI, Osaka (JP); Takao SONODA, Osaka (JP); Makoto IKEDA, Osaka (JP); Tetsushi TSUDA, Osaka (JP); Yu OTA, Osaka (JP); Yuuichi KITA, Osaka (JP); Kenji AMANO, Osaka (JP); Atsushi MATSUBARA, Osaka (JP); Tomomi KUKITA, Osaka (JP); Naoko KURIYAMA, Osaka (JP); Tomoyoshi ASHIKAGA, Osaka (JP); Gen KUMAMOTO, Osaka (JP)

(21) Appl. No.: 18/542,371

(22) Filed: Dec. 15, 2023

Related U.S. Application Data
(62) Division of application No. 16/618,826, filed on Dec. 3, 2019.

(30) Foreign Application Priority Data
Jul. 14, 2017 (JP) 2017-138611
Jul. 14, 2017 (JP) 2017-138618
Jul. 14, 2017 (JP) 2017-138619
Jul. 14, 2017 (JP) 2017-138621
Jul. 14, 2017 (JP) 2017-138630
Jul. 14, 2017 (JP) 2017-138631
Jul. 14, 2017 (JP) 2018-138629
Mar. 30, 2018 (JP) 2018-070240

(51) Int. Cl. F24F 11/58; F24F 11/63; F24F 13/20; G05B 19/02

(52) U.S. Cl. CPC F24F 11/58; F24F 11/63; F24F 13/20; G05B 19/02; F24F 2130/40

(57) ABSTRACT

Provided is an air conditioner including an indoor unit provided with a microphone element for receiving voice instructions, such that a voice instruction spoken by an operator is acquired with high quality and control based on the voice instruction spoken by the operator is likely to be ensured. The air conditioner includes an indoor unit, a transmission unit, and a reception unit. The indoor unit has a main body and a microphone element. The main body has formed therein a blow-out port through which air-conditioned air is blown out toward a space to be air-conditioned. The microphone element accepts a voice instruction captured from a voice capturing portion arranged at a position that deviates from a ventilation space through which the air blown out from the blow-out port flows, in such a manner as to face the space to be air-conditioned. The transmission unit transmits the voice instruction accepted by the microphone element to an outside as a signal. The acceptance unit receives a command corresponding to the signal transmitted from the transmission unit from the outside.

### CROSS-REFERENCE TO RELATED APPLICATIONS

This application is a divisional application of U.S. patent application Ser. No. 16/618,826, filed on Dec. 3, 2019, which is a U.S. National stage application of International Application PCT/JP2018/026616, having an international filing date of Jul. 13, 2018, which claims priority under 35 U.S.C. § 119(a) to Japanese Patent Application Nos. 2017-138611, 2017-138618, 2017-138619, 2017-138621, 2017-138629, 2017-138630, 2017-138631, filed in Japan on Jul. 14, 2017, and 2018-070240, filed in Japan on Mar. 30, 2018, the entire contents of which are hereby incorporated herein by reference.

### TECHNICAL FIELD

The present disclosure relates to an air conditioner, an air-conditioning system, a communication system, and a device management system.

### BACKGROUND ART

As disclosed in Japanese Laid-open Patent Publication No. H2-171098, an apparatus is known that enables operation of devices by voice. Japanese Laid-open Patent Publication No. H2-171098 relates to a remote control apparatus that remotely controls devices by voice.

### SUMMARY

An air conditioner according to a first aspect includes an indoor unit having a main body. The main body has formed therein a blow-out port through which air-conditioned air is blown out toward a space to be air-conditioned. The air conditioner includes an operation unit, a cable unit, a transmission unit, a reception unit, and an air conditioner control unit. The operation unit has a voice acceptance section. The voice acceptance section accepts input of a voice instruction. The operation unit is arranged outside the main body. The cable unit communicably connects the indoor unit and the operation unit to each other. The transmission unit transmits a signal that is based on the voice instruction accepted by the voice acceptance section to an outside. The reception unit receives from the outside a command corresponding to the signal transmitted from the transmission unit. The air conditioner control unit controls an operation of the air conditioner in accordance with the command.

In the air conditioner according to the first aspect, an operation unit used for operation via voice is externally attached to the indoor unit, and a command is generated outside the air conditioner in accordance with a voice instruction. Thus, it is easy to change addition/non-addition of a voice-activated operation function to the air conditioner in accordance with the need of the user. Since the operation unit is an externally attached device, it is also easy to add a voice-activated operation function to an already-installed air conditioner having no voice-activated operation function.

In the air conditioner, furthermore, since the operation unit is externally attached to the indoor unit, the operation unit is arranged flexibly. This ensures that the voice acceptance section is likely to accept an instruction given by the user, regardless of the arrangement location or the like of the indoor unit (for example, even when the arrangement location of the indoor unit and a location where the user of the air conditioner performs main activities are away from each other).

In the air conditioner, furthermore, the indoor unit and the operation unit are connected via wired connection, and thus it is likely that the signal is exchanged between these units with certainty.

Preferably, the operation unit includes a notification unit. The notification unit provides notification of acceptance of a voice instruction by the voice acceptance section.

The notification unit that provides notification of acceptance of a voice instruction by the voice acceptance section can be implemented as any of various types of notification devices such as a speaker that provides notification by sound, a light that provides notification by using light, a vibrator that provides notification by vibration, and a display that provides notification by an image (including text). The operation unit provided with the notification unit allows a user to recognize that voice is accepted by the voice acceptance section.

An air-conditioning system according to a second aspect includes an air conditioner having a controller, and a voice acceptance unit. The voice acceptance unit has a voice acceptance section and a first information transmission unit. The voice acceptance section accepts a voice instruction for the air conditioner. The first information transmission unit transmits first information corresponding to the voice instruction accepted by the voice acceptance section to the controller via wireless communication. The controller has a first information reception unit, a processing unit, a second information transmission unit, a command receiving unit, and an air conditioner control unit. The first information reception unit receives the first information transmitted from the first information transmission unit. The processing unit executes specific processing on the first information accepted by the first information reception unit to generate second information having a smaller information amount than the first information. The second information transmission unit transmits the second information to an outside. The command receiving unit receives from the outside a command corresponding to the second information transmitted from the second information transmission unit. The air conditioner control unit controls an operation of the air conditioner in accordance with the command.

In the air-conditioning system, the second information based on the voice instruction is transmitted to the outside, and the command based on the transmitted second information is given from the outside. That is, the air-conditioning system eliminates the need for the air conditioner or the voice acceptance unit to recognize a voice instruction and generate a command for controlling the air conditioner on the basis of the recognition result. Accordingly, an air-conditioning system that enables an air conditioner to be operated via voice is likely to be achieved at low cost.

In the air-conditioning system, furthermore, the controller of the air conditioner generates the second information having a small information amount suitably for communication from the first information transmitted from the voice acceptance unit, and transmits the second information to the outside. Thus, the voice acceptance unit is only required to have simple functions, and the voice acceptance unit (voice-activated remote control) is likely to be achieved at low cost. Accordingly, for example, even if voice acceptance units are provided at a plurality of locations to enhance convenience, the air-conditioning system is likely to be achieved at low cost.

A communication system according to a third aspect includes a transmission apparatus and a reception apparatus. The transmission apparatus has a voice acceptance section, a text conversion unit, a transmission unit, and a switching unit. The voice acceptance section accepts input of voice. The text conversion unit converts the voice accepted by the voice acceptance section into a text data format. The transmission unit transmits data that is based on the voice accepted by the voice acceptance section via a communication line. The switching unit switches a format of the data transmitted from the transmission unit between a voice data format and the text data format. The reception apparatus has a reception unit. The reception unit receives the data transmitted from the transmission unit of the transmission apparatus.

In the communication system, the data format of data, which is based on input voice, transmitted from the transmission apparatus to the reception apparatus, can be switched between a voice data format and a text data format. In the communication system, accordingly, when traffic is high, the data based on the input voice can be switched to the text data format having a smaller data amount than the voice data format and can be transmitted. Therefore, occurrence of communication failure can be reduced regardless of the state of traffic of the communication line.

In addition, here, voice is input to the transmission apparatus. Thus, compared with input of a code selected from a vocabulary list, desired information can be transmitted from the transmission apparatus to the reception apparatus without time and labor.

In addition, here, data can also be transmitted in voice data format from the transmission apparatus, i.e. the data format available for transmission is not limited to the text data format. Thus, when traffic is low, data can be transmitted in voice data format to the reception apparatus side, providing high convenience.

A device management system according to a fourth aspect manages a first device having a first sound output unit that outputs a sound, and a second device different from the first device and having a second sound output unit that outputs a sound. The device management system includes a determination unit and a sound output control unit. The determination unit determines a positional relationship between the first device and the second device. The sound output control unit controls on/off of sound output or an output sound volume of at least one of the first device and the second device based on a determination result of the determination unit.

Here, the output of sounds does not include the output of meaningless sounds (noise). The sounds also include voice (verbal sounds).

In the device management system, in accordance with the positional relationship between the first device and the second device, on/off control of output of sound or control of the sound volume of at least one device is performed. Thus, failures, such as sounds output from both devices being overlapped and noisy, or the sound output from each of the devices being difficult to hear, can be less likely to occur.

### BRIEF DESCRIPTION OF THE DRAWINGS

FIG. 1 is a schematic configuration diagram of a device control system including an air conditioner according to a first embodiment. An operation unit for the air conditioner is an example of an operation apparatus for an air conditioner.

FIG. 2 is a schematic block diagram of the device control system of FIG. 1. In FIG. 2, some of the components of the device control system are not depicted.

FIG. 3A is a schematic diagram of how a main body and an operation unit (operation apparatus) of a wall-mounted indoor unit of the air conditioner of FIG. 1 are installed.

FIG. 3B is a schematic diagram of how a main body and an operation unit (operation apparatus) of a ceiling-embedded indoor unit of an air conditioner according to another example are installed.

FIG. 4 is a schematic configuration diagram of a device control system including air-conditioning system/air conditioner according to a second embodiment.

FIG. 5 is a schematic block diagram of the device control system of FIG. 4. In FIG. 5, some of the components of the device control system are not depicted.

FIG. 6 is a schematic configuration diagram of a device operation/communication system, which is an example of a communication system according to a third embodiment.

FIG. 7 is a schematic block diagram of the device operation/communication system of FIG. 6. In FIG. 7, some of the components of the device operation/communication system are not depicted.

FIG. 8 is a schematic configuration diagram of a device system including a device management system according to a fourth embodiment.

FIG. 9 is a schematic block diagram of the device system of FIG. 8. In FIG. 9, some of the components of the device system are not depicted.

FIG. 10A is an example of positional-relationship-related information stored in a storage unit of a operation device in the device management system of FIG. 8.

FIG. 10B is another example of the positional-relationship-related information stored in the storage unit of the operation device in the device management system of FIG. 8.

FIG. 11 is an example of sound-output items stored in the storage unit of the operation device in the device management system of FIG. 8.

FIG. 12 is a schematic block diagram of a device system including a device management system according to Modification 7A.

FIG. 13 is a schematic block diagram of a device system including a device management system according to a fifth embodiment. In FIG. 13, some of the components of the device system are not depicted.

### DESCRIPTION OF EMBODIMENTS

The following describes embodiments with reference to the drawings. The configuration of each of the following embodiments may be combined with the configuration of any other embodiment or the configuration of any modification as appropriate so long as consistency is maintained between them.

Before explaining the embodiments, devices of the first device group 1050, 2050 and 3050 and devices of the second device group 1060, 2060 and 3060 in the first to third embodiments are explained.

(1) First Device Group

The devices 1050a, 1050b, . . . , and 1050n in the first device group 1050, the devices 2050a, 2050b, . . . , and 2050n in the first device group 2050, the devices 3050a, 3050b, . . . , and 3050n in the first device group 3050 (referring to “the devices in the first device group” as follows) are devices that can be operated using infrared signals. The devices in the first device group include, for example, but not limitation, an electric fan, a lighting device, and an audio device. The devices in the first device group may not be connected to the network 1080, 2080, 3080.

The devices in the first device group are devices that can be operated using infrared signals transmitted from the infrared output device 1040, 2040, 3040 in response to input of voice instructions to the microphone elements. Operations available by infrared signals include, for example, turning on/off the devices in the first device group, changing the level of ventilation in the case of an electric fan, changing the brightness in the case of a lighting device, and changing the volume level in the case of an audio device.

The devices in the first device group may be configured to be operable with a typical infrared remote control or switches on the main bodies of the devices in the first device group, in addition to operation via voice (in addition to operation using infrared signals transmitted from the infrared output device 1040, 2040, 3040 in response to input of voice instructions).

(2) Second Device Group

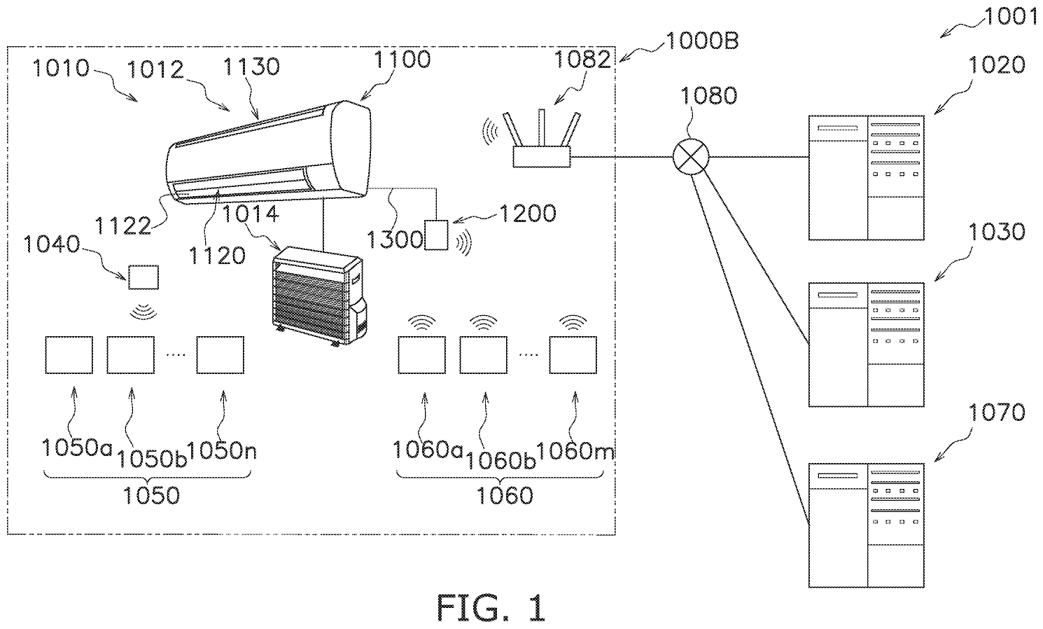

The devices 1060a, 1060b, . . . , and 1060m in the second device group 1060, the devices 2060a, 2060b, . . . , and 2060n in the second device group 2060, the devices 3060a, 3060b, . . . , and 3060n in the second device group 3060 (referring to “the devices in the second device group” as follows) are devices that can be operated using signals transmitted via the network 1080, 2080, 3080. The devices in the second device group include, for example, but not limitation, a television set and a DVD recorder. The devices in the second device group each have a wireless LAN adapter (not illustrated) and are connected to the network 1080, 2080, 3080 via the router 1082, 2082, 3082 (see FIG. 1). The devices in the second device group are communicably connected to at least one of the analysis server 1020, 2020, 3020 and the device server 1070, 2070, 3070 via the network 1080, 2080, 3080 (see FIG. 1). The devices in the second device group and the router 1082, 2082, 3082 may be connected via a wired LAN, rather than via a wireless LAN.

The devices in the second device group are operated using signals transmitted from the analysis server 1020, 2020, 3020 or the device server 1070, 2070, 3070 in response to input of voice instructions to the microphone elements. Operations available by signals transmitted from the analysis server 1020, 2020, 3020 or the device server 1070, 2070, 3070 include, for example, turning on/off the devices in the second device group, changing the channel or volume level of a television set, and setting a programmed recording on a DVD recorder.

The devices in the second device group may be configured to be operable with a commonly available remote control or switches on the main bodies of the devices in the second device group, in addition to operation via voice (in addition to operation by signals transmitted via the network 1080, 2080, 3080 in response to input of voice instructions).

### First Embodiment

The following describes an air conditioner 1010 according to a first embodiment with reference to the drawings. The following also describes an embodiment of an operation apparatus for an air conditioner with reference to the drawings. An operation unit 1200 for the air conditioner 1010 is an example of a control apparatus for an air conditioner.

(1) Overview of Device Control System

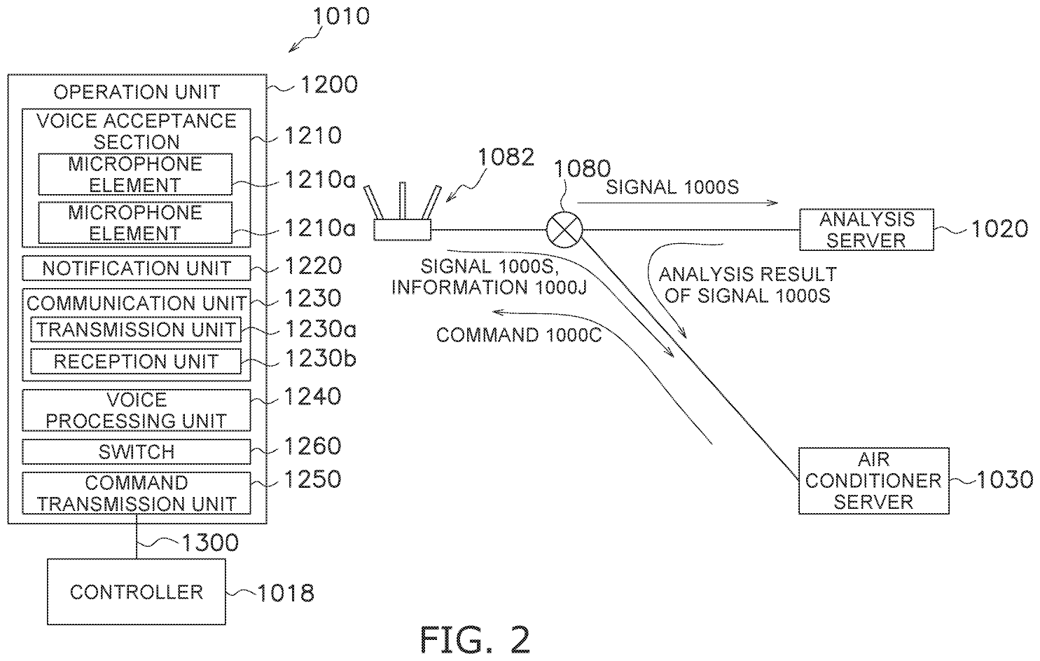

First, a device control system 1001 including the air conditioner 1010 will be described with reference to FIG. 1 and FIG. 2.

FIG. 1 is a schematic configuration diagram of the device control system 1001 including the air conditioner 1010. FIG. 2 is a schematic block diagram of the device control system 1001. In FIG. 2, some of the components of the device control system 1001 are not depicted.

The device control system 1001 is a system that controls the air conditioner 1010 using instructions given by an operator by voice. Further, the device control system 1001 is a system that controls devices 1050a, 1050b, . . . , and 1050n included in a first device group 1050 and devices 1060a, 1060b, . . . , and 1060m included in a second device group 1060 described below using instructions given by an operator by voice.

The device control system 1001 mainly includes the air conditioner 1010, the first device group 1050, the second device group 1060, an infrared output device 1040, an analysis server 1020, an air conditioner server 1030, and a device server 1070 (see FIG. 1).

The air conditioner 1010, the first device group 1050, the second device group 1060, and the infrared output device 1040 are devices arranged in a building 1000B (see FIG. 1). The building 1000B is, for example, but not limited to, a detached house. The building 1000B may be an office building, a commercial facility, a factory, or the like. The analysis server 1020, the air conditioner server 1030, and the device server 1070 are generally, but not limited to, installed in locations different from the building 1000B.

FIG. 1 depicts one building 1000B in which the air conditioner 1010, the first device group 1050, and the second device group 1060, whose operations are controlled by the device control system 1001, are arranged. However, a plurality of buildings 1000B may be used. That is, the device control system 1001 may be a system that controls the operation of the air conditioners 1010, the first device groups 1050, and the second device groups 1060 arranged in each of the plurality of buildings 1000B. For simplicity of description, it is assumed here that a single building 1000B is used.

Further, the number of air conditioners 1010, the number of devices in the first device group 1050, the number of devices in the second device group 1060, and the number of infrared output devices 1040, which are arranged in the building 1000B, are not limited to those depicted in FIG. 1, and may be each one or more. The following description is made assuming that one air conditioner 1010 and one infrared output device 1040 are arranged in the building 1000B and the first device group 1050 and the second device group 1060 arranged in the building 1000B each include a plurality of devices.

The following further describes the air conditioner 1010, the first device group 1050, the second device group 1060, the infrared output device 1040, the analysis server 1020, the air conditioner server 1030, and the device server 1070.

(1-1) Air Conditioner

The air conditioner 1010 mainly has an indoor unit 1012, an outdoor unit 1014, a connection pipe (not illustrated) that connects the indoor unit 1012 and the outdoor unit 1014 to each other, a controller 1018, the operation unit 1200, and a cable unit 1300 (see FIG. 1 and FIG. 2). The air conditioner 1010 is an apparatus that performs air-conditioning of a space to be air-conditioned. The space to be air-conditioned is, for example, a room where the indoor unit 1012 is arranged in the building 1000B.

The air conditioner 1010 is an air conditioner that can be operated by inputting a voice instruction to a voice acceptance section 1210 of the operation unit 1200 described below. Non-limiting examples of the voice instruction include voice such as “turn air conditioning on” and “set the set temperature to 25° C.”. The air conditioner 1010 may be configured to be operable using a typical remote control in addition to operation via voice.

In the device control system 1001, the voice acceptance section 1210 of the operation unit 1200 is configured to be capable of also accepting voice instructions for the devices 1050a, 1050b, . . . , and 1050n in the first device group 1050 and the devices 1060a, 1060b, . . . , and 1060m in the second device group 1060.

The voice-based operations of the air conditioner 1010, the devices 1050a, 1050b, . . . and 1050n in the first device group 1050, and the devices 1060a, 1060b, . . . , and 1060m in the second device group 1060 will be described below.

In the air conditioner 1010, the indoor unit 1012 and the outdoor unit 1014 are connected to each other via the connection pipe, thereby connecting an indoor heat exchanger (not illustrated) of the indoor unit 1012 and a compressor, an outdoor heat exchanger, an expansion valve, and the like (not illustrated) of the outdoor unit 1014 to each other via a pipe. Consequently, a refrigerant circuit is formed. In the air conditioner 1010, refrigerant is circulated in the refrigerant circuit, thereby cooling/heating the space where the indoor unit 1012 is installed.

In this embodiment, the air conditioner 1010 is configured such that in the indoor heat exchanger of the indoor unit 1012, refrigerant flowing in the indoor heat exchanger and air in the space to be air-conditioned exchange heat; however, the air conditioner is not limited to such a device. For example, the air conditioner 1010 may be an apparatus configured such that in the indoor heat exchanger of the indoor unit 1012 (fan coil unit), cold water/hot water flowing in the indoor heat exchanger and air in the space to be air-conditioned exchange heat.

The operation of the air conditioner 1010 is controlled by the controller 1018. The controller 1018 includes, for example, a control board (not illustrated) included in the indoor unit 1012 and a control board (not illustrated) included in the outdoor unit 1014. The operation of the components of the indoor unit 1012 is mainly controlled by the control board of the indoor unit 1012, and the operation of the components of the outdoor unit 1014 is mainly controlled by the control board of the outdoor unit 1014. CPUs on the control boards or the like of the indoor unit 1012 and the outdoor unit 1014, which constitute the controller 1018, execute an air conditioning control program to control the operation of the components of the air conditioner 1010 in accordance with a command 1000C or the like described below transmitted from the air conditioner server 1030. That is, the controller 1018 is an example of a control unit that controls the operation of the air conditioner 1010 in accordance with the command 1000C.

The operational principle and the content of the operation of the air conditioner 1010 using a vapor compression refrigeration cycle are widely known to the public and will not be described here. The air conditioner 1010 does not need to be an air conditioner capable of both cooling/heating the space to be air-conditioned, and may be a cooling-only or heating-only air conditioner. The operation unit 1200 is a unit for operating the air conditioner 1010 by voice. The operation unit 1200 is an example of an operation apparatus for the air conditioner 1010. The operation unit 1200 also functions as an operation apparatus used to operate devices (the devices in the first device group 1050 and the second device group 1060) other than the air conditioner 1010. The operation unit 1200 will be described below.

The air conditioner 1010 has a communication unit 1230 for communicating with the analysis server 1020 and the air conditioner server 1030 external to the air conditioner 1010 (see FIG. 2).

In this embodiment, the communication unit 1230 is mounted in the operation unit 1200 for the air conditioner 1010. However, this is not intended to be limiting, and, for example, the communication unit 1230 may be mounted in the indoor unit 1012 or the outdoor unit 1014. Further, the air conditioner 1010 may have a communication unit separate from the indoor unit 1012, the outdoor unit 1014, and the operation unit 1200. However, when a voice-activated operation function described in this embodiment is incorporated in an existing air conditioner having no communication function, it is preferable that the operation unit 1200 have the communication unit 1230.

The air conditioner 1010 (the communication unit 1230) is connected to the analysis server 1020 and the air conditioner server 1030 via a network 1080 (see FIG. 1). The network 1080 is the Internet, here, but may be any other WAN. The air conditioner 1010 is connected to a router 1082 via a wireless LAN, and is connected to the network 1080 via the router 1082 (see FIG. 1). The router 1082 has a WAN-side interface and a LAN-side interface, and interconnects a WAN and a LAN. The air conditioner 1010 and the router 1082 may be connected via a wired LAN, rather than via a wireless LAN.

The network 1080 may be a LAN.

The communication unit 1230 is, for example, a wireless LAN adapter that performs wireless communication with the router 1082. The communication unit 1230 has, as functional units, a transmission unit 1230a that transmits information, and a reception unit 1230b that receives information (see FIG. 2).

The transmission unit 1230a transmits, for example, a signal 1000S that is based on a voice instruction accepted by the voice acceptance section 1210 of the operation unit 1200 described below to the outside (see FIG. 2). In particular, the transmission unit 1230a transmits the signal 1000S that is based on a voice instruction other than a specific voice instruction (the specific voice instruction will be described below) among the voice instructions accepted by the voice acceptance section 1210 to the outside. However, this is not limiting, and the transmission unit 1230a may transmit, for all the voice instructions accepted by microphone elements 1210a, signals 1000S that are based on the voice instructions to the outside.

The transmission unit 1230a transmits the signal 1000S that is based on a voice instruction other than the specific voice instruction among the voice instructions accepted by the voice acceptance section 1210 to the analysis server 1020, which analyzes the signal 1000S. The transmission unit 1230a preferably transmits the signal 1000S that is based on a voice instruction other than the specific voice instruction among the voice instructions accepted by the voice acceptance section 1210 to also the air conditioner server 1030 and the device server 1070. That is, the transmission unit 1230a preferably transmits the signal 1000S to a plurality of addresses (for example, the analysis server 1020 and the air conditioner server 1030).

Here, the signal 1000S is a digital voice signal obtained by subjecting the voice instruction to AD conversion by a voice processing unit 1240 of the operation unit 1200 described below. The signal 1000S may be data obtained by, for example, further compressing the digital voice signal by the voice processing unit 1240 using various voice data compression techniques (such as MP3). Alternatively, the signal 1000S may be data obtained by converting the voice instruction into text (voice-to-text converted data) by the voice processing unit 1240.

Further, the transmission unit 1230a preferably transmits information 1000J on the state quantity for at least one of the air conditioner 1010 and the space to be air-conditioned to the air conditioner server 1030 (see FIG. 2). Non-limiting examples of the state quantity for the air conditioner 1010 include temperatures/pressures of refrigerant measured by sensors (not illustrated) at various locations in the refrigerant circuit, the number of revolutions of an inverter-controlled motor (not illustrated) of the compressor of the outdoor unit 1014, and the opening degree of the expansion valve of the outdoor unit 1014. Non-limiting examples of the state quantity for the space to be air-conditioned include the temperature of the space to be air-conditioned measured by a sensor (not illustrated). The information 1000J on the state quantity for the air conditioner 1010 and the space to be air-conditioned is transmitted from, for example, the controller 1018 for the air conditioner to the operation unit 1200 side, and is transmitted from the transmission unit 1230a.

The reception unit 1230b receives, for example, the command 1000C corresponding to the signal 1000S transmitted from the transmission unit 1230a (in particular, the signal 1000S that is based on a voice instruction for control of the air conditioner 1010) from the outside. More specifically, the reception unit 1230b receives the command 1000C generated on the basis of the result of analysis of the signal 1000S by the analysis server 1020 (in particular, the signal 1000S that is based on a voice instruction for control of the air conditioner 1010). Preferably, the reception unit 1230b receives the command 1000C generated by the air conditioner server 1030 on the basis of the result of analysis of the signal 1000S by the analysis server 1020 (in particular, the signal 1000S that is based on a voice instruction for control of the air conditioner 1010) and on the basis of the information 1000J on the state quantity transmitted from the transmission unit 1230a to the air conditioner server 1030.

The controller 1018 (the control unit for the air conditioner 1010) that controls the operation of the air conditioner 1010 controls the operation of the air conditioner 1010 in accordance with the command 1000C. For example, but not limitation, the command 1000C is related to at least one of turning on/off of the operation of the air conditioner 1010, switching among the operating modes (cooling/heating/dehumidification/ventilation, etc.) of the air conditioner 1010, changing of the set temperature (the target temperature of the space to be air-conditioned), a target value of the number of revolutions of the inverter-controlled motor (not illustrated) of the compressor of the outdoor unit 1014, a target value of the opening degree of the expansion valve of the outdoor unit 1014, and a target value of the number of revolutions of an inverter-controlled fan motor of the indoor unit 1012.

In this embodiment, the reception unit 1230b is disposed in the operation unit 1200. Thus, the operation unit 1200 transmits a signal based on the command 1000C received by the reception unit 1230b to the controller 1018, which controls the operation of the air conditioner 1010, via the cable unit 1300. The signal based on the command 1000C received by the reception unit 1230b may be the signal of the command 1000C or a signal (corresponding to the command 1000C) generated by the operation unit 1200 in accordance with the command 1000C.

The cable unit 1300 is a unit including a communication electric wire that communicably connects the indoor unit 1012 and the operation unit 1200 to each other. In this embodiment, furthermore, the cable unit 1300 also has the function of a power line that supplies electric power to the operation unit 1200 from the indoor unit 1012 side. For example, the cable unit 1300 is a bus-powered USB cable that is supplied with electric power from a USB port (not illustrated) on the indoor unit 1012 side. However, the operation unit 1200 may be supplied with electric power not via the cable unit 1300 but via any other power source line.

(1-2) First Device Group

The devices 1050a, 1050b, . . . , and 1050n in the first device group 1050 are devices that can be operated using infrared signals. The devices 1050a, 1050b, . . . , and 1050n in the first device group 1050 can be operated using infrared signals transmitted from the infrared output device 1040 in response to input of voice instructions to the operation unit 1200.

(1-3) Second Device Group

The devices 1060a, 1060b, . . . , and 1060m in the second device group 1060 are devices that can be operated using signals transmitted via the network 1080. The devices 1060a, 1060b, . . . , and 1060m in the second device group 1060 are operated using signals transmitted from the analysis server 1020 or the device server 1070 in response to input of voice instructions to the operation unit 1200.

(1-4) Analysis Server

The analysis server 1020 is an example of an analysis apparatus.

The analysis server 1020 is connected to the air conditioner 1010 (the communication unit 1230) via the network 1080. When the operation unit 1200 for the air conditioner 1010 accepts a voice instruction, as described above, the transmission unit 1230a of the air conditioner 1010 transmits the signal 1000S that is based on the voice instruction to the analysis server 1020 via the network 1080 (see FIG. 2). Voice instructions accepted by the operation unit 1200 include a voice instruction for control of the air conditioner 1010, voice instructions for control of the devices 1050a, 1050b, . . . , and 1050n in the first device group 1050, and voice instructions for control of the devices 1060a, 1060b, . . . , and 1060m in the second device group 1060. In other words, the analysis server 1020 receives signals 1000S that are based on voice instructions for control of the air conditioner 1010, the devices 1050a, 1050b, . . . , and 1050n, and the devices 1060a, 1060b, . . . , and 1060m.

Further, the analysis server 1020 is communicably connected to the air conditioner server 1030, the device server 1070, and the infrared output device 1040 via the network 1080.

The analysis server 1020 is a computer that executes a program stored in a storage device to analyze the received signal 1000S. Specifically, for example, the analysis server 1020 performs voice recognition of a received voice signal.

The storage device of the analysis server 1020 stores, in addition to the program, for example, a list of devices (the air conditioner 1010, the devices 1050a, 1050b, . . . , and 1050n in the first device group 1050, and the devices 1060a, 1060b, . . . , and 1060m in the second device group 1060) that can be operated by each operation unit 1200. That is, the analysis server 1020 knows which device can be operated by each operation unit 1200. In addition, for the devices 1060a, 1060b, . . . , and 1060m in the second device group 1060, information as to whether the device 1060a, 1060b, . . . , or 1060m to be controlled is a direct control target of the analysis server 1020 (a control target of either of the analysis server 1020 and the device server 1070) is also stored.

The analysis server 1020 analyzes the voice represented by the signal 1000S to determine a feature value for the voice, and generates text information from the feature value by using a voice recognition dictionary stored in the storage device, which includes an acoustic model, a linguistic model, and a pronunciation dictionary. Non-limiting examples of the text information generated by the analysis server 1020 include text information such as “turn the air conditioner on”, “set the set temperature of the air conditioner to 25 degrees”, “turn the lighting device off”, and “turn the television set on”.

When the text information is related to control of the air conditioner 1010 (for example, when the text information includes an air-conditioner-related keyword), the analysis server 1020 transmits the analysis result of the signal 1000S (i.e., the generated text information) to the air conditioner server 1030 via the network 1080 (see FIG. 2).

When the text information is related to control of the device 1050a, 1050b, . . . , or 1050n in the first device group 1050 (for example, when the text information includes a keyword related to the first device group 1050), the analysis server 1020 transmits a command to the infrared output device 1040 to provide an instruction to transmit an infrared signal corresponding to the analysis result of the signal 1000S (i.e., the generated text information). For example, when the text information is information concerning a lighting device included in the devices 1050a, 1050b, . . . , and 1050n in the first device group 1050 (for example, “turn the lighting device off”), the analysis server 1020 transmits a command to the infrared output device 1040 to transmit an infrared signal for instructing the lighting device to turn off. The command directed to the infrared output device 1040 is transmitted from the analysis server 1020 to the infrared output device 1040 via the network 1080.

When the text information is related to control of the device 1060a, 1060b, . . . , or 1060m in the second device group 1060 (for example, when the text information includes a keyword related to the second device group 1060), the analysis server 1020 transmits a command corresponding to the analysis result of the signal 1000S (i.e., the generated text information) to the device 1060a, 1060b, . . . , or 1060m in the second device group 1060. For example, when the text information is information concerning a television set included in the devices 1060a, 1060b, . . . , and 1060m in the second device group 1060 (for example, “turn the television set on”), the analysis server 1020 transmits a command to the television set to provide an instruction to turn on the switch. Commands directed to the devices 1060a, 1060b, . . . , and 1060m in the second device group 1060 are transmitted from the analysis server 1020 to the devices 1060a, 1060b, . . . , and 1060m in the second device group 1060 via the network 1080.

When the text information is related to control of the device 1060a, 1060b, . . . , or 1060m in the second device group 1060 and the device 1060a, 1060b, . . . , or 1060m to be controlled is not a direct control target of the analysis server 1020, the text information is transmitted to the device server 1070 that controls the corresponding device 1060a, 1060b, . . . , or 1060m. Then, a command is transmitted from the device server 1070 to the corresponding device 1060a, 1060b, . . . , or 1060m via the network 1080.

(1-5) Air Conditioner Server

The air conditioner server 1030 is an example of a command generation apparatus.

The air conditioner server 1030 generates the command 1000C on the basis of the result of analysis of the signal 1000S by the analysis server 1020 (i.e., the text information generated by the analysis server 1020), which is transmitted from the analysis server 1020, and on the basis of the information 1000J on the state quantity for at least one of the air conditioner 1010 and the space to be air-conditioned, which is transmitted as appropriate from the transmission unit 1230a of the air conditioner 1010. Then, the air conditioner server 1030 transmits the command 1000C to the reception unit 1230b of the air conditioner 1010 via the network 1080. For example, without limitation, upon receipt of the command “turn the air conditioner on” as text information, the air conditioner server 1030 determines the operation of the components of the air conditioner 1010 on the basis of the current temperature and the like of the space to be air-conditioned, and transmits the command as the command 1000C.

Here, without limitation, the air conditioner server 1030 generates the command 1000C on the basis of the information 1000J in addition to the result of analysis of the signal 1000S by the analysis server 1020. The air conditioner server 1030 may generate the command 1000C on the basis of only the result of analysis of the signal 1000S by the analysis server 1020.

Further, the air conditioner server 1030 accumulates signals 1000S transmitted from the transmission unit 1230a of the air conditioner 1010 and performs various analysis operations by using the signals 1000S.

In this embodiment, without limitation, the device control system 1001 includes the air conditioner server 1030. For example, when the air conditioner 1010 is capable of directly determining the content of the operation on the basis of the result of analysis of the signal 1000S by the analysis server 1020 (i.e., the text information generated by the analysis server 1020), the air conditioner server 1030 may not be disposed. The result of analysis of the signal 1000S by the analysis server 1020 may be transmitted directly to the reception unit 1230b of the air conditioner 1010 as the command 1000C.

(1-6) Device Server

The device server 1070 generates a command for the device 1060a, 1060b, . . . , or 1060m in the second device group 1060 on the basis of the result of analysis of the signal 1000S by the analysis server 1020 (i.e., the text information generated by the analysis server 1020), which is transmitted from the analysis server 1020. Then, the device server 1070 transmits the command to the operation target among the devices 1060a, 1060b, . . . , and 1060m in the second device group 1060 via the network 1080.

In FIG. 1, the number of device servers 1070 is one. However, if there is a plurality of types of the devices 1060a, 1060b, . . . , and 1060m to be operated by the device server 1070 (rather than in accordance with commands from the analysis server 1020), a number of device servers 1070 equal to the number of types are preferably present.

In addition, when all of the devices 1060a, 1060b, . . . , and 1060m are operable with commands from the analysis server 1020, the device server 1070 may not be present.

(1-7) Infrared Output Device

The infrared output device 1040 has a storage unit (not illustrated) that stores an infrared signal pattern for control for each of the devices 1050a, 1050b, . . . , and 1050n in the first device group 1050 or for each of the operations to be performed on the devices 1050a, 1050b, . . . , and 1050n in the first device group 1050. The infrared output device 1040 transmits an infrared signal to the operation target among the devices 1050a, 1050b, . . . , and 1050n in the first device group 1050 in accordance with a command transmitted from the analysis server 1020 by using the infrared signal pattern stored in the storage unit.

(2) Indoor Unit of Air Conditioner

The indoor unit 1012 of the air conditioner 1010 will further be described with reference to the drawings.

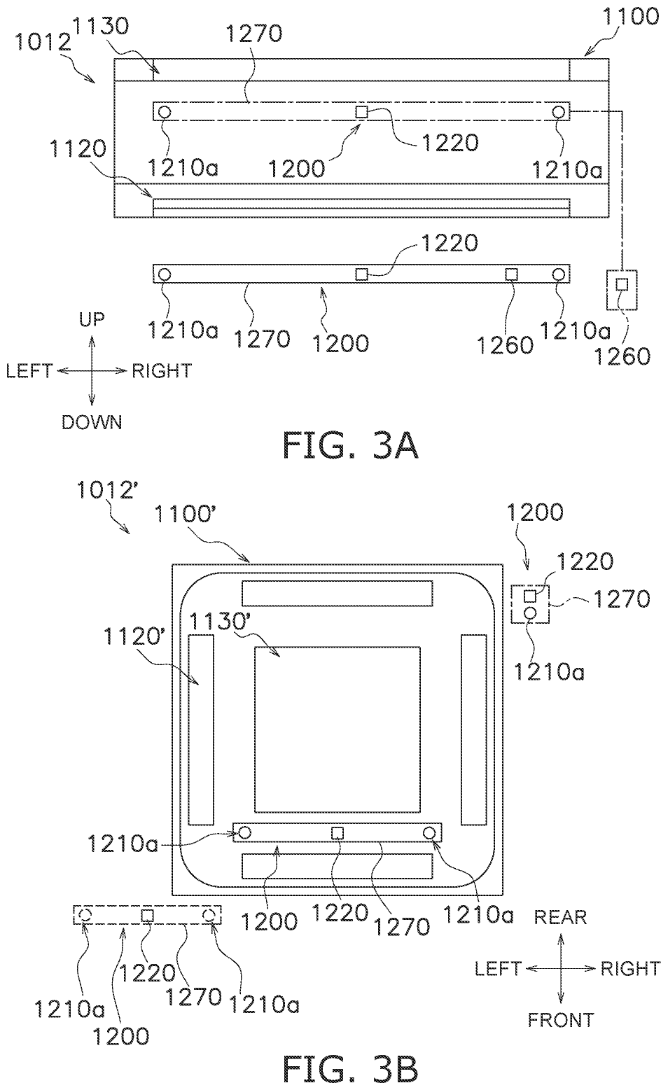

FIG. 3A is a schematic front view of the indoor unit 1012 of the air conditioner 1010. FIG. 3B is a schematic bottom view of an indoor unit 1012′ of another embodiment, which is different in type from the indoor unit 1012. In FIG. 3A and FIG. 3B, the operation unit 1200 for the air conditioner 1010 is also illustrated.

In the following, expressions sometimes used to describe directions or orientations, such as “front (front face)”, “rear (rear face)”, “left”, “right”, “up”, and “down”, are indicated by the arrows in the drawings unless otherwise stated.

The indoor unit 1012 according to this embodiment is of a wall-mounted type.

The indoor unit 1012 has a main body 1100 whose rear side is attached to the wall (see FIG. 1 and FIG. 3A). The main body 1100 is a housing accommodating therein an indoor-side heat exchanger (not illustrated), a fan, and a fan motor.

The main body 1100 has formed therein a blow-out port 1120 and a suction port 1130 (see FIG. 1 and FIG. 3A).

The suction port 1130 is an opening through which air in the space to be air-conditioned is sucked into the main body 1100. The suction port 1130 extends with its longitudinal direction corresponding to the left-right direction in front view (see FIG. 3). The suction port 1130 is formed so as to extend from the top of the front face of the main body 1100 to an upper surface of the main body 1100.

The blow-out port 1120 is an opening through which air-conditioned air is blown out into the space to be air-conditioned. The blow-out port 1120 is formed in a lower portion of the main body 1100. A flap 1122 is arranged in the blow-out port 1120 to adjust the up-down direction of airflow (see FIG. 1).

The type of the indoor unit of the air conditioner is not limited to the wall-mounted type. For example, the air conditioner may use the ceiling-embedded indoor unit 1012′ illustrated in FIG. 3B.

In accordance with another example, without limitation, the indoor unit 1012′ is a unit that blows out air in four directions (see FIG. 3B).

The indoor unit 1012′ has a main body 1100′ (see FIG. 3B). The main body 1100′ is a housing accommodating therein an indoor-side heat exchanger (not illustrated), a fan, and a fan motor. The main body 1100′ has formed therein blow-out ports 1120′ and a suction port 1130′ (see FIG. 3B).

In the main body 1100′, the suction port 1130′ is formed into a square shape (see FIG. 3B). The suction port 1130′ is formed in a center portion of the main body 1100′ in bottom view (see FIG. 3B).

In the main body 1100′, furthermore, the blow-out ports 1120′ are formed at four locations on a lower surface of the main body 1100′. The blow-out ports 1120′ are formed so as to extend along the four sides of the square-shaped main body 1100′ in bottom view in the vicinity of the front edge, the rear edge, the left edge, and the right edge. The blow-out ports 1120′ are formed so as to surround the suction port 1130′ arranged in the center portion of the main body 1100′ in bottom view.

Although not illustrated or described, the indoor unit of the air conditioner may be of a ceiling-suspended type or a floor-mounted type otherwise.

Alternatively, the indoor unit of the air conditioner may be a built-in type unit having a main body that is not exposed to the space to be air-conditioned or is not substantially exposed to the space to be air-conditioned. The main body of a built-in type unit is arranged in the wall or within the ceiling area. For example, the air blown out from a blow-out port in the main body of a built-in type unit is delivered to an opening in the wall surface or the surface of the ceiling through a duct and is blown out to the space to be air-conditioned.

While the following describes the indoor unit 1012 of this embodiment as an example, the indoor unit 1012′ may have a similar configuration.

The main body 1100 accommodates therein a control board (not illustrated) of the indoor unit 1012. The control board of the indoor unit 1012 is communicably connected to the operation unit 1200 by using the cable unit 1300.

The cable unit 1300 may be connected directly to the control board of the indoor unit 1012. Alternatively, the cable unit 1300 may be a USB cable whose USB terminal is connected to the USB port in the indoor unit 1012 to communicably connect the control board of the indoor unit 1012 and the operation unit 1200 to each other.

(3) Operation Unit

The operation unit 1200 is a unit used for operation of the air conditioner 1010 via voice. The operation unit 1200 is also an example of an operation apparatus for the air conditioner 1010.

The operation unit 1200 includes a CPU (not illustrated) that executes various processing operations, and a storage device (not illustrated) that stores a program executed by the CPU and various kinds of information. Further, the operation unit 1200 includes the microphone elements 1210a included in the voice acceptance section 1210, a speaker serving as a notification unit 1220, a voice processing chip that performs various processing operations on voice acquired by the microphone elements 1210a, a wireless LAN adapter that functions as the communication unit 1230, and so on.

The operation unit 1200 is arranged outside the main body 1100 of the indoor unit 1012.

For example, the operation unit 1200 is attached to a wall surface facing the space to be air-conditioned (see the operation unit 1200 indicated by the solid line in FIG. 3A). Alternatively, for example, the operation unit 1200 may be attached on the main body 1100 (to a surface of the main body 1100) (see the operation unit 1200 indicated by the one-dot chain line in FIG. 3A or the operation unit 1200 indicated by the solid line in FIG. 3B). Alternatively, the operation unit 1200 may be attached to the surface of the ceiling facing the space to be air-conditioned (see the operation unit 1200 indicated by the one-dot chain line or broken line in FIG. 3B).

Here, without limitation, the operation unit 1200 is attached to a wall surface near the wall-mounted indoor unit 1012 or is attached on the main body 1100 of the indoor unit 1012 (see FIG. 3A) and the operation unit 1200 is attached to the surface of the ceiling near the ceiling-embedded indoor unit 1012′ or is attached on the main body 1100′ of the indoor unit 1012′. For example, when the wall-mounted indoor unit 1012 is used, the operation unit 1200 may be attached to the surface of the ceiling facing the space to be air-conditioned. For example, when the ceiling-embedded indoor unit 1012′ is used, the operation unit 1200 may be attached to a wall surface facing the space to be air-conditioned.

The operation unit 1200 includes a main body 1270, the voice acceptance section 1210, the notification unit 1220, the communication unit 1230, the voice processing unit 1240, a command transmission unit 1250, and a switch 1260.

(3-1) Main Body

The main body 1270 is a housing of the operation unit 1200 that accommodates therein various components of the operation unit 1200 or that has on a surface thereof various components of the operation unit 1200.

The main body 1270 is formed into, for example, but not limited to, a long and narrow rectangular shape (see the operation units 1200 depicted in FIG. 3A and the operation unit 1200 indicated by the solid line or broken line in FIG. 3B). The main body 1270 extends with its longitudinal direction corresponding to the horizontal direction in such a manner as to be attached on the main body 1100 of the indoor unit 1012 or attached to a wall surface facing the space to be air-conditioned or to the surface of the ceiling.

As indicated by the one-dot chain line in FIG. 3B, for example, the main body 1270 may be formed into a square shape. Alternatively, the main body 1270 may be formed into a polygonal shape other than a rectangular shape, such as a circular shape or an elliptic shape.

As described above, the main body 1270 is preferably attached on the main body 1100 or 1100′ of the indoor unit 1012 or attached to a wall surface facing the space to be air-conditioned or to the surface of the ceiling. For example, the main body 1270 indicated by the solid line in FIG. 3A is attached to a wall surface below the main body 1100. Further, the main body 1270 indicated by the one-dot chain line in FIG. 3A is attached to a front surface of the main body 1100 between the blow-out port 1120 and the suction port 1130. The main body 1270 indicated by the solid line in FIG. 3B is attached to the lower surface of the main body 1100 between one of the blow-out ports 1120′ and the suction port 1130′. The main body 1270 indicated by the one-dot chain line in FIG. 3B is attached to the surface of the ceiling near a corner of the substantially square-shaped main body 1100′. The main body 1270 indicated by the broken line in FIG. 3B is also attached to the surface of the ceiling near a corner of the substantially square-shaped main body 1100′.

To prevent input of voice instructions from being affected by noise, the main body 1270 is preferably arranged such that at least the voice acceptance section 1210 disposed on the main body 1270 is not arranged at a location which is near the blow-out port 1120 or 1120′ of the indoor unit 1012 and to which the air blown out from the blow-out port 1120 or 1120′ is directly applied.

(3-2) Voice Acceptance Section

The voice acceptance section 1210 accepts input of voice instructions to the air conditioner 1010. Further, the voice acceptance section 1210 is configured to be capable of also accepting input of voice instructions to the devices 1050a, 1050b, . . . , and 1050n in the first device group 1050 and the devices 1060a, 1060b, . . . , and 1060m in the second device group 1060.

The voice acceptance section 1210 has the microphone elements 1210a that accept voice instructions.

Like the operation unit 1200 indicated by the one-dot chain line in FIG. 3B, the voice acceptance section 1210 may include a single microphone element 1210a. Note that the number of microphone elements 1210a included in the voice acceptance section 1210 is preferably at least two or more (see the operation units 1200 depicted in FIG. 3A and the operation units 1200 indicated by the solid line and broken line in FIG. 3B).

The arrangement of two or more microphone elements 1210a so that the microphone elements 1210a can easily acquire a voice instruction from different places results in it being likely that the voice acceptance section 1210 acquires the voice instruction with certainty, regardless of the position of the operator (utterer). In addition, the arrangement of two or more microphone elements 1210a so that the microphone elements 1210a can easily acquire a voice instruction from different places allows detection of the position of a person (operator) from a detection result and also allows control of the air conditioner 1010 based on the information.

Like the operation units 1200 depicted in FIG. 3A and the operation units 1200 indicated by the solid line and broken line in FIG. 3B, when the main body 1270 has a shape that extends with its longitudinal direction corresponding to the horizontal direction and two or more the microphone elements 1210a are present, each of the microphone elements 1210a is preferably disposed at least at either end of the operation unit 1200 (the main body 1270) in the longitudinal direction.

(3-3) Notification Unit

The notification unit 1220 is, here, a speaker.

The notification unit 1220 mainly provides notification that a voice instruction is accepted by the voice acceptance section 1210. Specifically, for example, when the voice acceptance section 1210 accepts a voice instruction, the notification unit 1220 produces a spoken sentence, such as “voice has been accepted”, or repeats the accepted voice instruction to provide notification of acceptance of the voice instruction by the voice acceptance section 1210. Alternatively, the notification unit 1220 may be configured to, when the air conditioner 1010 executes various operations, provide notification of the content of the operations (for example, a text such as “the operation starts”). Alternatively, the notification unit 1220 may be configured to, when the devices in the first device group 1050 and the second device group 1060 execute various operations, provide notification of the content of the operations.

The speaker serving as the notification unit 1220 does not need to provide notification by producing a spoken sentence or word, and may provide notification by using a beep sound or the like.

The notification unit 1220 may not be a speaker. For example, the notification unit 1220 can be implemented as any other type of notification device such as a light that provides notification by using light, a vibrator that provides notification by vibration, or a display that displays information. The operation unit provided with the notification unit allows a user to recognize that voice is accepted by the voice acceptance section.

(3-4) Communication Unit

The communication unit 1230 is, for example, a wireless LAN adapter that performs wireless communication with the router 1082. The communication unit 1230 may be a network adapter or the like that is connected to the router 1082 via a wired LAN. The communication unit 1230 has, as functional units, the transmission unit 1230a that transmits information and the reception unit 1230b that receives information (see FIG. 2). The communication unit 1230 including the transmission unit 1230a and the reception unit 1230b has already been described and will not be described.

(3-5) Voice Processing Unit

The voice processing unit 1240 processes a voice instruction accepted by the microphone elements 1210a of the voice acceptance section 1210 to generate the signal 1000S. Further, the voice processing unit 1240 recognizes only a specific voice instruction among voice instructions accepted by the microphone elements 1210a and generates a predetermined command 1000C0. The voice processing unit 1240 is, for example, an integrated circuit that executes these functions.

The voice processing unit 1240 performs AD conversion on a voice instruction to generate a digital voice signal that is an example of the signal 1000S. Preferably, the voice processing unit 1240 further performs voice compression on the voice instruction subjected to AD conversion using various voice data compression techniques (such as MP3) to generate the signal 1000S. In another embodiment, the voice processing unit 1240 may convert a voice instruction into text to generate the signal 1000S (voice instruction-to-text converted data).

The transmission unit 1230a transmits the signal 1000S generated by the voice processing unit 1240 (for example, a voice instruction subjected to voice compression processing by the voice processing unit 1240) to the outside (such as the analysis server 1020).

The specific voice instruction recognized by the voice processing unit 1240 is voice for, for example, requesting the operation unit 1200 to prepare to input the next voice instruction. The predetermined command 1000C0 includes, for example, a command for requesting the voice acceptance section 1210 to accept the subsequent voice instruction. Further, the predetermined command 1000C0 includes, for example, a command for requesting the transmission unit 1230a of the communication unit 1230 to prepare to transmit the signal 1000S that is based on a voice instruction (accepted subsequently to the specific voice instruction), other than the specific voice instruction, among the voice instructions accepted by the voice acceptance section 1210.

The specific voice instruction may not be voice for requesting the operation unit 1200 to prepare to input the next voice instruction. For example, the specific voice instruction may be voice for requesting execution of the basic operation (for example, turning on/off) of the air conditioner 1010, and the predetermined command 1000C0 generated in accordance with the specific voice instruction may be a command for requesting the controller 1018 to start/stop the operation of the air conditioner 1010. The signal 1000S that is based on a voice instruction for requesting execution of an operation of the air conditioner 1010, other than the basic operation, may be transmitted to the outside (the analysis server 1020).

In this embodiment, without limitation, the voice processing unit 1240 is disposed in the operation unit 1200. For example, the voice processing unit 1240 may be disposed in the indoor unit 1012 of the air conditioner 1010.

(3-6) Switch

The switch 1260 is a switch for switching the operating state of the voice acceptance section 1210.

For example, the switch 1260 is disposed on the main body 1270 (see the operation unit 1200 indicated by the solid line in FIG. 3A).

When the main body 1270 is disposed at a position that is out of a person's reach (for example, in a high place), the switch 1260, which is separate from the main body 1270 having the voice acceptance section 1210, may be placed at a position away from the main body 1270 (see the operation unit 1200 indicated by the one-dot chain line in FIG. 3A). While the switch 1260 is not illustrated in FIG. 3B, the main body 1270 is assumed to be placed near the ceiling in FIG. 3B, and the switch 1260 is thus arranged at a position away from the main body 1270 (for example, on the wall surface), for example. When the switch 1260 is placed at a position away from the main body 1270, the switch 1260 is communicably connected to the main body 1270 side via wired or wireless connection.

The switch 1260 is a push button switch, but this is not limiting. By pressing the switch 1260, the operating state of the voice acceptance section 1210 is switched between a sleep state in which no voice instruction is accepted and an active state in which voice instructions are acceptable.

The operating state of the voice acceptance section 1210 may be switched between the sleep state and the active state each time the switch 1260 is pressed. Alternatively, the operating state of the voice acceptance section 1210 may be switched from the sleep state to the active state for a predetermined time period when the switch 1260 is pressed.

The operation unit 1200 may not have the switch 1260, and the operating state of the voice acceptance section 1210 may be always set to the active state. It is preferable that the operation unit 1200 be provided with the switch 1260 to prevent the voice acceptance section 1210 from accepting voice at an unintended timing (to avoid unintended malfunction of the air conditioner 1010 or the devices in the first device group 1050 and the second device group 1060).

(3-7) Command Transmission Unit

The command transmission unit 1250 transmits various commands to the controller 1018 for the air conditioner 1010. For example, the command transmission unit 1250 transmits a signal based on the command 1000C received by the reception unit 1230b from the air conditioner server 1030 to the controller 1018 for the air conditioner 1010, which controls the operation of the air conditioner 1010, via the cable unit 1300. Further, the command transmission unit 1250 transmits the predetermined command 1000C0 generated by the voice processing unit 1240 to the controller 1018 for the air conditioner 1010, which controls the operation of the air conditioner 1010, via the cable unit 1300, as needed.

(4) Features of Air Conditioner and Operation Unit (Operation Apparatus)

(4-1)

The air conditioner 1010 according to this embodiment includes the indoor unit 1012 having the main body 1100. The main body 1100 has formed therein the blow-out port 1120 through which air-conditioned air is blown out toward the space to be air-conditioned. The air conditioner 1010 includes the operation unit 1200, the cable unit 1300, the transmission unit 1230a, the reception unit 1230b, and the controller 1018, which is an example of an air conditioner control unit. The operation unit 1200 has the voice acceptance section 1210. The voice acceptance section 1210 accepts input of voice instructions. The operation unit 1200 is arranged outside the main body 1100. The cable unit 1300 communicably connects the indoor unit 1012 and the operation unit 1200 to each other. The transmission unit 1230a transmits the signal 1000S that is based on a voice instruction accepted by the voice acceptance section 1210 to the outside. The reception unit 1230b receives the command 1000C corresponding to the signal 1000S transmitted from the transmission unit 1230a from the outside. The controller 1018 controls the operation of the air conditioner 1010 in accordance with the command 1000C.

In the air conditioner 1010 according to this embodiment, the operation unit 1200 used for operation via voice is externally attached to the indoor unit 1012, and the command 1000C is generated outside the air conditioner 1010 in accordance with a voice instruction. Thus, it is easy to change addition/non-addition of a voice-activated operation function to the air conditioner 1010 in accordance with the need of the user. Since the operation unit 1200 is an externally attached device, it is also easy to add a voice-activated operation function to an already-installed air conditioner having no voice-activated operation function.

In the air conditioner 1010, furthermore, since the operation unit 1200 is externally attached to the indoor unit 1012, the operation unit 1200 is arranged flexibly. This ensures that the voice acceptance section 1210 is likely to accept an instruction given by the user, regardless of the arrangement location or the like of the indoor unit 1012 (for example, even when the arrangement location of the indoor unit 1012 and a location where the user of the air conditioner 1010 performs main activities are away from each other).

In the air conditioner 1010, furthermore, the indoor unit 1012 and the operation unit 1200 are connected via wired connection, and thus it is likely that the signal 1000S is exchanged between these units with certainty.

Preferably, the operation unit 1200 includes the notification unit 1220. The notification unit 1220 provides notification of acceptance of a voice instruction by the voice acceptance section 1210.

(4-2)

In the air conditioner 1010 according to this embodiment, the transmission unit 1230a and the reception unit 1230b are mounted in the operation unit 1200.

Here, the operation unit 1200 includes the transmission unit 1230a and the reception unit 1230b in addition to the voice acceptance section 1210 and the notification unit 1220. Thus, it is particularly easy to change addition/non-addition of a voice-activated operation function to the air conditioner 1010 in accordance with the need of the user. In addition, various components necessary for operation via voice are collectively mounted in the operation unit 1200. Thus, it is easy to also add a voice-activated operation function to an already-installed air conditioner having no voice-activated operation function.

(4-3)

In the air conditioner 1010 according to this embodiment, the operation unit 1200 has the switch 1260 that switches the operating state of the voice acceptance section 1210 from a sleep state in which no voice instruction is accepted to an active state in which voice instructions are acceptable.

Here, the operation unit 1200 is provided with the switch 1260 that switches the operating state of the voice acceptance section 1210 to the active state. This makes it easy to activate the voice acceptance section 1210 only when a voice instruction is to be input. In the air conditioner 1010, thus, it is possible to prevent malfunction of the air conditioner 1010 based on voice issued without the intention of instructions.

(4-4)

In the air conditioner 1010 according to this embodiment, the cable unit 1300 has the function of a power line that supplies electric power to the operation unit 1200.

Here, the cable unit 1300 connecting the indoor unit 1012 and the operation unit 1200 also functions as a power line. This enables the operation unit 1200 to function without using a power source extraction port dedicated to the operation unit 1200, and provides high convenience.

(4-5)

In the air conditioner 1010 according to this embodiment, the operation unit 1200 extends with its longitudinal direction corresponding to the horizontal direction, and is disposed on the main body 1100 or on a wall surface or the surface of the ceiling facing the space to be air-conditioned.

Thus, it is possible to realize the air conditioner 1010 that is also excellent aesthetically.

(4-6)

In the air conditioner 1010 according to this embodiment, the voice acceptance section 1210 has at least two microphone elements 1210a. Each of the microphone elements 1210a is disposed at least at either end of the operation unit 1200 in the longitudinal direction.

Here, since each of the microphone elements 1210a is disposed at either end of the operation unit 1200 in the horizontal direction, the voice acceptance section 1210 is likely to accept an instruction given by the user regardless of the position of the user relative to the operation unit 1200.

(4-7)

In the air conditioner 1010 according to this embodiment, the transmission unit 1230a transmits the signal 1000S to the analysis server 1020, which is an example of an analysis apparatus that analyzes the signal 1000S, via the network 1080. The reception unit 1230b receives the command 1000C generated on the basis of the result of analysis of the signal 1000S by the analysis server 1020.

Here, a voice instruction is transmitted to the external analysis server 1020, and the command 1000C is generated on the basis of the result of analysis of the voice instruction. Thus, even if the air conditioner is caused to execute a relatively complex operation, the air conditioner can be operated by voice.

In addition, it is also easy to operate multiple types of devices including the air conditioner 1010 (the devices in the first device group 1050 and the second device group 1060) by voice by using the operation unit 1200.

(4-8)

In the air conditioner 1010 according to this embodiment, the transmission unit 1230a transmits the information 1000J on the state quantity for at least one of the air conditioner 1010 and the space to be air-conditioned to the air conditioner server 1030, which is an example of a command generation apparatus. The reception unit 1230b receives the command 1000C generated by the air conditioner server 1030 on the basis of the result of analysis of the signal 1000S by the analysis server 1020 and on the basis of the information 1000J on the state quantity.

Here, an instruction is given to the air conditioner 1010 on the basis of the result of analysis of a voice instruction and information on the state quantity for the air conditioner 1010 or the space to be air-conditioned. Thus, it is likely that appropriate control based on the voice instruction is executed on the air conditioner 1010.

(4-9)

The air conditioner 1010 according to this embodiment further includes the voice processing unit 1240 that is an example of a voice compression unit that performs voice compression on the voice instruction accepted by the voice acceptance section 1210. The transmission unit 1230a transmits, as the signal 1000S, a voice instruction subjected to voice compression processing by the voice processing unit 1240 to the outside.

Here, a voice instruction is subjected to voice compression and is then transmitted to the outside. Thus, efficient communication can be achieved.

(4-10)

In the air conditioner 1010 according to this embodiment, the transmission unit 1230a transmits the signal 1000S to a plurality of addresses.

Here, a voice accepted by the voice acceptance section 1210 is transmitted to a plurality of addresses. Thus, the acquired voice is available for various processing operations.

(4-11)

The operation unit 1200, which is an example of an operation apparatus according to this embodiment, is the operation unit 1200 for the air conditioner 1010, which is arranged outside the main body 1100 of the indoor unit 1012 of the air conditioner 1010 and is connected to the indoor unit 1012 via the cable unit 1300. The main body 1100 of the indoor unit 1012 has formed therein the blow-out port 1120 through which air-conditioned air is blown out toward the space to be air-conditioned. The operation unit 1200 includes the voice acceptance section 1210, the notification unit 1220, the transmission unit 1230a, the reception unit 1230b, and the command transmission unit 1250. The voice acceptance section 1210 accepts input of a voice instruction to the air conditioner 1010. The notification unit 1220 provides notification of acceptance of the voice instruction by the voice acceptance section 1210. The transmission unit 1230a transmits the signal 1000S that is based on the voice instruction accepted by the voice acceptance section 1210 to the outside. The reception unit 1230b receives the command 1000C corresponding to the signal 1000S transmitted from the transmission unit 1230a from the outside. The command transmission unit 1250 transmits a signal based on the command 1000C received by the reception unit 1230b to the controller 1018 for the air conditioner 1010, which controls the operation of the air conditioner 1010, via the cable unit 1300.

In the operation unit 1200, various components necessary for operation via voice are collectively mounted in the operation unit 1200. This makes it easy to add a voice-activated operation function to the air conditioner 1010 in accordance with the need of the user.

(4-12)

The operation unit 1200 according to this embodiment includes the switch 1260. The switch 1260 switches the operating state of the voice acceptance section 1210 from a sleep state in which no voice instruction is accepted to an active state in which voice instructions are acceptable.

Here, the operation unit 1200 has the switch 1260 that switches the operating state of the voice acceptance section 1210 to the active state, making it easy to activate the voice acceptance section 1210 only when a voice instruction is to be input. This makes it possible to prevent malfunction of the air conditioner 1010 based on voice issued without the intention of instructions.

(4-13)

The operation unit 1200 according to this embodiment is supplied with electric power via the cable unit 1300.

Here, the supply of electric power via the cable unit 1300 connecting the indoor unit 1012 and the operation unit 1200 eliminates the need to use a power source extraction port dedicated to the operation unit 1200, and provides high convenience.

(5) Modifications

The following describes modifications of the embodiment described above. The modifications may be combined as appropriate so long as consistency is maintained between them.

(5-1) Modification 2A

In the embodiment described above, without limitation, the device control system 1001 is a system capable of operating the devices in the first device group 1050 and the second device group 1060 via voice instructions. The device control system 1001 may be a system that does not control the operation of either the first device group 1050 or the second device group 1060 or does not control the operation of the first device group 1050 or the second device group 1060. The device groups 1050 and 1060 that are not operated via voice instructions, and the infrared output device 1040 and the device server 1070, which are required to control the device groups 1050 and 1060, may not be included in the device control system 1001.

(5-2) Modification 2B

In the embodiment described above, without limitation, the analysis server 1020, the air conditioner server 1030, and the device server 1070 in the device control system 1001 are separate servers. For example, one server may function as the analysis server 1020 and the air conditioner server 1030, or function as the analysis server 1020, the air conditioner server 1030, and the device server 1070.

Conversely, the function of each of the analysis server 1020, the air conditioner server 1030, and the device server 1070 described in the above embodiment may be achieved by a plurality of servers rather than by a single server.

Furthermore, in the embodiment described above, without limitation, the signal 1000S transmitted from the transmission unit 1230a is received by the analysis server 1020. For example, the transmission unit 1230a may transmit the signal 1000S to the air conditioner server 1030, and the signal 1000S may be transmitted from the air conditioner server 1030 to the analysis server 1020.

(5-3) Modification 2C

In the embodiment described above, an air conditioner has been described, taking as an example an apparatus that mainly adjusts the temperature or humidity of air; however, the air conditioner is not limited to an apparatus of this type. The air conditioner may be an air cleaner that removes dust particles and the like from air and blows out cleaned air, an air-flow adjustment apparatus that adjusts the flow of air in the space to be air-conditioned, or the like.

### Second Embodiment

The following describes an air-conditioning system 2010a according to a second embodiment and an air conditioner 2010, which is an embodiment of an air conditioner, with reference to the drawings.

(1) Overview of Device Control System

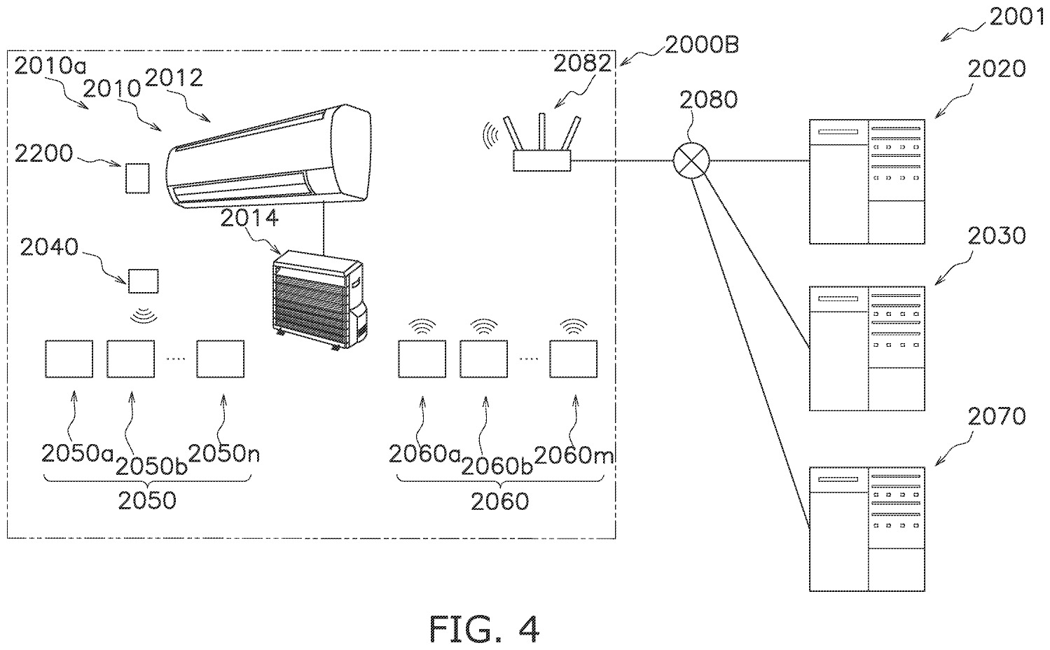

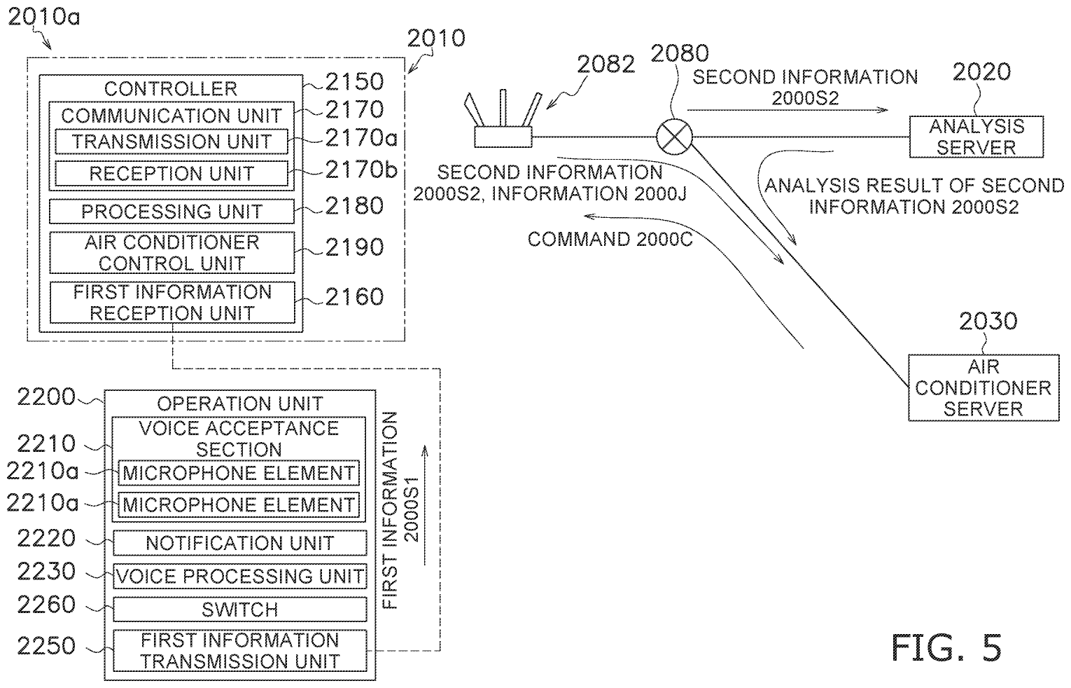

First, a device control system 2001 including the air-conditioning system 2010a will be described with reference to FIG. 4 and FIG. 5.

FIG. 4 is a schematic configuration diagram of the device control system 2001 including the air-conditioning system 2010a. FIG. 5 is a schematic block diagram of the device control system 2001. In FIG. 5, some of the components of the device control system 2001 are not depicted.

The air-conditioning system 2010a forms a portion of the device control system 2001. The air-conditioning system 2010a mainly includes the air conditioner 2010 and an operation unit 2200. The operation unit 2200 is an example of a voice acceptance unit. The operation unit 2200 is used to input a voice instruction to the air conditioner 2010.

The device control system 2001 is a system capable of controlling devices 2050a, 2050b, . . . , and 2050n included in a first device group 2050 and devices 2060a, 2060b, . . . , and 2060m included in a second device group 2060 described below, in addition to the air conditioner 2010, using instructions given by an operator by voice. The device control system 2001 is configured to be capable of operating the devices in the first device group 2050 and the second device group 2060, in addition to the air conditioner 2010, by input of voice instructions to the operation unit 2200 in the air-conditioning system 2010a.

The device control system 2001 mainly includes the air-conditioning system 2010a including the air conditioner 2010, the first device group 2050, the second device group 2060, an infrared output device 2040, an analysis server 2020, an air conditioner server 2030, and a device server 2070 (see FIG. 4).

The air conditioner 2010, the first device group 2050, the second device group 2060, and the infrared output device 2040 are devices arranged in a building 2000B (see FIG. 4). The building 2000B is, for example, but not limited to, a detached house. The building 2000B may be an office building, a commercial facility, a factory, or the like. The analysis server 2020, the air conditioner server 2030, and the device server 2070 are generally, but not limited to, installed in locations different from the building 2000B.

FIG. 4 depicts one building 2000B in which the air conditioner 2010, the first device group 2050, and the second device group 2060, whose operations are controlled by the device control system 2001, are arranged. However, a plurality of buildings 2000B may be used. That is, the device control system 2001 may be a system that controls the operation of the air conditioners 2010, the first device groups 2050, and the second device groups 2060 arranged in each of the plurality of buildings 2000B. For simplicity of description, it is assumed here that a single building 2000B is used.

Further, the number of air conditioners 2010, the number of devices in the first device group 2050, the number of devices in the second device group 2060, and the number of infrared output devices 2040, which are arranged in the building 2000B, are not limited to those depicted in FIG. 4, and may be each one or more. The following description is made assuming that one air conditioner 2010 and one infrared output device 2040 are arranged in the building 2000B and the first device group 2050 and the second device group 2060 arranged in the building 2000B each include a plurality of devices.

In addition, FIG. 4 and FIG. 5 depict only one operation unit 2200, which is included in the air-conditioning system 2010a. However, this is not intended to be limiting, and a plurality of operation units 2200 may be used. For example, the operation units 2200 may be arranged in a plurality of locations in the building 2000B.

The following further describes the air-conditioning system 2010a including the air conditioner 2010, the first device group 2050, the second device group 2060, the infrared output device 2040, the analysis server 2020, the air conditioner server 2030, and the device server 2070.

(1-1) Air-Conditioning System

The air conditioner 2010 and the operation unit 2200 of the air-conditioning system 2010a will be described hereinafter.

(A) Operation Unit

The operation unit 2200 is a unit used for operation of the air conditioner 2010 via voice. The operation unit 2200 is also a unit used for operation of the devices 2050a, 2050b, . . . and 2050n included in the first device group 2050 and the devices 2060a, 2060b, . . . , and 2060m included in the second device group 2060 described below via voice.

For example, the operation unit 2200 is installed in a stationary manner in the building 2000B (for example, fixed to the wall surface or the like). The operation unit 2200 may be a unit having functions described below and used exclusively for input of voice instructions, or may be a device further having other functions (for example, the function of a watch, the function of a music player, etc.).

Alternatively, the operation unit 2200 may be a mobile terminal. Examples of the mobile terminal include, without limitation in type, a smartphone, a mobile phone, a tablet terminal, and a wearable terminal having a voice acceptance section. Specifically, for example, the operation unit 2200 is a wristwatch-type device carried by an operator in such a manner as to be worn around their wrist.

When a plurality of operation units 2200 are used, each of the plurality of operation units 2200 may be different in type from the other operation units 2200.

The operation unit 2200 includes a CPU (not illustrated) that executes various processing operations, and a storage device (not illustrated) that stores a program executed by the CPU and various kinds of information. Further, the operation unit 2200 includes microphone elements 2210a included in a voice acceptance section 2210, a speaker serving as a notification unit 2220, an A/D conversion circuit that performs A/D conversion processing on voice acquired by the microphone elements 2210a, and so on.

The operation unit 2200 has the voice acceptance section 2210, the notification unit 2220, a voice processing unit 2230, a first information transmission unit 2250, and a switch 2260.

(A-1) Voice Acceptance Section

The voice acceptance section 2210 accepts input of a voice instruction to the air conditioner 2010. Further, the voice acceptance section 2210 is configured to be capable of also accepting input of voice instructions to the devices in the first device group 2050 and the second device group 2060.

The voice acceptance section 2210 has the microphone elements 2210a that accept voice instructions. The number of microphone elements 2210a may be one or more (in FIG. 5, two microphone elements 2210a are used).

For example, when the operation unit 2200 is a stationary-type device, a plurality of microphone elements 2210a are used, and the microphone elements 2210a are arranged so as to easily acquire a voice instruction from different places, thereby facilitating reliable acquisition of the voice instruction by the voice acceptance section 2210, regardless of the position of the operator (utterer). In addition, a plurality of microphone elements 2210a are used, and the microphone elements 2210a are arranged so as to easily acquire a voice instruction from different places, thereby allowing detection of the position of a person (operator) from a detection result and also allows control of the air conditioner 2010 based on the information.

(A-2) Notification Unit

The notification unit 2220 is, here, a speaker.

The notification unit 2220 mainly provides notification that a voice instruction is accepted by the voice acceptance section 2210. Specifically, for example, when the voice acceptance section 2210 accepts a voice instruction, the notification unit 2220 produces a spoken sentence, such as “voice has been accepted”, or repeats the accepted voice instruction to provide notification of acceptance of the voice instruction by the voice acceptance section 2210. Alternatively, the notification unit 2220 may be configured to, when the air conditioner 2010 executes various operations, provide notification of the content of the operations (for example, a text such as “the operation starts”). Alternatively, the notification unit 2220 may be configured to, when the devices in the first device group 2050 and the second device group 2060 execute various operations, provide notification of the content of the operations.

The speaker serving as the notification unit 2220 does not need to provide notification by producing a spoken sentence or word, and may provide notification by using a beep sound or the like.

The notification unit 2220 may not be a speaker. For example, the notification unit 2220 can be implemented as any other type of notification device such as a light that provides notification by using light, a vibrator that provides notification by vibration, or a display that provides notification by displaying information. The operation unit provided with the notification unit allows a user to recognize that voice is accepted by the voice acceptance section.

(A-3) Voice Processing Unit

The voice processing unit 2230 is a functional unit that processes a voice instruction accepted by the microphone elements 2210a of the voice acceptance section 2210 to generate first information 2000S1. The voice processing unit 2230 is implemented by, for example, an A/D conversion circuit. The voice processing unit 2230 performs A/D conversion on the voice instruction to generate a digital voice signal that is an example of the first information 2000S1. That is, in an embodiment, the first information 2000S1 is voice information subjected to A/D conversion.

When a voice instruction accepted by the voice acceptance section 2210 is transmitted to a controller 2150 of the air conditioner 2010 as an analog voice signal (i.e., when the first information 2000S1 is analog voice information), the operation unit 2200 may not have the voice processing unit 2230.

(A-4) First Information Transmission Unit

The first information transmission unit 2250 is a transmitter that transmits the first information 2000S1 corresponding to the voice instruction accepted by the voice acceptance section 2210 to the controller 2150 of the air conditioner 2010 via wireless communication.

For example, the first information transmission unit 2250 transmits the first information 2000S1 to the controller 2150 by radio (for example, via Bluetooth (registered trademark) protocol). Alternatively, the first information transmission unit 2250 may transmit the first information 2000S1 to the controller 2150 by using an infrared signal.

(A-5) Switch

The switch 2260 is a switch for switching the operating state of the voice acceptance section 2210.

The switch 2260 is a push button switch, but this is not limiting. By pressing the switch 2260, the operating state of the voice acceptance section 2210 is switched between a sleep state in which no voice instruction is accepted and an active state in which voice instructions are acceptable.

The operating state of the voice acceptance section 2210 may be switched between the sleep state and the active state each time the switch 2260 is pressed. Alternatively, the operating state of the voice acceptance section 2210 may be switched from the sleep state to the active state for a predetermined time period when the switch 2260 is pressed.

The operation unit 2200 may not have the switch 2260, and the operating state of the voice acceptance section 2210 may be always set to the active state. It is preferable that the operation unit 2200 be provided with the switch 2260 to prevent the voice acceptance section 2210 from accepting voice at an unintended timing (to avoid unintended malfunction of the air conditioner 2010 or the devices in the first device group 2050 and the second device group 2060).

(B) Air Conditioner

The air conditioner 2010 is an air conditioner that can be operated by inputting a voice instruction to the voice acceptance section 2210 of the operation unit 2200. Non-limiting examples of the voice instruction include voice such as “turn air conditioning on” and “set the set temperature to 25° C.”. The air conditioner 2010 may be configured to be operable using a typical remote control in addition to operation via voice.

The air conditioner 2010 mainly has an indoor unit 2012, an outdoor unit 2014, a connection pipe (not illustrated) that connects the indoor unit 2012 and the outdoor unit 2014 to each other, and the controller 2150 (see FIG. 4 and FIG. 5). The air conditioner 2010 is an apparatus that performs air-conditioning of a space to be air-conditioned. The space to be air-conditioned is, for example, a room where the indoor unit 2012 is arranged in the building 2000B. The indoor unit 2012 is not limited to any specific type. The indoor unit 2012 of, for example, a wall-mounted type, a ceiling-embedded type, a ceiling-suspended type, a floor-mounted type, a built-in type (in which the main body of the indoor unit 2012 is arranged in the wall or within the ceiling area), or the like is applicable to the air conditioner 2010.

In the air conditioner 2010, the indoor unit 2012 and the outdoor unit 2014 are connected to each other via the connection pipe, thereby connecting an indoor heat exchanger (not illustrated) of the indoor unit 2012 and a compressor, an outdoor heat exchanger, an expansion valve, and the like (not illustrated) of the outdoor unit 2014 to each other via a pipe. Consequently, a refrigerant circuit is formed. In the air conditioner 2010, refrigerant is circulated in the refrigerant circuit, thereby cooling/heating the space where the indoor unit 2012 is installed.

The operational principle and the content of the operation of the air conditioner 2010 using a vapor compression refrigeration cycle are widely known to the public and will not be described here. The air conditioner 2010 does not need to be an air conditioner capable of both cooling/heating the space to be air-conditioned, and may be a cooling-only or heating-only air conditioner. In this embodiment, the air conditioner 2010 is configured such that in the indoor heat exchanger of the indoor unit 2012, refrigerant flowing in the indoor heat exchanger and air in the space to be air-conditioned exchange heat; however, the air conditioner is not limited to such a device. For example, the air conditioner 2010 may be an apparatus configured such that in the indoor heat exchanger of the indoor unit 2012 (fan coil unit), cold water/hot water flowing in the indoor heat exchanger and air in the space to be air-conditioned exchange heat.

Further, the air conditioner is not limited to an apparatus that adjusts the temperature or humidity of air. The air conditioner may be an air cleaner that removes dust particles and the like from air and blows out cleaned air, an air-flow adjustment apparatus that adjusts the flow of air in the space to be air-conditioned, or the like.

(B-1) Controller

The controller 2150 controls the operation of the air conditioner 2010.

Further, the controller 2150 also has a function that enables the air conditioner 2010 to be operated via voice. The controller 2150 enables the air conditioner 2010 to be operated via voice by substantially performing the following processing.

The controller 2150 receives the first information 2000S1 transmitted from the first information transmission unit 2250 of the operation unit 2200. Here, without limitation, the first information 2000S1 is assumed to be voice information (voice digital signal) obtained by subjecting a voice instruction to A/D conversion. Upon receipt of the first information 2000S1, the controller 2150 executes specific processing on the first information 2000S1 to generate second information 2000S2 (the specific processing will be described below). The controller 2150 transmits the generated second information 2000S2 to the outside. Further, from the outside, the controller 2150 receives a command 2000C corresponding to the transmitted second information 2000S2 from the outside. Specifically, the controller 2150 receives the command 2000C from the external air conditioner server 2030 via a network 2080. The controller 2150 executes the command 2000C to control the operation of the air conditioner 2010.

The controller 2150 includes a control board (not illustrated) included in the indoor unit 2012, and a control board (not illustrated) included in the outdoor unit 2014. CPUs on the control boards or the like of the indoor unit 2012 and the outdoor unit 2014, which constitute the controller 2150, execute various programs to execute various processing operations. Further, the controller 2150 includes a receiver that functions as a first information reception unit 2160 described below, a device such as a wireless LAN adapter that functions as a communication unit 2170 described below, an integrated circuit that functions as a processing unit 2180 described below, and so on.

The controller 2150 has, as functional units, the first information reception unit 2160, the communication unit 2170, the processing unit 2180, and an air conditioner control unit 2190. The first information reception unit 2160, the communication unit 2170, the processing unit 2180, and the air conditioner control unit 2190 will be described below.

(B-1-1) First Information Reception Unit

The first information reception unit 2160 is a receiver corresponding to a transmitter serving as the first information transmission unit 2250 of the operation unit 2200. The first information reception unit 2160 receives the first information 2000S1 wirelessly transmitted from the first information transmission unit 2250.

(B-1-2) Communication Unit

The communication unit 2170 is used to allow the controller 2150 to communicate with the analysis server 2020 or the air conditioner server 2030 external to the air conditioner 2010. (see FIG. 5).

The air conditioner 2010 (the communication unit 2170) is connected to the analysis server 2020 and the air conditioner server 2030 via the network 2080 (see FIG. 4). The network 2080 is the Internet, here, but may be any other WAN. The air conditioner 2010 is connected to a router 2082 via a wireless LAN, and is connected to the network 2080 via the router 2082 (see FIG. 4). The router 2082 has a WAN-side interface and a LAN-side interface, and interconnects a WAN and a LAN. The air conditioner 2010 and the router 2082 may be connected via a wired LAN, rather than via a wireless LAN.

The network 2080 may be a LAN.

The communication unit 2170 is, for example, a wireless LAN adapter that performs wireless communication with the router 2082. The communication unit 2170 has, as functional units, a transmission unit 2170a that transmits information, and a reception unit 2170b that receives information (see FIG. 5).

The transmission unit 2170a transmits, for example, the second information 2000S2 to the outside (see FIG. 5). That is, the transmission unit 2170a is an example of a second information transmission unit. The second information 2000S2 is information generated by executing specific processing on the first information 2000S1 received from the operation unit 2200 (the specific processing will be described below). Further, the transmission unit 2170a transmits the second information 2000S2, which is generated by executing specific processing on a piece of first information 2000S1 other than specific instruction information among pieces of first information 2000S1 received from the operation unit 2200 to the outside (the specific instruction information will be described below). However, this is not limiting, and the transmission unit 2170a may transmit the second information 2000S2, which is generated by executing specific processing on all the pieces of first information 2000S1 received from the operation unit 2200, to the outside.

The transmission unit 2170a transmits the second information 2000S2 to the analysis server 2020, which analyzes the second information 2000S2. Further, the transmission unit 2170a preferably transmits the second information 2000S2 also to the air conditioner server 2030 or the device server 2070. That is, the transmission unit 2170a preferably transmits the second information 2000S2 to a plurality of addresses (for example, the analysis server 2020 and the air conditioner server 2030).

Further, the transmission unit 2170a preferably transmits information 2000J on the state quantity for at least one of the air conditioner 2010 and the space to be air-conditioned to the air conditioner server 2030 (see FIG. 5). In other words, the transmission unit 2170a may function as a state-quantity information transmission unit. Non-limiting examples of the state quantity for the air conditioner 2010 include temperatures/pressures of refrigerant measured by sensors (not illustrated) at various locations in the refrigerant circuit, the number of revolutions of an inverter-controlled motor (not illustrated) of the compressor of the outdoor unit 2014, and the opening degree of the expansion valve of the outdoor unit 2014. Non-limiting examples of the state quantity for the space to be air-conditioned include the temperature of the space to be air-conditioned measured by a sensor (not illustrated).

The reception unit 2170b receives, for example, the command 2000C corresponding to the second information 2000S2 transmitted from the transmission unit 2170a (in particular, the second information 2000S2 generated from the first information 2000S1 that is based on a voice instruction for control of the air conditioner 2010) from the outside. That is, the reception unit 2170b is an example of a command reception unit. More specifically, the reception unit 2170b receives the command 2000C, which is generated on the basis of the result of analysis of the first information 2000S1 by the analysis server 2020 (in particular, the second information 2000S2 generated from the first information 2000S1 that is based on a voice instruction for control of the air conditioner 2010). Preferably, the reception unit 2170b receives the command 2000C, which is generated by the air conditioner server 2030 on the basis of the result of analysis of the second information 2000S2 by the analysis server 2020 (in particular, the second information 2000S2 generated from the first information 2000S1 that is based on a voice instruction for control of the air conditioner 2010) and on the basis of the information 2000J on the state quantity, which is transmitted from the transmission unit 2170a to the air conditioner server 2030.

For example, but not limitation, the command 2000C is related to at least one of turning on/off of the operation of the air conditioner 2010, switching among the operating modes (cooling/heating/dehumidification/ventilation, etc.) of the air conditioner 2010, changing of the set temperature (the target temperature of the space to be air-conditioned), a target value of the number of revolutions of the inverter-controlled motor (not illustrated) of the compressor of the outdoor unit 2014, a target value of the opening degree of the expansion valve of the outdoor unit 2014, and a target value of the number of revolutions of an inverter-controlled fan motor of the indoor unit 2012.

(B-2) Processing Unit

The processing unit 2180 recognizes specific instruction information among the accepted pieces of first information 2000S1 and generates a predetermined command 2000C0. Further, the processing unit 2180 executes specific processing on the first information 2000S1 accepted by the first information reception unit 2160 to generate the second information 2000S2. More specifically, the processing unit 2180 executes specific processing on information, which is obtained by removing the specific instruction information from the pieces of first information 2000S1 accepted by the first information reception unit 2160, to generate the second information 2000S2. However, this is not limiting, and the processing unit 2180 may execute specific processing on all the pieces of first information 2000S1 received from the operation unit 2200 to generate the second information 2000S2. In the following, for simplicity of description, the pieces of first information 2000S1 other than the specific instruction information are also referred to simply as the first information 2000S1.

For example, the processing unit 2180 is an integrated circuit that executes the functions described above. Various processing operations may be implemented by hardware processing or software processing.

First, specific processing executed by the processing unit 2180 will be described.

The specific processing is a process for generating, from the first information 2000S1, information (the second information 2000S2) having a smaller data amount than the first information 2000S1. The specific processing is, for example, conversion of the data format of the first information 2000S1.

For example, when the first information 2000S1 is a digital voice signal, the specific processing is voice compression processing. The second information 2000S2 generated by the processing unit 2180 is data obtained by, for example, compressing the first information 2000S1, which is a digital voice signal, by using various voice data compression techniques (such as MP3).

For example, when the first information 2000S1 is an analog voice signal, the specific processing may be A/D conversion, and the generated second information 2000S2 may be a digital voice signal. When the first information 2000S1 is an analog voice signal, the specific processing may be a combination of A/D conversion and voice data compression processing.

For example, when the first information 2000S1 is a digital voice signal, the specific processing may be conversion of the voice signal into text, and the second information 2000S2 may be text-converted data. Here, unlike voice recognition, the conversion into text refers to simply converting voice into text without recognizing the meaning of the voice.

Next, the specific instruction information will be described.

The specific instruction information is the first information 2000S1 corresponding to a specific voice instruction (specific words or phrases) among voice instructions accepted by the voice acceptance section 2210. For example, the specific instruction information is a digital voice signal obtained by subjecting the specific voice instruction to A/D conversion.

For example, the specific voice instruction indicates voice for requesting the controller 2150 or the like to prepare to input the next voice instruction. The predetermined command 2000C0, which is generated by the processing unit 2180 upon recognition of the first information 2000S1 corresponding to the specific voice instruction (specific instruction information) includes, for example, a command for requesting the transmission unit 2170a to prepare to transmit the second information 2000S2 generated on the basis of the first information 2000S1 accepted by the first information reception unit 2160 subsequently to the specific instruction information.

The specific voice instruction may not be voice for requesting the controller 2150 or the like to prepare to input the next voice instruction. For example, the specific voice instruction may be voice for requesting execution of the basic operation (for example, turning on/off) of the air conditioner 2010, and the predetermined command 2000C0 generated in accordance with the specific voice instruction may be a command for requesting the air conditioner control unit 2190 to start/stop the operation of the air conditioner 2010. The second information 2000S2 that is based on a voice instruction for requesting execution of an operation of the air conditioner 2010, other than the basic operation, may be transmitted to the outside (the analysis server 2020, etc.).

(B-3) Air Conditioner Control Unit

The air conditioner control unit 2190 controls the operation of the air conditioner 2010 in accordance with the command 2000C received by the reception unit 2170b, a command from a typical remote control (not illustrated), or the like. For example, the air conditioner control unit 2190 controls the operation of the compressor and expansion valve of the outdoor unit 2014, a fan of the indoor unit 2012, and so on in accordance with the command 2000C received by the reception unit 2170b on the basis of the settings of the air conditioner 2010 (such as the set temperature), values measured by various sensors (not illustrated), and so on.

(1-2) First Device Group

The devices 2050a, 2050b, . . . , and 2050n in the first device group 2050 are devices that can be operated using infrared signals. The devices 2050a, 2050b, . . . , and 2050n in the first device group 2050 can be operated using infrared signals transmitted from the infrared output device 2040 in response to input of voice instructions to the operation unit 2200.

(1-3) Second Device Group

The devices 2060a, 2060b, . . . , and 2060m in the second device group 2060 are devices that can be operated using signals transmitted via the network 2080. The devices 2060a, 2060b, . . . , and 2060m in the second device group 2060 are operated using signals transmitted from the analysis server 2020 or the device server 2070 in response to input of voice instructions to the operation unit 2200.

(1-4) Analysis Server

The analysis server 2020 is an example of an analysis apparatus.

The analysis server 2020 is connected to the air conditioner 2010 (the communication unit 2170) via the network 2080. When the operation unit 2200 of the air conditioner 2010 accepts a voice instruction, the transmission unit 2170a of the air conditioner 2010 transmits the second information 2000S2, which is generated by executing specific processing on the first information 2000S1 corresponding to the voice instruction, to the analysis server 2020 via the network 2080 (see FIG. 5). Voice instructions accepted by the operation unit 2200 include a voice instruction for control of the air conditioner 2010, voice instructions for control of the devices 2050a, 2050b, . . . , and 2050n in the first device group 2050, and voice instructions for control of the devices 2060a, 2060b, . . . , and 2060m in the second device group 2060. In other words, the analysis server 2020 receives the second information 2000S2, which is generated by executing specific processing on the first information 2000S1 corresponding to voice instructions for control of the air conditioner 2010, the devices 2050a, 2050b, . . . , and 2050n, and the devices 2060a, 2060b, . . . , and 2060m.

Further, the analysis server 2020 is communicably connected to the air conditioner server 2030, the device server 2070, and the infrared output device 2040 via the network 2080.

The analysis server 2020 is a computer that executes a program stored in a storage device to analyze the received second information 2000S2. Specifically, for example, the analysis server 2020 performs voice recognition of a received voice signal. Further, the analysis server 2020 may interpret the meaning of received text information.

The storage device of the analysis server 2020 stores, in addition to the program, for example, a list of devices (the air conditioner 2010, the devices 2050a, 2050b, . . . , and 2050n in the first device group 2050, and the devices 2060a, 2060b, . . . , and 2060m in the second device group 2060) that can be operated by each operation unit 2200. That is, the analysis server 2020 knows which device can be operated by each operation unit 2200. In addition, for the devices 2060a, 2060b, . . . , and 2060m in the second device group 2060, information as to whether the device 2060a, 2060b, . . . , or 2060m to be controlled is a direct control target of the analysis server 2020 (a control target of either of the analysis server 2020 and the device server 2070) is also stored.

For example, the analysis server 2020 analyzes the voice represented by the second information 2000S2 to determine a feature value for the voice, and generates text information from the feature value by using a voice recognition dictionary stored in the storage device, which includes an acoustic model, a linguistic model, and a pronunciation dictionary. Non-limiting examples of the text information generated by the analysis server 2020 include text information such as “turn the air conditioner on”, “set the set temperature of the air conditioner to 25 degrees”, “turn the lighting device off”, and “turn the television set on”.

When the generated text information is related to control of the air conditioner 2010 (for example, when the text information includes an air-conditioner-related keyword), the analysis server 2020 transmits the analysis result of the second information 2000S2 (i.e., the generated text information) to the air conditioner server 2030 via the network 2080 (see FIG. 5).

When the text information is related to control of the device 2050a, 2050b, . . . , or 2050n in the first device group 2050 (for example, when the text information includes a keyword related to the first device group 2050), the analysis server 2020 transmits a command to the infrared output device 2040 to provide an instruction to transmit an infrared signal corresponding to the analysis result of the second information 2000S2 (i.e., the generated text information). For example, when the text information is information concerning a lighting device included in the devices 2050a, 2050b, . . . , and 2050n in the first device group 2050 (for example, “turn the lighting device off”), the analysis server 2020 transmits a command to the infrared output device 2040 to transmit an infrared signal for instructing the lighting device to turn off. The command directed to the infrared output device 2040 is transmitted from the analysis server 2020 to the infrared output device 2040 via the network 2080.

When the text information is related to control of the device 2060a, 2060b, . . . , or 2060m in the second device group 2060 (for example, when the text information includes a keyword related to the second device group 2060), the analysis server 2020 transmits a command corresponding to the analysis result of the second information 2000S2 (i.e., the generated text information) to the device 2060a, 2060b, . . . , or 2060m in the second device group 2060. For example, when the text information is information concerning a television set included in the devices 2060a, 2060b, . . . , and 2060m in the second device group 2060 (for example, “turn the television set on”), the analysis server 2020 transmits a command to the television set to provide an instruction to turn on the switch. Commands directed to the devices 2060a, 2060b, . . . , and 2060m in the second device group 2060 are transmitted from the analysis server 2020 to the devices 2060a, 2060b, . . . , and 2060m in the second device group 2060 via the network 2080.

When the text information is related to control of the device 2060a, 2060b, . . . , or 2060m in the second device group 2060 and the device 2060a, 2060b, . . . , or 2060m to be controlled is not a direct control target of the analysis server 2020, the text information is transmitted to the device server 2070 that controls the corresponding device 2060a, 2060b, . . . , or 2060m. Then, a command is transmitted from the device server 2070 to the corresponding device 2060a, 2060b, . . . , or 2060m via the network 2080.

(1-5) Air Conditioner Server

The air conditioner server 2030 is an example of a command generation apparatus.

The air conditioner server 2030 generates the command 2000C on the basis of the result of analysis of the second information 2000S2 by the analysis server 2020 (i.e., the text information generated by the analysis server 2020), which is transmitted from the analysis server 2020, and on the basis of the information 2000J on the state quantity for at least one of the air conditioner 2010 and the space to be air-conditioned, which is transmitted as appropriate from the transmission unit 2170a of the air conditioner 2010. Then, the air conditioner server 2030 transmits the command 2000C to the reception unit 2170b of the air conditioner 2010 via the network 2080. For example, without limitation, upon receipt of the command “turn the air conditioner on” as text information, the air conditioner server 2030 determines the operation of the components of the air conditioner 2010 on the basis of the current temperature and the like of the space to be air-conditioned, and transmits the command as the command 2000C.

Here, without limitation, the air conditioner server 2030 generates the command 2000C on the basis of the information 2000J in addition to the result of analysis of the second information 2000S2 by the analysis server 2020. The air conditioner server 2030 may generate the command 2000C on the basis of only the result of analysis of the second information 2000S2 by the analysis server 2020.

Further, the air conditioner server 2030 accumulates the second information 2000S2 transmitted from the transmission unit 2170a of the air conditioner 2010, and performs various analysis operations by using the second information 2000S2.

In this embodiment, without limitation, the device control system 2001 includes the air conditioner server 2030. For example, when the air conditioner 2010 is capable of directly determining the content of the operation on the basis of the result of analysis of the second information 2000S2 by the analysis server 2020 (i.e., the text information generated by the analysis server 2020), the air conditioner server 2030 may not be disposed. The result of analysis of the second information 200052 by the analysis server 2020 may be transmitted directly to the reception unit 2170b of the air conditioner 2010 as the command 2000C.

(1-6) Device Server

The device server 2070 generates a command for the device 2060a, 2060b, . . . , or 2060m in the second device group 2060 on the basis of the result of analysis of the second information 200052 by the analysis server 2020 (i.e., the text information generated by the analysis server 2020), which is transmitted from the analysis server 2020. Then, the device server 2070 transmits the command to the operation target among the devices 2060a, 2060b, . . . , and 2060m in the second device group 2060 via the network 2080.

In FIG. 4, the number of device servers 2070 is one. However, if there is a plurality of types of the devices 2060a, 2060b, . . . , and 2060m to be operated by the device server 2070 (rather than in accordance with commands from the analysis server 2020), a number of device servers 2070 equal to the number of types are preferably present.

In addition, when all of the devices 2060a, 2060b, . . . , and 2060m are operable with commands from the analysis server 2020, the device server 2070 may not be present.

(1-7) Infrared Output Device

The infrared output device 2040 has a storage unit (not illustrated) that stores an infrared signal pattern for control for each of the devices 2050a, 2050b, . . . , and 2050n in the first device group 2050 or for each of the operations to be performed on the devices 2050a, 2050b, . . . , and 2050n in the first device group 2050. The infrared output device 2040 transmits an infrared signal to the operation target among the devices 2050a, 2050b, . . . , and 2050n in the first device group 2050 in accordance with a command transmitted from the analysis server 2020 by using the infrared signal pattern stored in the storage unit.

(2) Features of Air-Conditioning System and Air Conditioner

(2-1)

The air-conditioning system 2010a according to this embodiment includes the air conditioner 2010 having the controller 2150, and the operation unit 2200, which is an example of a voice acceptance unit. The operation unit 2200 has the voice acceptance section 2210 and the first information transmission unit 2250. The voice acceptance section 2210 accepts a voice instruction for the air conditioner 2010. The first information transmission unit 2250 transmits the first information 2000S1 corresponding to the voice instruction accepted by the voice acceptance section 2210 to the controller 2150 via wireless communication. The controller 2150 has the first information reception unit 2160, the processing unit 2180, the transmission unit 2170a, the reception unit 2170b, and the air conditioner control unit 2190. The first information reception unit 2160 receives the first information 2000S1 transmitted from the first information transmission unit 2250. The processing unit 2180 executes specific processing on the first information 2000S1 accepted by the first information reception unit 2160 to generate the second information 2000S2 having a smaller information amount than the first information 2000S1. The transmission unit 2170a, which is an example of a second information transmission unit, transmits the second information 2000S2 to the outside. The reception unit 2170b, which is an example of a command reception unit, receives the command 2000C corresponding to the second information 2000S2 transmitted from the transmission unit 2170a from the outside. The air conditioner control unit 2190 controls the operation of the air conditioner 2010 in accordance with the command 2000C.

In the air-conditioning system 2010a, the second information 2000S2 based on the voice instruction is transmitted to the outside, and the command 2000C based on the transmitted second information 2000S2 is given from the outside. That is, the air-conditioning system 2010a eliminates the need for the air conditioner 2010 or the operation unit 2200 to recognize a voice instruction and generate a command for controlling the air conditioner 2010 on the basis of the recognition result. Accordingly, the air-conditioning system 2010a that enables the air conditioner 2010 to be operated via voice is likely to be achieved at low cost.

In the air-conditioning system 2010a, furthermore, the controller 2150 of the air conditioner 2010 generates the second information 2000S2 having a small information amount (amount of data to be transmitted) suitably for communication from the first information 2000S1 transmitted from the operation unit 2200, and transmits the second information 2000S2 to the outside. Thus, the operation unit 2200 is only required to have simple functions, and the operation unit 2200 (voice-activated remote control) is likely to be achieved at low cost. Accordingly, for example, even if the operation units 2200 are provided at a plurality of locations to enhance convenience, the air-conditioning system 2010a is likely to be achieved at low cost.

(2-2)

In the air-conditioning system 2010a according to this embodiment, the first information 2000S1 is voice information subjected to A/D conversion.

Here, the operation unit 2200 is only required to have a function of merely performing A/D conversion of voice instructions, and the function required for the operation unit 2200 may be simple. The voice-activated remote control function of the air conditioner 2010 is likely to be achieved at low cost.

(2-3)

In the air-conditioning system 2010a according to this embodiment, the specific processing is format conversion.

Here, through format conversion, the first information 2000S1 can be converted into the second information 2000S2 having a small information amount, which is then transmitted to the outside of the controller 2150. Efficient communication can be achieved between the air-conditioning system 2010a and a component external to the air-conditioning system 2010a.

(2-4)

In the air-conditioning system 2010a according to this embodiment, the operation unit 2200 has the notification unit 2220. The notification unit 2220 provides notification of acceptance of a voice instruction by the voice acceptance section 2210.

The operation unit 2200 provided with the notification unit 2220 enables a user to recognize that voice is accepted by the voice acceptance section 2210. Even when the user operates the air conditioner 2010 in a location where the air conditioner 2010 is not visible, the user is able to recognize that the air conditioner 2010 would have received instructions.

(2-5)

In the air-conditioning system 2010a according to this embodiment, the operation unit 2200 has the switch 2260 that switches the operating state of the voice acceptance section 2210 from a sleep state in which no voice instruction is accepted to an active state in which voice instructions are acceptable.

Here, the operation unit 2200 is provided with the switch 2260 that switches the operating state of the voice acceptance section 2210 to the active state. This makes it easy to activate the voice acceptance section 2210 only when a voice instruction is to be input, and makes it possible to prevent malfunction of the air conditioner 2010 based on voice issued without the intention of instructions.

(2-6)

In the air-conditioning system 2010a according to this embodiment, a mobile terminal may be used as the operation unit 2200.

Here, a mobile terminal (such as a smartphone, a mobile phone, a tablet terminal, or a wearable terminal) having the voice acceptance section 2210, which is possessed by the user, is available as the operation unit 2200, and the voice-activated remote control function of the air conditioner 2010 can be achieved at low cost.

(2-7)

In the air-conditioning system 2010a according to this embodiment, the transmission unit 2170a transmits the second information 2000S2 to the analysis server 2020, which is an example of an analysis apparatus that analyzes the second information 2000S2, via the network 2080. The reception unit 2170b receives the command 2000C generated on the basis of the result of analysis of the second information 2000S2 by the analysis apparatus.

Here, the second information 2000S2 based on the voice instruction is transmitted to the external analysis server 2020, and the command 2000C is generated on the basis of the analysis result of the second information 2000S2. Thus, even when the air conditioner 2010 is caused to execute operation having relatively complex content, the air conditioner 2010 can be operated by voice.

(2-8)

In the air-conditioning system 2010a according to this embodiment, the controller 2150 has the transmission unit 2170a serving as a state-quantity information transmission unit. That is the transmission unit 2170a also functions as a state-quantity information transmission unit. The transmission unit 2170a transmits information on the state quantity for at least one of the air conditioner 2010 and the space to be air-conditioned by the air conditioner 2010 to the air conditioner server 2030, which is an example of a command generation apparatus. The reception unit 2170b receives the command 2000C generated by the air conditioner server 2030 on the basis of the analysis result obtained by the analysis server 2020 and on the basis of the information on the state quantity.

Here, an instruction is given to the air conditioner 2010 on the basis of the analysis result of the second information 2000S2 that is based on a voice instruction and the state quantity for the air conditioner 2010 or the space to be air-conditioned. Thus, it is likely that appropriate control based on the voice instruction is executed on the air conditioner 2010.

(2-9)

In the air-conditioning system 2010a according to this embodiment, the transmission unit 2170a transmits the second information 2000S2 to a plurality of addresses. For example, the transmission unit 2170a transmits the second information 2000S2 to the analysis server 2020 and the air conditioner server 2030.

Here, since the second information 2000S2 is transmitted to a plurality of addresses, the second information 2000S2, which is based on acquired voice, is available for various processing operations.

(2-10)

The air conditioner 2010 according to this embodiment includes the first information reception unit 2160, the processing unit 2180, the transmission unit 2170a, which is an example of a second information transmission unit, the reception unit 2170b, which is an example of a command receiving unit, and the air conditioner control unit 2190. The first information reception unit 2160 receives the first information 2000S1 that is based on a voice instruction accepted by the operation unit 2200 and that is wirelessly transmitted from the operation unit 2200. The processing unit 2180 executes specific processing on the first information 2000S1 accepted by the first information reception unit 2160 to generate the second information 2000S2 having a smaller information amount than the first information 2000S1. The transmission unit 2170a transmits the second information 2000S2 to the outside. The reception unit 2170b receives the command 2000C corresponding to the second information 2000S2 transmitted from the transmission unit 2170a from the outside. The air conditioner control unit 2190 controls the operation of the air conditioner 2010 in accordance with the command 2000C.

In the air conditioner 2010, the second information 2000S2 based on the voice instruction is transmitted to the outside, and the command 2000C based on the transmitted second information 2000S2 is given from the outside. That is, the air conditioner 2010 itself does not need to recognize a voice instruction and generate a command for controlling the air conditioner 2010 on the basis of the recognition result. Accordingly, the air conditioner 2010 that is voice-operable is likely to be achieved at low cost.

Furthermore, the air conditioner 2010 generates the second information 2000S2 having a small information amount suitably for communication from the first information 2000S1 transmitted from the operation unit 2200, and transmits the second information 2000S2 to the outside. Thus, the operation unit 2200, which transmits the first information 2000S1 that is based on a voice instruction to the air conditioner 2010, is only required to have simple functions, and the operation unit 2200 (voice-activated remote control) is likely to be achieved at low cost.

(3) Modifications

The following describes modifications of the embodiment described above. The modifications may be combined as appropriate so long as consistency is maintained between them.

(3-1) Modification 3A

In the embodiment described above, without limitation, the device control system 2001 is a system capable of operating the devices in the first device group 2050 and the second device group 2060 via voice instructions. The device control system 2001 may be a system that does not control the operation of either the first device group 2050 or the second device group 2060 or does not control the operation of the first device group 2050 or the second device group 2060. The device groups 2050 and 2060 that are not operated via voice instructions, and the infrared output device 2040 and the device server 2070, which are required to control the device groups 2050 and 2060, may not be included in the device control system 2001.

(3-2) Modification 3B

In the embodiment described above, without limitation, the analysis server 2020, the air conditioner server 2030, and the device server 2070 in the device control system 2001 are separate servers. For example, one server may function as the analysis server 2020 and the air conditioner server 2030, or function as the analysis server 2020, the air conditioner server 2030, and the device server 2070.

Conversely, the function of each of the analysis server 2020, the air conditioner server 2030, and the device server 2070 described in the above embodiment may be achieved by a plurality of servers rather than by a single server.

Furthermore, in the embodiment described above, without limitation, the second information 2000S2 transmitted from the transmission unit 2170a is received by the analysis server 2020. For example, the transmission unit 2170a may transmit the second information 2000S2 to the air conditioner server 2030, and the second information 2000S2 may be transmitted from the air conditioner server 2030 to the analysis server 2020.

(3-3) Modification 3C

In the embodiment described above, without limitation, the operation unit 2200 is provided with a notification unit. The operation unit 2200 may not have a notification unit in particular.

### Third Embodiment

The following describes a device operation/communication system 3001 according to a third embodiment and operation/communication devices 3200 and 3300 according to an embodiment of a transmission apparatus with reference to the drawings.

(1) General Overview

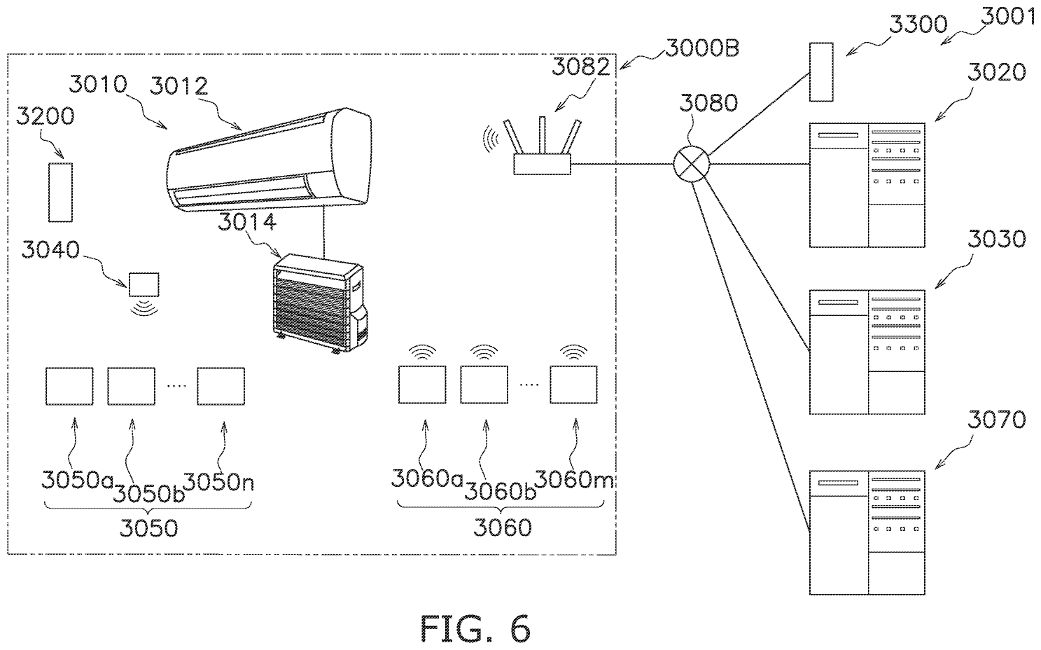

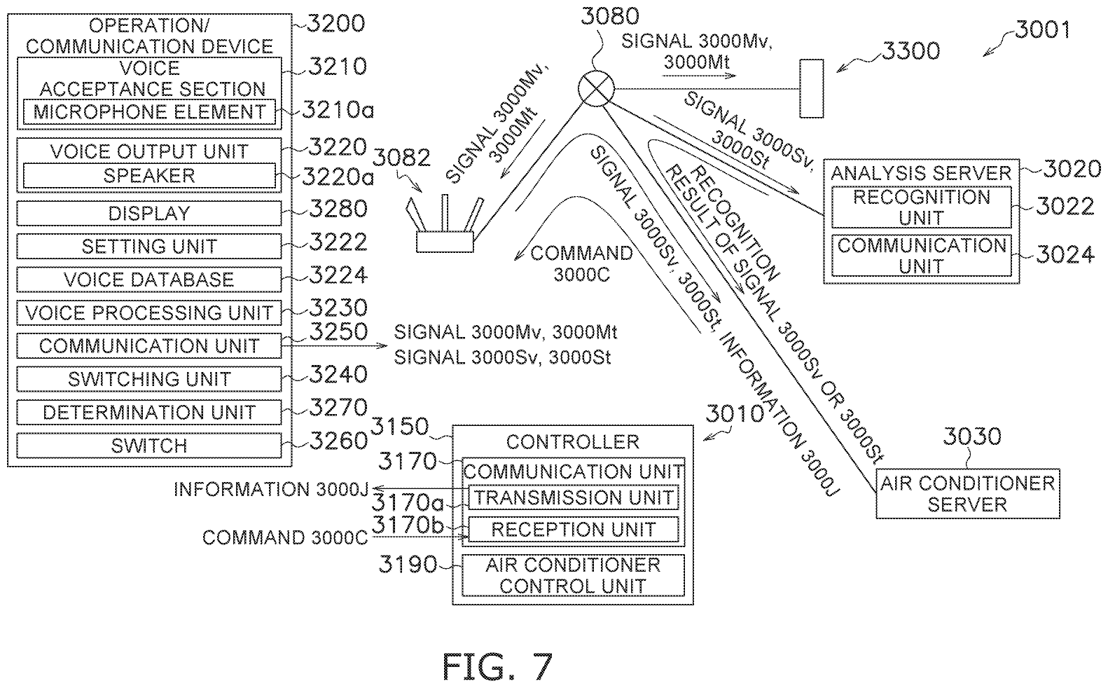

FIG. 6 is a schematic configuration diagram of the device operation/communication system 3001. FIG. 7 is a schematic block diagram of the device operation/communication system 3001. In FIG. 7, some of the components of the device operation/communication system 3001 are not depicted.

The device operation/communication system 3001 mainly includes the operation/communication device 3200, the operation/communication device 3300, an air conditioner 3010, a first device group 3050, a second device group 3060, an infrared output device 3040, an analysis server 3020, an air conditioner server 3030, and a device server 3070 (see FIG. 6 and FIG. 7).

The device operation/communication system 3001 is a system that operates the air conditioner 3010, devices 3050a, 3050b, . . . , and 3050n included in the first device group 3050, and devices 3060a, 3060b, . . . , and 3060m included in the second device group 3060 by instructions given by voice. To enable voice-based operation of devices, the device operation/communication system 3001 functions as a communication system for transmitting data that is based on a voice accepted by the operation/communication devices 3200 and 3300, which are transmission apparatuses, to the analysis server 3020, which is a reception apparatus.

The device operation/communication system 3001 is also a system capable of communication between users of the system. Specifically, the device operation/communication system 3001 is a system capable of communication between the operation/communication device 3200 and the operation/communication device 3300, where each of the operation/communication devices 3200 and 3300 is used as a transmission apparatus/reception apparatus.

In the device operation/communication system 3001 of this embodiment, without limitation, communication can be performed between the operation/communication device 3200 and the operation/communication device 3300. The device operation/communication system 3001 may be a system that functions only as a system for operating the air conditioner 3010, the devices in the first device group 3050, and the devices in the second device group 3060 and that does not allow communication between operation/communication devices.

The air conditioner 3010, the first device group 3050, the second device group 3060, and the infrared output device 3040 are devices arranged in a building 3000B (see FIG. 6). The building 3000B is, for example, but not limited to, a detached house. The building 3000B may be an office building, a commercial facility, a factory, or the like. The analysis server 3020, the air conditioner server 3030, and the device server 3070 are generally, but not limited to, installed in locations different from the building 3000B.

The number of air conditioners 3010, the number of devices in the first device group 3050, the number of devices in the second device group 3060, and the number of infrared output devices 3040, which are arranged in the building 3000B, are not limited to those depicted in FIG. 6, and may be each one or more. The following description is made assuming that one air conditioner 3010 and one infrared output device 3040 are arranged in the building 3000B and the first device group 3050 and the second device group 3060 arranged in the building 3000B each include a plurality of devices.

For simplicity of description, FIG. 6 depicts one building 3000B in which the air conditioner 3010, the first device group 3050, and the second device group 3060, whose operations are controlled by the device operation/communication system 3001, are arranged. However, a plurality of buildings 3000B may be used. That is, the device operation/communication system 3001 may be a system that controls the operation of the air conditioners 3010, the first device groups 3050, and the second device groups 3060 arranged in each of the plurality of buildings 3000B.

The operation/communication device 3200 is installed in the building 3000B and is used to operate the air conditioner 3010, the devices in the first device group 3050, and the devices in the second device group 3060 in the building 3000B. While a single operation/communication device in the building 3000B is depicted, a plurality of operation/communication devices 3200 may be installed in the building 3000B. Further, the operation/communication device 3200 is not limited to a mounted type, and may be a mobile terminal that can be carried outside the building 3000B. In other words, the air conditioner 3010 and the devices in the first device group 3050 and the second device group 3060 may be configured to be operable from outside the building 3000B by using the operation/communication device 3200 that is portable.

The operation/communication device 3300 has a function similar to that of the operation/communication device 3200. For example, the operation/communication device 3300 is installed in a building (not illustrated) different from the building 3000B and is used to operate devices (not illustrated) located in the building. However, this is not limiting, and the operation/communication device 3300 may be a device dedicated to communication with the operation/communication device 3200.

While two operation/communication devices (the operation/communication devices 3200 and 3300) are depicted in FIG. 6 and FIG. 7, the number of operation/communication devices is not limited to two. For example, the device operation/communication system 3001 may have a large number of operation/communication devices.

(2) Detailed Configuration

The operation/communication device 3200, the air conditioner 3010, the first device group 3050, the second device group 3060, the analysis server 3020, the air conditioner server 3030, the device server 3070, and the infrared output device 3040 will be described below.

Since the operation/communication device 3300 is a device similar to the operation/communication device 3200, the operation/communication device 3300 will not be described.

(2-1) Operation/Communication Device

The operation/communication device 3200 is a device used to operate the air conditioner 3010, the devices 3050a, 3050b, . . . , and 3050n included in the first device group 3050 and the devices 3060a, 3060b, . . . , and 3060m included in the second device group 3060. Further, the operation/communication device 3200 is a device used to communicate with the operation/communication device 3300.

The operation/communication device 3200 is an example of a transmission apparatus. The operation/communication device 3200 transmits data that is based on voice accepted by a voice acceptance section 3210 described below to the analysis server 3020 or the operation/communication device 3300 that is an example of a reception apparatus.

Further, the operation/communication device 3200 is an example of a reception apparatus. The operation/communication device 3200 receives data based on voice (data that is based on voice accepted by a voice acceptance section of the operation/communication device 3300), which is transmitted from the operation/communication device 3300 that is an example of a transmission apparatus.

The operation/communication device 3200 is installed in a stationary manner in the building 3000B, for example. For example, the operation/communication device 3200 is placed on a table or shelf or is fixed to the wall surface or the like. The operation/communication device 3200 may be a device that has functions described below and that is used to operate the air conditioner 3010 and the devices in the first device group 3050 and the second device group 3060 and to communicate with any other operation/communication device. Further, the operation/communication device 3200 may be a device having, in addition to the functions described below, other functions (for example, the functions of a watch and a music player).

The operation/communication device 3200 may be a mobile terminal. Examples of the mobile terminal include, without limitation in type, a smartphone, a mobile phone, a tablet terminal, and a wearable terminal having a voice acceptance section. Specifically, for example, the operation/communication device 3200 is a wristwatch-type device carried by an operator in such a manner as to be worn around their wrist.

When a plurality of operation/communication devices 3200 are used in the building 3000B, each of the plurality of operation/communication devices 3200 may be different in type from the other operation/communication devices 3200.

The operation/communication device 3200 includes a CPU that executes various processing operations, and a storage device that stores a program executed by the CPU and various kinds of information. The operation/communication device 3200 further includes a microphone element 3210a included in the voice acceptance section 3210, a speaker 3220a included in a voice output unit 3220, a display 3280, a voice processing chip that performs various processing operations on voice acquired by the microphone element 3210a, a wireless LAN adapter that functions as a communication unit 3250, and so on.

The operation/communication device 3200 has, as functional units, the voice acceptance section 3210, the voice output unit 3220, the display 3280, a setting unit 3222, a voice database 3224, a voice processing unit 3230, a switching unit 3240, a determination unit 3270, the communication unit 3250, and a switch 3260 (see FIG. 7).

(2-1-1) Voice Acceptance Section

The voice acceptance section 3210 accepts input of voice. The voice accepted by the voice acceptance section 3210 includes voice instructions for operating the air conditioner 3010, the devices in the first device group 3050, and the devices in the second device group 3060, and voice for communication (normal conversation) with the user of the operation/communication device 3300.

The voice acceptance section 3210 has the microphone element 3210a that accepts voice. The number of microphone elements 3210a may be one or more.

For example, when the operation/communication device 3200 is a stationary-type device, a plurality of microphone elements 3210a are used, and the plurality of microphone elements 3210a are arranged so as to easily acquire voice from different places, thereby facilitating reliable acquisition of the voice by the voice acceptance section 3210, regardless of the position of the utterer.

The operation/communication device 3200 is preferably provided with an operation section (not illustrated) for designating whether the voice input to the voice acceptance section 3210 is voice directed to the analysis server 3020 (a voice instruction for device operation) or voice directed to the operation/communication device 3300. Preferably, based on the input from the operation section, the communication unit 3250 described below switches the address of the destination of data that is based on the voice accepted by the voice acceptance section 3210 (to be transmitted to the analysis server 3020 or the operation/communication device 3300).

(2-1-2) Voice Output Unit

The voice output unit 3220 is an output unit of voice. The voice output unit 3220 has the speaker 3220a.

The voice output unit 3220 outputs voice from the speaker 3220a, for example, when the communication unit 3250 described below receives data that is based on voice (data similar to a signal 3000Mv or a signal 3000Mt described below) from any other operation/communication device (here, the operation/communication device 3300).

When the communication unit 3250 receives data of a voice data format (data similar to the signal 3000Mv described below) from the operation/communication device 3300, the voice output unit 3220 outputs the data received by the communication unit 3250 from the speaker 3220a after, for example, performing processing for decompressing compressed data, performing D/A conversion processing to convert a digital voice signal into an analog voice signal, and so on.

When the communication unit 3250 receives data of a text data format (data similar to the signal 3000Mt described below) from the operation/communication device 3300, for example, the voice output unit 3220 performs voice conversion processing to convert the data of the text data format accepted by the communication unit 3250 into voice, and outputs the voice-converted data from the speaker 3220a. The voice conversion processing is a process for converting the content of sent text into voice.

For example, also when the voice acceptance section 3210 accepts voice instructions for the air conditioner 3010, the devices in the first device group 3050, and the devices in the second device group 3060, the voice output unit 3220 may output voice to provide notification of acceptance of the voice instructions. Specifically, for example, when the voice acceptance section 3210 accepts a voice instruction, the voice output unit 3220 produces a spoken sentence, such as “voice has been accepted”, or repeats the accepted voice instruction to provide notification of acceptance of the voice instruction by the voice acceptance section 3210.

The voice output unit 3220 may be configured to, when the air conditioner 3010, the devices in the first device group 3050, and the devices in the second device group 3060 to be operated by the operation/communication device 3200 execute various operations, output the content of the operations (for example, a sentence, such as “the operation starts”) via voice.

(2-1-3) Display

The display 3280 is a display unit that displays various kinds of information.

For example, when the communication unit 3250 described below receives data of a text file format (data similar to the signal 3000Mt described below) from any other operation/communication device (here, the operation/communication device 3300), the display 3280 outputs (displays) the content of the received data together with the voice output unit 3220 or instead of the voice output unit 3220.

Alternatively, together with the voice output unit 3220 or instead of the voice output unit 3220, the display 3280 may output (display) that voice instructions for the air conditioner 3010, the devices in the first device group 3050, and the devices in the second device group 3060 are accepted by the voice acceptance section 3210, or output (display) the content of the operations of the air conditioner 3010, the devices in the first device group 3050, and the devices in the second device group 3060 to be operated by the operation/communication device 3200, and so on.

The operation/communication device 3200 may not have the display 3280.

(2-1-4) Setting Unit and Voice Database

The setting unit 3222 sets a voice pattern to be used by the voice output unit 3220. The voice output unit 3220 uses the set voice pattern when the communication unit 3250 outputs data of a text data format which is received from any other operation/communication device (here, the operation/communication device 3300) and which is subjected to voice conversion. The voice pattern refers to a pattern of tone or accent of voice.

The setting unit 3222 sets one voice pattern as a voice pattern to be used by the voice output unit 3220 from among a plurality of voice patterns stored in the voice database 3224 in accordance with a user's selection input from, for example, the operation section (not illustrated) of the operation/communication device 3200. The plurality of voice patterns stored in the voice database 3224 include, for example, male voices, female voices, voices of specific individuals, voices of specific characters, and so on.

The setting unit 3222 may not set a voice pattern to be used by the voice output unit 3220 in accordance with a user's selection. For example, the setting unit 3222 may set a voice pattern to be used by the voice output unit 3220 in the following way.

Here, the voice database 3224 stores a specific voice in association with an operation/communication device with which the operation/communication device 3200 communicates (for example, in association with an identification code for identifying the operation/communication device 3300). For example, the voice database 3224 stores, the voice of the user of the operation/communication device 3300 in association with the operation/communication device 3300. When communication is started between the operation/communication device 3200 and the operation/communication device 3300, the setting unit 3222 identifies the operation/communication device 3300 that is the communication partner of the operation/communication device 3200 (for example, on the basis of data sender information included in a signal transmitted to the communication unit 3250). Then, the setting unit 3222 sets the voice pattern stored in the voice database 3224 in association with the identified operation/communication device 3300 as a voice pattern to be used by the voice output unit 3220.

While the case where the voice database 3224 stores a plurality of voice patterns has been described as an example, the voice database 3224 may store only one voice pattern.

(2-1-5) Voice Processing Unit

The voice processing unit 3230 is an integrated circuit that converts voice accepted by the voice acceptance section 3210 into data suitable for communication. Various processing operations may be implemented by hardware processing or software processing.

The voice processing unit 3230 mainly performs two processing operations.

As one of the processing operations, the voice processing unit 3230 converts voice accepted by the voice acceptance section 3210 into data of a voice data format suitable for communication (first processing operation). As the other processing operation, the voice processing unit 3230 converts voice accepted by the voice acceptance section 3210 into data of a text data format (second processing operation). Which of the first processing operation and the second processing operation to be executed by the voice processing unit 3230 on voice accepted by the voice acceptance section 3210 is switched by the switching unit 3240 described below. When the voice processing unit 3230 executes both the first processing operation and the second processing operation on a voice accepted by the voice acceptance section 3210, data generated by executing the second processing operation has a smaller size than data generated by executing the first processing operation.

The first processing operation and the second processing operation will further be described.

As the first processing operation, the voice processing unit 3230 performs A/D conversion on voice accepted by the voice acceptance section 3210 to obtain a digital voice signal, and further executes voice compression processing using various voice data compression techniques (such as MP3) to generate signals 3000Sv and 3000Mv. The content of the first processing operation is an example, and the voice processing unit 3230 may perform, as the first processing operation, A/D conversion on voice accepted by the voice acceptance section 3210 to generate digital voice signals as the signals 3000Sv and 3000Mv.

The signal 3000Sv refers to data of a voice data format, which is generated on the basis of voice instructions for the air conditioner 3010, the devices in the first device group 3050, and the devices in the second device group 3060 to be operated by the operation/communication device 3200. The signal 3000Sv is a signal to be transmitted to the analysis server 3020. The signal 3000Mv refers to data of a voice data format, which is generated on the basis of voice (normal conversation) to be transmitted to the operation/communication device 3300.

The signal 3000Sv and the signal 3000Mv may be data of a voice data format, which is generated by performing the same processing operation on a voice accepted by the voice acceptance section 3210, or data of a voice data format, which is generated by performing different processing operations on voice accepted by the voice acceptance section 3210.

As the second processing operation, the voice processing unit 3230 converts voice accepted by the voice acceptance section 3210 into a text data format. The voice processing unit 3230 may perform, for example, voice recognition processing (processing for interpreting the meaning of the voice), which is performed by a recognition unit 3022 of the analysis server 3020 described below. Alternatively, the voice processing unit 3230 may perform, as the second processing operation, for example, processing to replace each sound included in a voice accepted by the voice acceptance section 3210 with text. For example, the voice processing unit 3230 may replace the voice “akari”, which means “light” in Japanese, with texts “a”, “ka”, and “ri”, with each of the sounds in the voice being converted into a text by referring to a database in which each of texts prepared in advance and a pattern of the sound of pronunciation of the text are associated with each other, without recognizing the meaning of the voice.

The voice processing unit 3230 executes the second processing operation on voice accepted by the voice acceptance section 3210 to generate signals 3000St and 3000Mt. The signal 3000St refers to data of a text data format, which is generated on the basis of voice instructions for the air conditioner 3010, the devices in the first device group 3050, and the devices in the second device group 3060 to be operated by the operation/communication device 3200. The signal 3000Mt refers to data of a text data format, which is generated on the basis of voice (normal conversation) to be transmitted to the operation/communication device 3300.

The signal 3000St and the signal 3000Mt may be data of a text data format, which is generated by performing the same processing operation on a voice accepted by the voice acceptance section 3210, or data of a text data format, which is generated by performing different processing operations on voice accepted by the voice acceptance section 3210.

(2-1-6) Communication Unit

The communication unit 3250 is a functional unit for allowing the operation/communication device 3200 to communicate with the analysis server 3020 or the operation/communication device 3300 (see FIG. 7).

When the operation/communication device 3200 functions as a transmission apparatus, the communication unit 3250 functions as a transmission unit. When the operation/communication device 3200 functions as a reception apparatus, the communication unit 3250 functions as a reception unit.

The operation/communication device 3200 is connected to the analysis server 3020 and the operation/communication device 3300 via a network 3080 that is an example of a communication line (see FIG. 6).

The network 3080 is the Internet, here, but may be any other WAN. The operation/communication device 3200 is connected to a router 3082 via a wireless LAN, and is connected to the network 3080 via the router 3082 (see FIG. 6). The communication unit 3250 is, for example, a wireless LAN adapter that performs wireless communication with the router 3082. The router 3082 has a WAN-side interface and a LAN-side interface, and interconnects a WAN and a LAN. The operation/communication device 3200 and the router 3082 may be connected via a wired LAN, rather than via a wireless LAN. The network 3080 may be a LAN.

The communication unit 3250 transmits data that is based on voice accepted by the voice acceptance section 3210 (in particular, voice instructions for the air conditioner 3010, the devices in the first device group 3050, and the devices in the second device group 3060 to be operated by the operation/communication device 3200) to the analysis server 3020, which is an example of a reception apparatus, via the network 3080 (see FIG. 7). The data transmitted to the analysis server 3020 is the signal 3000Sv or the signal 3000St generated by the voice processing unit 3230.

The communication unit 3250 may transmit the signal 3000Sv and the signal 3000St to the air conditioner server 3030 or the device server 3070 in addition to the analysis server 3020. That is, the communication unit 3250 may transmit the signal 3000Sv and the signal 3000St to a plurality of addresses (for example, the analysis server 3020 and the air conditioner server 3030) (see FIG. 7).

Further, the communication unit 3250 transmits data that is based on voice accepted by the voice acceptance section 3210 (in particular, normal conversation whose destination is the operation/communication device 3300) to the operation/communication device 3300, which is an example of a reception apparatus, via the network 3080 (see FIG. 7). The data transmitted to the operation/communication device 3300 is the signal 3000Mv or the signal 3000Mt generated by the voice processing unit 3230.

When the operation/communication device 3200 functions as a reception apparatus, the communication unit 3250 serves as a reception unit and receives data (the signal 3000Mv or the signal 3000Mt) transmitted from a transmission unit of the operation/communication device 3300.

The communication unit 3250 may be configured to receive information concerning the content of the operation of the air conditioner 3010 and the devices in the second device group 3060, which is transmitted from a transmission unit 3170a of the air conditioner 3010 and transmission units (not illustrated) of the devices in the second device group 3060.

(2-1-7) Switching Unit

The switching unit 3240 switches the format of data that is based on voice accepted by the voice acceptance section 3210, which is transmitted from the communication unit 3250, between the voice data format and the text data format.

Here, the switching unit 3240 switches the type of processing to be executed by the voice processing unit 3230 on the voice accepted by the voice acceptance section 3210 between the first processing operation and the second processing operation to switch the format of the data transmitted from the communication unit 3250 between the voice data format and the text data format.

The method of switching the format of the data transmitted from the communication unit 3250 is not limited to the method described above. For example, the voice processing unit 3230 may execute the first processing operation on a voice accepted by the voice acceptance section 3210 to generate data of a voice data format, and also execute the second processing operation on the voice to generate data of a text data format. Then, the switching unit 3240 may control the communication unit 3250 to transmit only one of the generated two types of data to switch the format of the data transmitted from the communication unit 3250 between the voice data format and the text data format.

Preferably, the switching unit 3240 switches the format of the data transmitted from the communication unit 3250 between the voice data format and the text data format on the basis of the determination result of the determination unit 3270 described below. In particular, when the determination unit 3270 determines that the traffic of the network 3080 is relatively high, the switching unit 3240 switches the format of the data transmitted from the communication unit 3250 to the text data format (switches the processing by the voice processing unit 3230 to the second processing operation). When the determination unit 3270 determines that the traffic of the network 3080 is relatively low, the switching unit 3240 switches the format of the data transmitted from the communication unit 3250 to the voice data format (switches the processing by the voice processing unit 3230 to the first processing operation).

Note that the switching unit 3240 may switch the format of the data transmitted from the communication unit 3250 between the voice data format and the text data format without using the determination result of the determination unit 3270 or in accordance with a user's selection input from the operation section (not illustrated) in addition to the determination result of the determination unit 3270.

(2-1-8) Determination Unit

The determination unit 3270 determines the state of traffic of the network 3080.

For example, the determination unit 3270 determines that the traffic of the network 3080 is relatively high when the measured communication speed is less than a predetermined threshold value, and determines that the traffic of the network 3080 is relatively low when the measured communication speed is greater than or equal to the predetermined threshold value.

In another embodiment, the determination unit 3270 may determine that the traffic of the network 3080 is relatively low in a certain time zone (for example, midnight and early morning), and determine that the traffic of the network 3080 is relatively high in the other time zones.

(2-1-9) Switch

The switch 3260 is a switch for switching the operating state of the voice acceptance section 3210.

The switch 3260 is a push button switch, but this is not limiting. By pressing the switch 3260, the operating state of the voice acceptance section 3210 is switched between a sleep state in which no voice is accepted and an active state in which voice is acceptable.

The operating state of the voice acceptance section 3210 may be switched between the sleep state and the active state each time the switch 3260 is pressed. Alternatively, the operating state of the voice acceptance section 3210 may be switched from the sleep state to the active state for a predetermined time period when the switch 3260 is pressed.

The operation/communication device 3200 may not have the switch 3260, and the operating state of the voice acceptance section 3210 may be always set to the active state. It is preferable that the operation/communication device 3200 be provided with the switch 3260 to prevent the voice acceptance section 3210 from accepting voice at an unintended timing (to prevent malfunction of the air conditioner 3010 or the devices in the first device group 3050 and the second device group 3060 or unintended transmission of the signal 3000Mv or the signal 3000Mt to the operation/communication device 3300).

(2-2) Air Conditioner

The air conditioner 3010 is an air conditioner that can be operated by inputting a voice instruction to the voice acceptance section 3210 of the operation/communication device 3200. Non-limiting examples of the voice instruction include voice such as “turn air conditioning on” and “set the set temperature to 25° C.”. The air conditioner 3010 may be configured to be operable using a typical remote control in addition to operation via voice.

The air conditioner 3010 mainly has an indoor unit 3012, an outdoor unit 3014, a connection pipe (not illustrated) that connects the indoor unit 3012 and the outdoor unit 3014 to each other, and a controller 3150 (see FIG. 6 and FIG. 7).

The air conditioner 3010 is an apparatus that performs air-conditioning of a space to be air-conditioned. The space to be air-conditioned is, for example, a room where the indoor unit 3012 is arranged in the building 3000B.

In the air conditioner 3010, the indoor unit 3012 and the outdoor unit 3014 are connected to each other via the connection pipe, thereby connecting an indoor heat exchanger (not illustrated) of the indoor unit 3012 and a compressor, an outdoor heat exchanger, an expansion valve, and the like (not illustrated) of the outdoor unit 3014 to each other via a pipe. Consequently, a refrigerant circuit is formed. In the air conditioner 3010, refrigerant is circulated in the refrigerant circuit, thereby cooling/heating the space where the indoor unit 3012 is installed.

The operational principle and the content of the operation of the air conditioner 3010 using a vapor compression refrigeration cycle are widely known to the public and will not be described here. The air conditioner 3010 does not need to be an air conditioner capable of both cooling/heating the space to be air-conditioned, and may be a cooling-only or heating-only air conditioner.

In this embodiment, the air conditioner 3010 is configured such that in the indoor heat exchanger of the indoor unit 3012, refrigerant flowing in the indoor heat exchanger and air in the space to be air-conditioned exchange heat; however, the air conditioner is not limited to such a device. For example, the air conditioner 3010 may be an apparatus configured such that in the indoor heat exchanger of the indoor unit 3012 (fan coil unit), cold water/hot water flowing in the indoor heat exchanger and air in the space to be air-conditioned exchange heat.

The controller 3150 is a control apparatus that controls the operation of the air conditioner 3010.

The controller 3150 includes a control board (not illustrated) included in the indoor unit 3012 and a control board (not illustrated) included in the outdoor unit 3014. CPUs on the control boards or the like of the indoor unit 3012 and the outdoor unit 3014, which constitute the controller 3150, execute various programs stored in storage devices on the control boards or the like to execute various processing operations. Further, the controller 3150 includes devices and the like such as a wireless LAN adapter that functions as a communication unit 3170 described below.

The controller 3150 mainly has a communication unit 3170 and an air conditioner control unit 3190.

The communication unit 3170 is used to allow the air conditioner 3010 to communicate with mainly the air conditioner server 3030 (see FIG. 7).

The air conditioner 3010 (the communication unit 3170) is connected to the air conditioner server 3030 via the network 3080 (see FIG. 6). The air conditioner 3010 is connected to the router 3082 via a wireless LAN, and is connected to the network 3080 via the router 3082 (see FIG. 6). The air conditioner 3010 and the router 3082 may be connected via a wired LAN, rather than via a wireless LAN.

The communication unit 3170 is, for example, a wireless LAN adapter that performs wireless communication with the router 3082. The communication unit 3170 has, as functional units, the transmission unit 3170a that transmits information, and a reception unit 3170b that receives information (see FIG. 7).

The transmission unit 3170a preferably transmits information 3000J on the state quantity for at least one of the air conditioner 3010 and the space to be air-conditioned to the air conditioner server 3030 (see FIG. 7). Non-limiting examples of the state quantity for the air conditioner 3010 include temperatures/pressures of refrigerant measured by sensors (not illustrated) at various locations in the refrigerant circuit, the number of revolutions of an inverter-controlled motor (not illustrated) of the compressor of the outdoor unit 3014, and the opening degree of the expansion valve of the outdoor unit 3014. The state quantity for the space to be air-conditioned, includes, but not limited to, the measured temperature of the space to be air-conditioned.

The reception unit 3170b receives, for example, a command 3000C corresponding to the signal 3000Sv or the signal 3000St transmitted from the communication unit 3250 of the operation/communication device 3200 (in particular, the signal 3000Sv or the signal 3000St that is based on a voice instruction for control of the air conditioner 3010) from the outside. More specifically, the reception unit 3170b receives the command 3000C generated on the basis of the result of analysis of the signal 3000Sv or the signal 3000St by the analysis server 3020 (in particular, the signal 3000Sv or the signal 3000St that is based on a voice instruction for control of the air conditioner 3010). Preferably, the reception unit 3170b receives the command 3000C generated by the air conditioner server 3030 on the basis of the result of analysis of the signal 3000Sv or the signal 3000St by the analysis server 3020 (in particular, the signal 3000Sv or the signal 3000St that is based on a voice instruction for control of the air conditioner 3010) and on the basis of the information 3000J on the state quantity transmitted from the transmission unit 3170a to the air conditioner server 3030.

For example, but not limitation, the command 3000C is related to at least one of turning on/off of the operation of the air conditioner 3010, switching among the operating modes (cooling/heating/dehumidification/ventilation, etc.) of the air conditioner 3010, changing of the set temperature (the target temperature of the space to be air-conditioned), a target value of the number of revolutions of the inverter-controlled motor (not illustrated) of the compressor of the outdoor unit 3014, a target value of the opening degree of the expansion valve of the outdoor unit 3014, and a target value of the number of revolutions of an inverter-controlled fan motor of the indoor unit 3012.

The air conditioner control unit 3190 controls the operation of the air conditioner 3010 in accordance with the command 3000C received by the reception unit 3170b, a command from a typical remote control (not illustrated), or the like. For example, the air conditioner control unit 3190 controls the operation of the compressor and expansion valve of the outdoor unit 3014, a fan of the indoor unit 3012, and so on in accordance with the command 3000C received by the reception unit 3170b on the basis of the settings of the air conditioner 3010 (such as the set temperature), values measured by various sensors (not illustrated), and so on.

(2-3) First Device Group

The devices 3050a, 3050b, . . . , and 3050n in the first device group 3050 are devices that can be operated using infrared signals. The devices 3050a, 3050b, . . . , and 3050n in the first device group 3050 can be operated using infrared signals transmitted from the infrared output device 3040 in response to input of voice instructions to the operation/communication device 3200.

(2-4) Second Device Group

The devices 3060a, 3060b, . . . , and 3060m in the second device group 3060 are devices that can be operated using signals transmitted via the network 3080. The devices 3060a, 3060b, . . . , and 3060m in the second device group 3060 are operated using signals transmitted from the analysis server 3020 or the device server 3070 in response to input of voice instructions to the operation/communication device 3200.

(2-5) Analysis Server

The analysis server 3020 is communicably connected to the operation/communication device 3200, the air conditioner 3010, the air conditioner server 3030, the device server 3070, and the infrared output device 3040 via the network 3080. The analysis server 3020 is an example of a reception apparatus that receives the signals 3000Sv and 3000St transmitted from the operation/communication devices 3200 and 3300, which are examples of a transmission apparatus.

When the operation/communication device 3200 accepts a voice instruction for the air conditioner 3010, a device in the first device group 3050, or a device in the second device group 3060, the communication unit 3250 transmits the signal 3000Sv or the signal 3000St that is based on the voice instruction to the analysis server 3020 via the network 3080 (see FIG. 7).

The analysis server 3020 is a computer that executes a program stored in a storage device to analyze the received signal 3000Sv and signal 3000St. For example, the analysis server 3020 performs voice recognition of the received signal 3000Sv of a voice data format. Further, the analysis server 3020 performs processing to recognize the meaning of the received signal 3000St of a text data format.

The analysis server 3020 has a communication unit 3024 capable of communication via the network 3080. The communication unit 3024 is an example of a reception unit, and receives the signal 3000Sv and the signal 3000St, which are transmitted from the operation/communication devices 3200 and 3300. The communication unit 3024 is also an example of a signal output unit that outputs (transmits) a signal (text information) that is based on the recognition result obtained by the recognition unit 3022 described below.

The storage device of the analysis server 3020 preferably stores, in addition to the program executed by a CPU, for example, a list of devices that can be operated by each of the operation/communication devices 3200 and 3300. That is, the analysis server 3020 preferably knows which device can be operated by each of the operation/communication devices 3200 and 3300. In addition, preferably, for the devices 3060a, 3060b, . . . , and 3060m in the second device group 3060, information as to whether the device 3060a, 3060b, . . . , or 3060m to be controlled is a direct control target of the analysis server 3020 (a control target of either of the analysis server 3020 and the device server 3070) is also stored.

The analysis server 3020 has, as a functional unit, the recognition unit 3022 that recognizes the content of the received signal 3000Sv and signal 3000St.

For example, the recognition unit 3022 analyzes the signal 3000Sv of a voice data format to determine a feature value, and generates text information from the feature value by using a voice recognition dictionary stored in the storage device, which includes an acoustic model, a linguistic model, and a pronunciation dictionary.

For example, the recognition unit 3022 includes a text recognition engine, and recognizes the meaning of the signal 3000St of a text data format. Then, the analysis server 3020 recognizes the meaning of text data, such as “air-conditioner-on”, and generates meaningful text information, such as “turn the air conditioner on”.

When the recognition unit 3022 executes recognition processing on the signal 3000Sv and the signal 3000St that are based on the same voice, it is more likely that the content will be recognizable when recognition processing is executed on the signal 3000Sv of a voice data format (having a relatively large amount of data). If the meaning of the signal 3000Sv or the signal 3000St fails to be recognized, the analysis server 3020 may request the user of the operation/communication device 3200 to retransmit the signal 3000Sv or the signal 3000St (re-enter voice).

Non-limiting examples of the text information generated by the analysis server 3020 include text information such as “turn the air conditioner on”, “set the set temperature of the air conditioner to 25 degrees”, “turn the lighting device off”, and “turn the television set on”.

When the generated text information is related to control of the air conditioner 3010 (for example, when the text information includes an air-conditioner-related keyword), the analysis server 3020 transmits the recognition result of the signal 3000Sv or the signal 3000St (i.e., the generated text information) to the air conditioner server 3030 via the network 3080 (see FIG. 7).

When the text information is related to control of the device 3050a, 3050b, . . . , or 3050n in the first device group 3050 (for example, when the text information includes a keyword related to the first device group 3050), the analysis server 3020 transmits a command to the infrared output device 3040 to provide an instruction to transmit an infrared signal based on the recognition result of the signal 3000Sv or the signal 3000St (i.e., the generated text information). For example, when the text information is information concerning a lighting device included in the devices 3050a, 3050b, . . . , and 3050n in the first device group 3050 (for example, “turn the lighting device off”), the analysis server 3020 transmits a command to the infrared output device 3040 to transmit an infrared signal for instructing the lighting device to turn off. The command directed to the infrared output device 3040 is transmitted from the analysis server 3020 to the infrared output device 3040 via the network 3080.

When the text information is related to control of the device 3060a, 3060b, . . . , or 3060m in the second device group 3060 (for example, when the text information includes a keyword related to the second device group 3060), the analysis server 3020 transmits a command based on the recognition result of the signal 3000Sv or the signal 3000St (i.e., the generated text information) to the device 3060a, 3060b, . . . , or 3060m in the second device group 3060. For example, when the text information is information concerning a television set included in the devices 3060a, 3060b, . . . , and 3060m in the second device group 3060 (for example, “turn the television set on”), the analysis server 3020 transmits a command to the television set to provide an instruction to turn on the switch. Commands directed to the devices 3060a, 3060b, . . . , and 3060m in the second device group 3060 are transmitted from the analysis server 3020 to the devices 3060a, 3060b, . . . , and 3060m in the second device group 3060 via the network 3080.

When the text information is related to control of the device 3060a, 3060b, . . . , or 3060m in the second device group 3060 and the device 3060a, 3060b, . . . , or 3060m to be controlled is not a direct control target of the analysis server 3020, the text information is transmitted to the device server 3070 that controls the corresponding device 3060a, 3060b, . . . , or 3060m. Then, a command is transmitted from the device server 3070 to the corresponding device 3060a, 3060b, . . . , or 3060m via the network 3080.

(2-6) Air Conditioner Server

The air conditioner server 3030 generates the command 3000C on the basis of the result of analysis of the signal 3000Sv or the signal 3000St by the analysis server 3020 (i.e., the text information generated by the analysis server 3020), which is transmitted from the analysis server 3020, and on the basis of the information 3000J on the state quantity for at least one of the air conditioner 3010 and the space to be air-conditioned, which is transmitted as appropriate from the transmission unit 3170a of the air conditioner 3010. Then, the air conditioner server 3030 transmits the command 3000C to the reception unit 3170b of the air conditioner 3010 via the network 3080. For example, without limitation, upon receipt of the command “turn the air conditioner on” as text information, the air conditioner server 3030 determines the operation of the components of the air conditioner 3010 on the basis of the current temperature and the like of the space to be air-conditioned, and transmits the command as the command 3000C.

Here, without limitation, the air conditioner server 3030 generates the command 3000C on the basis of the information 3000J in addition to the result of analysis of the signal 3000Sv or the signal 3000St by the analysis server 3020. The air conditioner server 3030 may generate the command 3000C on the basis of only the result of analysis of the signal 3000Sv or the signal 3000St by the analysis server 3020.

Further, the air conditioner server 3030 accumulates signals 3000Sv or signals 3000St transmitted from the operation/communication device 3200 and performs various analysis operations by using the signals 3000Sv or the signals 3000St.

In this embodiment, without limitation, the device operation/communication system 3001 includes the air conditioner server 3030. For example, when the air conditioner 3010 is capable of directly determining the content of the operation on the basis of the result of analysis of the signal 3000Sv or the signal 3000St by the analysis server 3020 (i.e., the text information generated by the analysis server 3020), the air conditioner server 3030 may not be disposed. The result of analysis of the signal 3000Sv or the signal 3000St by the analysis server 3020 may be transmitted directly to the reception unit 3170b of the air conditioner 3010 as the command 3000C.

(2-7) Device Server

The device server 3070 generates a command for the device 3060a, 3060b, . . . , or 3060m in the second device group 3060 on the basis of the result of analysis of the signal 3000Sv or the signal 3000St by the analysis server 3020 (i.e., the text information generated by the analysis server 3020), which is transmitted from the analysis server 3020. Then, the device server 3070 transmits the command to the operation target among the devices 3060a, 3060b, . . . , and 3060m in the second device group 3060 via the network 3080.

In FIG. 6, the number of device servers 3070 is one. However, if there is a plurality of types of the devices 3060a, 3060b, . . . , and 3060m to be operated by the device server 3070 (rather than in accordance with commands from the analysis server 3020), a number of device servers 3070 equal to the number of types are preferably present.

In addition, when all of the devices 3060a, 3060b, . . . , and 3060m are operable with commands from the analysis server 3020, the device server 3070 may not be present.

(2-8) Infrared Transmitter

The infrared output device 3040 has a storage unit (not illustrated) that stores an infrared signal pattern for control for each of the devices 3050a, 3050b, . . . , and 3050n in the first device group 3050 or for each of the operations to be performed on the devices 3050a, 3050b, . . . , and 3050n in the first device group 3050. The infrared output device 3040 transmits an infrared signal to the operation target among the devices 3050a, 3050b, . . . , and 3050n in the first device group 3050 in accordance with a command transmitted from the analysis server 3020 by using the infrared signal pattern stored in the storage unit.

(3) Features

(3-1)

The device operation/communication system 3001 according to this embodiment includes the operation/communication device 3200, which is an example of a transmission apparatus, and the operation/communication device 3300 and the analysis server 3020, which are examples of a reception apparatus. The operation/communication device 3200 has the voice acceptance section 3210, the voice processing unit 3230, which is an example of a text conversion unit, the communication unit 3250, which is an example of a transmission unit, and the switching unit 3240. The voice acceptance section 3210 accepts input of voice. The voice processing unit 3230 converts the voice accepted by the voice acceptance section 3210 into a text data format. The communication unit 3250 transmits data that is based on voice accepted by the voice acceptance section 3210 via the network 3080. The switching unit 3240 switches the format of the data transmitted from the communication unit 3250 between a voice data format and a text data format. The operation/communication device 3300 has a reception unit (similar to the communication unit of the operation/communication device 3200) that receives data transmitted from the communication unit 3250 of the operation/communication device 3200. Further, the analysis server 3020 has the communication unit 3024, which is an example of a reception unit that receives data transmitted from the communication unit 3250 of the operation/communication device 3200.

In the device operation/communication system 3001, the data format of data based on input voice, which is transmitted from the operation/communication device 3200 to the analysis server 3020 or the operation/communication device 3300, can be switched between a voice data format and a text data format. In the device operation/communication system 3001, accordingly, when traffic is high, the data based on the input voice can be switched to the text data format having a smaller data amount than the voice data format and can be transmitted, reducing the occurrence of communication failure regardless of the state of traffic of the network 3080.

In addition, here, voice is input to the operation/communication device 3200. Thus, compared with input of a code selected from a vocabulary list, desired information can be transmitted from the operation/communication device 3200 to the analysis server 3020 or the operation/communication device 3300 without time and labor.

In addition, here, data can also be transmitted in voice data format from the operation/communication device 3200 (the data format available for transmission is not limited to the text data format). Thus, when traffic is low, data can be transmitted invoice data format to the analysis server 3020 or the operation/communication device 3300, providing high convenience.

(3-2)

The device operation/communication system 3001 according to this embodiment has the determination unit 3270. The determination unit 3270 determines the state of traffic of the network 3080. The switching unit 3240 switches the format of the data transmitted from the communication unit 3250 between a voice data format and a text data format on the basis of the determination result of the determination unit 3270.

Here, the format of data transmitted from the operation/communication device 3200 to the analysis server 3020 or the operation/communication device 3300 is switched between the voice data format and the text data format in accordance with the state of traffic of the network 3080. Thus, communication failures are less likely to occur.

(3-3)

In the device operation/communication system 3001 according to this embodiment, the analysis server 3020, which is an example of a reception apparatus, has the recognition unit 3022, and the communication unit 3024, which is an example of a signal output unit. The recognition unit 3022 recognizes the content of received data (the received signal 3000Sv and signal 3000St). The communication unit 3024 outputs a signal (text information) based on the recognition result of the recognition unit 3022.

Here, the content of the data received on the analysis server 3020 side is recognized, and a signal is output accordingly. In this system, input voice is preferably transmitted to the analysis server 3020 side in such a manner as to be as close to original data as possible (in a voice data format having a large information amount) to enable accurate recognition of the content of the data. However, sticking to transmission of data in voice data format may cause communication failure, and data may not reach the analysis server 3020, which would otherwise reach it. Consequently, the processing to be performed by the analysis server 3020 may not be executed.

In the device operation/communication system 3001, in contrast, data based on voice input to the operation/communication device 3200 can be transmitted in voice data format and can also be transmitted in text data format. Thus, if the network 3080 enters a state where communication failure is likely to occur, data may be transmitted in text data format. A condition is less likely to occur in which no data reaches the analysis server 3020 and in which the processing to be performed by the analysis server 3020 is not executed.

(3-4)

In the device operation/communication system 3001 according to this embodiment, the operation/communication device 3300, which is an example of a reception apparatus, further has a voice output unit, a storage unit, and a setting unit. The voice output unit, the storage unit, and the setting unit of the operation/communication device 3300 have configurations similar to those of the voice output unit 3220, the voice database 3224, and the setting unit 3222 of the operation/communication device 3200, respectively. The voice output unit performs voice conversion of data of the text data format accepted by the reception unit of the operation/communication device 3300 (having a configuration similar to that of the communication unit 3250 of the operation/communication device 3200), and outputs the resulting data. The storage unit stores a plurality of voice patterns. The setting unit sets a voice pattern to be used by the voice output unit for output.

Here, in the case of voice output of data of the text data format, a voice to be used for output can be set from among a plurality of voice patterns. This allows a listener who listens to the voice to listen to the content of the data using a voice pattern that is the easiest to hear.

(3-5)

The operation/communication device 3200 according to this embodiment includes the voice acceptance section 3210, the voice processing unit 3230, the communication unit 3250, and the switching unit 3240. The voice acceptance section 3210 accepts input of voice. The voice processing unit 3230 converts the voice accepted by the voice acceptance section 3210 into a text data format. The communication unit 3250 transmits data that is based on the voice accepted by the voice acceptance section 3210 via the network 3080. The switching unit 3240 switches the format of the data transmitted from the communication unit 3250 between a voice data format and the text data format.

The operation/communication device 3300 also has features similar to those of the operation/communication device 3200, which will not be described to avoid repetition.

In the operation/communication device 3200, the data format of data based on input voice, which is transmitted from the operation/communication device 3200, can be switched between the voice data format and the text data format. In the operation/communication device 3200, accordingly, when traffic is high, the data based on the input voice can be switched to the text data format having a smaller data amount than the voice data format and can be transmitted, reducing the occurrence of communication failure regardless of the state of traffic of the network 3080.

In addition, here, voice is input to the operation/communication device 3200. Thus, compared with input of a code selected from a vocabulary list, desired information can be transmitted from the operation/communication device 3200 without time and labor.

In addition, here, data can also be transmitted in voice data format from the device/communication device 3200 (the data format available for transmission is not limited to the text data format). Thus, when traffic is low, data can be transmitted invoice data format to the receiver side, providing high convenience.

(3-6)

The operation/communication device 3200 according to this embodiment includes the determination unit 3270. The determination unit 3270 determines the state of traffic of the network 3080. The switching unit 3240 switches the format of the data transmitted from the communication unit 3250 between a voice data format and a text data format on the basis of the determination result of the determination unit 3270.

Here, the format of data transmitted from the operation/communication device 3200 is switched between the voice data format and the text data format in accordance with the state of traffic of the network 3080. Thus, communication failures are less likely to occur.

(4) Modifications

The following describes modifications of the embodiment described above. The modifications may be combined as appropriate so long as consistency is maintained between them.

(4-1) Modification 4A

In the embodiment described above, without limitation, the device operation/communication system 3001 is a system capable of operating the air conditioner 3010, the devices in the first device group 3050, and the devices in the second device group 3060 via voice instructions.

For example, in the device operation/communication system 3001, some of the air conditioner 3010, the devices in the first device group 3050, and the devices in the second device group 3060 may not be operation targets. When some of the air conditioner 3010, the devices in the first device group 3050, and the devices in the second device group 3060 are no longer operation targets, a component that is no longer necessary (for example, the infrared output device 3040, the air conditioner server 3030, or the device server 3070) may be removed from the configuration of the device operation/communication system 3001.

Further, the communication system may not be a system used to operate devices. That is, the communication system may be a system for implementing communication between a plurality of communication devices (the operation/communication device 3200 of the embodiment described above from which the device operating function is removed). In this communication system, the infrared output device 3040, the analysis server 3020, the air conditioner server 3030, and the device server 3070 are no longer necessary. Likewise, the transmission apparatus may be an apparatus obtained by removing the device operating function from the operation/communication device 3200 of the embodiment described above.

(4-2) Modification 4B

In the embodiment described above, without limitation, the analysis server 3020, the air conditioner server 3030, and the device server 3070 in the device operation/communication system 3001 are separate servers. For example, one server may function as the analysis server 3020 and the air conditioner server 3030, or function as the analysis server 3020, the air conditioner server 3030, and the device server 3070.

Conversely, the function of each of the analysis server 3020, the air conditioner server 3030, and the device server 3070 described in the above embodiment may be achieved by a plurality of servers rather than by a single server.

Furthermore, in the embodiment described above, without limitation, the signal 3000Sv and the signal 3000St transmitted from the communication unit 3250 are received directly by the analysis server 3020. For example, the communication unit 3250 may transmit the signal 3000Sv and the signal 3000St to the air conditioner server 3030, and the signal 3000Sv and the signal 3000St may be transmitted from the air conditioner server 3030 to the analysis server 3020.

Furthermore, in the embodiment described above, without limitation, whether data that is based on voice accepted by the voice acceptance section 3210 is transmitted to the analysis server 3020 or the operation/communication device 3300 is determined on the operation/communication device 3200 side. For example, all the data that is based on voice accepted by the voice acceptance section 3210 may be temporarily transmitted to the analysis server 3020, and the analysis server 3020 may recognize the content of the data and transmit data based on voice (including a voice data format and a text data format) to the operation/communication device 3300, if necessary.

(4-3) Modification 4C

The air conditioner 3010 in the device operation/communication system 3001 according to the embodiment described above is an apparatus that adjusts the temperature or humidity or air, but this is not limiting. The air conditioner may be an air cleaner that removes dust particles and the like from air and blows out cleaned air, an air-flow adjustment apparatus that adjusts the flow of air in the space to be air-conditioned, or the like.

(4-4) Modification 4D

In the device operation/communication system 3001 according to the embodiment described above, without limitation, when the communication unit 3250 receives data based on voice in text data format, the operation/communication device 3200 serving as a reception apparatus performs voice conversion of the data and outputs the resulting data from the voice output unit 3220. For example, when the communication unit 3250 receives data based on voice in text data format, the operation/communication device 3200 may merely output the data to the display 3280.

### Fourth Embodiment

The following describes a device management system 6001 according to a fourth embodiment with reference to the drawings.

(1) Overview of Device System Including Device Management System

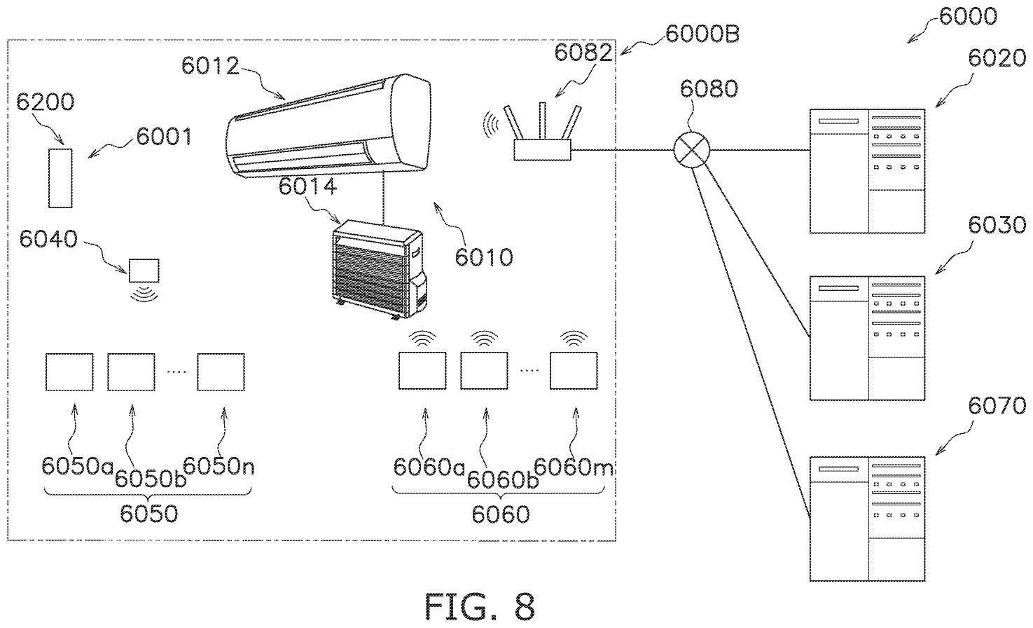

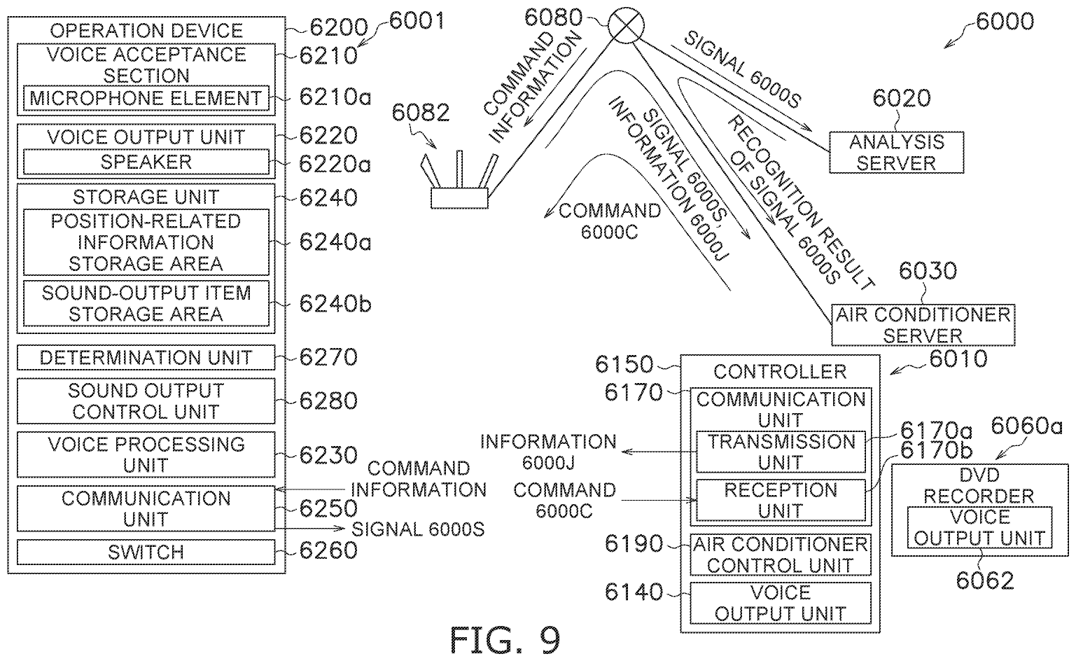

FIG. 8 is a schematic configuration diagram of a device system 6000 including the device management system 6001. FIG. 9 is a schematic block diagram of the device system 6000. In FIG. 9, some of the components of the device system 6000 are not depicted.

The device system 6000 mainly includes an operation device 6200, an air conditioner 6010, infrared-operated device group 6050, network-connected device group 6060, 6040, an analysis server 6020, an air conditioner server 6030, and a device server 6070 (see FIG. 8 and FIG. 9). The device management system 6001 includes the operation device 6200.

The device management system 6001 is a system that operates the air conditioner 6010, devices 6050a, 6050b, . . . , and 6050n included in the infrared-operated device group 6050, and devices 6060a, 6060b, . . . , and 6060m included in the network-connected device group 6060 by instructions given by voice.

Further, the device management system 6001 is a system that controls, in an environment where a plurality of a devices that output sounds (having a sound output unit) are present, sound output of the devices such that failures, such as sounds output from the devices being overlapped and noisy, or the sound output from each of the devices being difficult to hear, are less likely to occur. In this embodiment, examples of the plurality of devices that output sounds are assumed to include the operation device 6200, the air conditioner 6010, and the device 6060a. The device 6060a is, for example, a DVD recorder. The operation device 6200 is a remote control device that controls the operation of the air conditioner 6010 and the device 6060a, and is an example of a first device. The air conditioner 6010 and the device 6060a are examples of a second device.

The air conditioner 6010, the infrared-operated device group 6050, the network-connected device group 6060, and 6040 are devices arranged in a building 6000B (see FIG. 8). The building 6000B is, for example, but not limited to, a detached house. The building 6000B may be an office building, a commercial facility, a factory, or the like. The analysis server 6020, the air conditioner server 6030, and the device server 6070 are generally, but not limited to, installed in locations different from the building 6000B.

The number of air conditioners 6010, the number of devices in the infrared-operated device group 6050, the number of devices in the network-connected device group 6060, and the number of 6040, which are arranged in the building 6000B, are not limited to those depicted in FIG. 8, and may be each one or more. The following description is made assuming that one air conditioner 6010 and one 6040 are arranged in the building 6000B and the infrared-operated device group 6050 and the network-connected device group 6060 arranged in the building 6000B each include a plurality of devices.

For simplicity of description, FIG. 8 depicts one building 6000B in which the air conditioner 6010, the infrared-operated device group 6050, and the network-connected device group 6060, whose operations are controlled by the device management system 6001, are arranged. However, a plurality of buildings 6000B may be used. That is, the device management system 6001 may be a system that controls the operation of the air conditioners 6010, the infrared-operated device groups 6050, and the network-connected device groups 6060 arranged in each of the plurality of buildings 6000B.

The operation device 6200 is installed in the building 6000B and is used to operate the air conditioner 6010, the devices in the infrared-operated device group 6050, and the devices in the network-connected device group 6060 in the building 6000B. While a single operation/communication device in the building 6000B is depicted, a plurality of operation devices 6200 may be installed in the building 6000B. Further, the operation device 6200 is not limited to a mounted type, and may be a mobile terminal that can be carried outside the building 6000B. In other words, the air conditioner 6010 and the devices in the infrared-operated device group 6050 and the network-connected device group 6060 may be configured to be operable from outside the building 6000B by using the operation device 6200 that is portable.

(2) Detailed Configuration

The operation device 6200, the air conditioner 6010, the infrared-operated device group 6050, the network-connected device group 6060, the analysis server 6020, the air conditioner server 6030, the device server 6070, and 6040 will be described below.

(2-1) Operation Device

The operation device 6200 is an example of a remote control apparatus. The operation device 6200 is a device used to control the operation of the air conditioner 6010, the devices 6050a, 6050b, . . . , and 6050n included in the infrared-operated device group 6050, and the devices 6060a, 6060b, . . . , and 6060m included in the network-connected device group 6060 in the building 6000B, including a second device (the air conditioner 6010 and the device 6060a).

The operation device 6200 may be a device having, in addition to the functions described below, other functions (for example, the functions of a watch and a music player).

In this embodiment, the operation device 6200 is installed in a stationary manner in the building 6000B. For example, the operation device 6200 is placed on a table or shelf or is fixed to the wall surface or the like.

In another aspect, the operation device 6200 may be a mobile terminal. Examples of the mobile terminal include, without limitation in type, a smartphone, a mobile phone, a tablet terminal, and a wearable terminal having a voice acceptance section. Specifically, for example, the operation device 6200 is a wristwatch-type device carried by an operator in such a manner as to be worn around their wrist.

In this embodiment, for simplicity of description, the operation device 6200 is described as a single operation device. However, a plurality of operation devices 6200 may be used. When a plurality of operation devices 6200 are used in the building 6000B, each of the plurality of operation devices 6200 may be different in type from the other operation devices 6200.

The operation device 6200 includes a CPU (not illustrated) that executes various processing operations, and a storage device (not illustrated) that stores a program executed by the CPU and various kinds of information. Further, the operation device 6200 includes a microphone element 6210a included in a voice acceptance section 6210, a speaker 6220a included in a voice output unit 6220, a voice processing chip that performs various processing operations on voice acquired by the microphone element 6210a, a wireless LAN adapter that functions as a communication unit 6250, and so on.

The operation device 6200 has, as functional units, the voice acceptance section 6210, the voice output unit 6220, a storage unit 6240, a determination unit 6270, a sound output control unit 6280, a voice processing unit 6230, the communication unit 6250, and a switch 6260 (see FIG. 9).

(2-1-1) Voice Acceptance Section

The voice acceptance section 6210 accepts input of voice instructions to the air conditioner 6010, the devices 6050a, 6050b, . . . , and 6050n in the infrared-operated device group 6050 and the devices 6060a, 6060b, . . . , and 6060m in the network-connected device group 6060.

The voice acceptance section 6210 has the microphone element 6210a that accepts voice. The number of microphone elements 6210a may be one or more.

For example, when the operation device 6200 is a stationary-type device, a plurality of microphone elements 6210a are used, and the plurality of the microphone element 6210a are arranged so as to easily acquire voice from different places, thereby facilitating reliable acquisition of the voice by the voice acceptance section 6210, regardless of the position of the utterer.

(2-1-2) Voice Output Unit

The voice output unit 6220 has the speaker 6220a and outputs various kinds of information by sounds (including voice (verbal sounds) in addition to beep, buzzer, and other sounds). The voice output unit 6220 is an example of a first sound output unit.

The following describes the basic operation of the voice output unit 6220. The basic operation of the voice output unit 6220 refers to an operation in a case where the sound output control unit 6280 does not control sound output described below.

For example, when the voice acceptance section 6210 accepts a specific voice instruction, the voice output unit 6220 provides notification of acceptance of the specific voice instruction by voice. For example, when a specific voice instruction is accepted, the voice output unit 6220 outputs the sentence “a specific voice instruction has been accepted” by voice. The specific voice instruction will be described below.

Further, for example, when a device (the air conditioner 6010, a device in the infrared-operated device group 6050, or a device in the network-connected device group 6060) is to be operated, the voice output unit 6220 outputs information concerning an operation to be performed on the device by sound. The information concerning an operation to be performed on the device, which is transmitted from the voice output unit 6220, also includes information (first information) concerning an operation to be performed on a second device (the air conditioner 6010 or the device 6060a).

The information concerning an operation to be performed on the device will be described in detail.

As described below, when the voice acceptance section 6210 accepts a voice instruction, the operation device 6200 generates a signal 6000S that is based on the voice instruction (voice data obtained by performing A/D conversion processing on the voice instruction and further performing compression processing) and transmits the signal 6000S from the communication unit 6250 to the analysis server 6020. The analysis server 6020 executes voice recognition processing on the received signal 6000S. Then, the analysis server 6020, the air conditioner server 6030, or the device server 6070 generates a command for the operation target device on the basis of the result of the voice recognition processing performed by the analysis server 6020. At this time, a command generated by the analysis server 6020, the air conditioner server 6030, or the device server 6070 (which device is to be instructed to execute operation and what operation is to be executed) is transmitted to the operation device 6200 (the communication unit 6250) as command information (see FIG. 9). Here, without limitation, the command information is transmitted from the analysis server 6020, the air conditioner server 6030, or the device server 6070 to the operation device 6200. The command information may be transmitted from the command recipient (operated) device side to the communication unit 6250.

When the communication unit 6250 receives the command information, the voice output unit 6220 outputs the information concerning an operation to be performed on the device (information indicating which device is to be operated and what operation is to be performed) by sound on the basis of the received command information. The information concerning an operation to be performed on the device is output by sound, which allows the operator of the device to which the voice instruction is input from the voice acceptance section 6210 to check whether their issued voice instruction has been correctly recognized. When the received command information indicates an instruction to start the operation of the air conditioner 6010, for example, the voice output unit 6220 outputs the sentence “the control of the operation of the air conditioner has been accepted” by sound.

The operation device 6200 may also be configured to receive information concerning the content of the current operations or the current operating states of the air conditioner 6010, the devices in the infrared-operated device group 6050, and the devices in the network-connected device group 6060, which are to be operated by the operation device 6200, and to output the information by sound from the speaker 6220a of the voice output unit 6220. The information concerning the content of the operation or the operating state of a device may be transmitted from the device side or transmitted from a component that has obtained such information (for example, the air conditioner server 6030 or the device server 6070).

(2-1-3) Storage Unit

The storage unit 6240 stores various kinds of information in addition to a program executed by the CPU (not depicted) of the operation device 6200. The information stored in the storage unit 6240 includes position-related information stored in a position-related information storage area 6240a, and sound output content information stored in a sound-output item storage area 6240b.

(2-1-3-1) Position-Related Information Storage Area

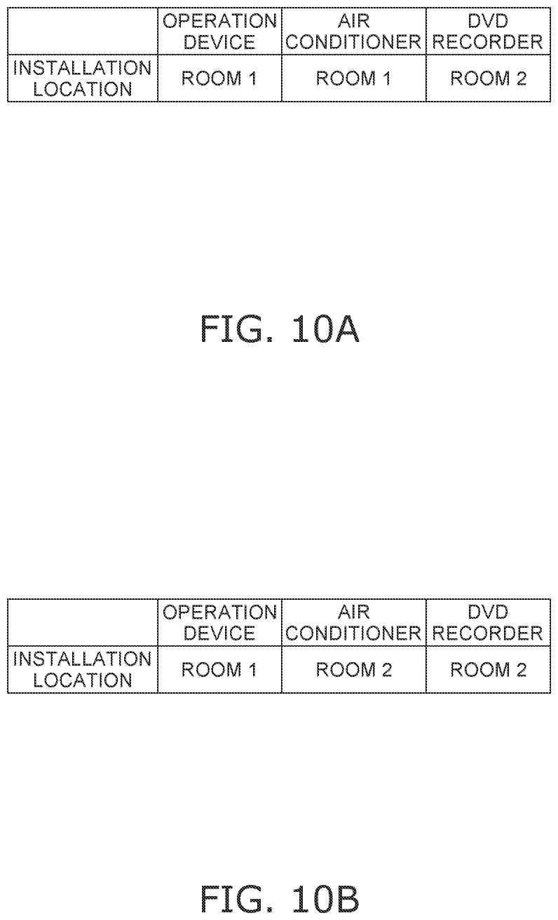

The position-related information stored in the position-related information storage area 6240a is information concerning the positions of the operation device 6200 serving as a first device and the air conditioner 6010 and the device 6060a serving as second devices. The position-related information is, for example, a list of installation locations (room names) of devices (the operation device 6200, the air conditioner 6010, and the device 6060a) (see FIG. 10A and FIG. 10B).

While the installation locations are defined as rooms where the respective devices are installed, the installation locations may not be defined as rooms.

For example, the installation locations may be defined as regions. For example, even when devices are installed in the same room, the installation locations of the devices may be determined to be different depending on the areas of installation. In addition, for example, when the building 6000B has a plurality of floors, the regions may be defined for each floor, regardless of the room. Alternatively, the installation locations may be defined as distances from the operation device 6200 (first device) (for example, when a second device is installed within an area that is 5 m away from the operation device 6200, the second device is regarded as being installed in the same region as that of the operation device 6200).

The position-related information is, for example, information input by the user of the operation device 6200 (for example, a resident of the building 6000B) using an input unit (not illustrated).

Here, the position-related information stored in the position-related information storage area 6240a is information concerning only the operation device 6200, the air conditioner 6010, and the device 6060a, each having a sound output unit. However, this is not limiting. Position-related information of the operation device 6200 and all the devices to be operated by the operation device 6200 (the air conditioner 6010, the devices in the infrared-operated device group 6050, and the devices in the network-connected device group 6060) may be registered in the position-related information storage area 6240a.

(2-1-3-2) Sound-Output Item Storage Area 6240b

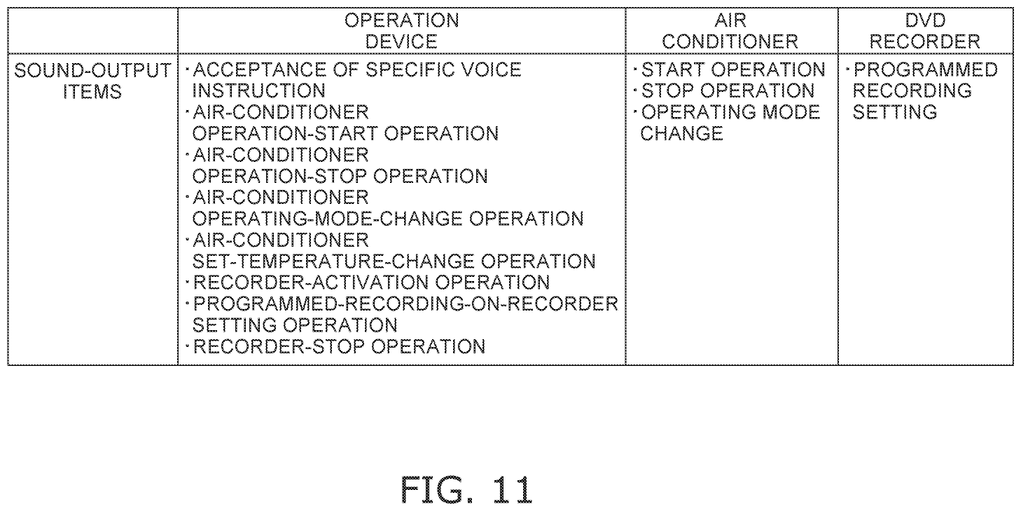

The sound-output item information stored in the sound-output item storage area 6240b is information concerning items that are output by sound from the operation device 6200 serving as a first device and the air conditioner 6010 and the device 6060a serving as second devices. Specifically, the sound-output item information is a list of collection of voice items that are output from the voice output unit 6220 of the operation device 6200, a voice output unit 6140 of the air conditioner 6010 described below, and a voice output unit 6062 of the device 6060a described below (see FIG. 11). The sound-output item information stored in the sound-output item storage area 6240b does not take into account the control of sound output by the sound output control unit 6280 described below. In other words, in some cases, as a result of control of sound output by the sound output control unit 6280, the voice output unit 6220 does not output information on some items by sound even if the information corresponds to the sound-output item information stored in the sound-output item storage area 6240b.

In the example in FIG. 11, the operation device 6200 outputs information concerning acceptance of a specific voice instruction by voice from the voice output unit 6220. Further, for example, in the example in FIG. 11, the operation device 6200 outputs information concerning operation-start operation, operation-stop operation, operating-mode-change operation, and set-temperature-change operation for the air conditioner 6010 (first information concerning an operation to be performed on the air conditioner 6010) by voice. Further, in the example in FIG. 11, the operation device 6200 outputs information concerning activation operation, programmed-recording setting operation, and stop operation for a DVD recorder (the device 6060a) (first information concerning an operation to be performed on the device 6060a) by voice. Preferably, the operation device 6200 outputs information concerning an operation to be performed on not only the second devices but also all the operation target devices (including devices having no sound output unit) by voice. That is, in FIG. 11, which illustrates an example of the sound-output item information, only items concerning an operation to be performed on the air conditioner 6010 and the device 6060a are registered in the list. However, preferably, items concerning devices other than the air conditioner 6010 and the device 6060a are also registered in the list.

In the example in FIG. 11, the air conditioner 6010 outputs information concerning operation start, operation stop, and operating mode change by voice. In the example in FIG. 11, furthermore, the DVD recorder (the device 6060a) outputs information concerning programmed recording setting by voice.

The sound-output item information illustrated in FIG. 11 is an example for the purpose of illustration, and items of information to be output by sound from each of the devices 6200, 6010, and 6060a are not limited to the illustrated items.

The sound-output item information of the operation device 6200 is created automatically (in accordance with a predetermined rule), for example, when the user or the like of the operation device 6200 inputs an operation target device, which is a device to be operated by the operation device 6200, by using an input unit (not illustrated). The sound-output item information of the air conditioner 6010 and the device 6060a is, for example, information downloadable from homepages or the like of the manufacturers of the air conditioner 6010 and the device 6060a. However, all the pieces of sound-output item information may be information that is manually input from an input unit (not illustrated).

(2-1-4) Determination Unit

The determination unit 6270 determines a positional relationship between the operation device 6200, which is an example of first device, and the air conditioner 6010, which is an example of a second device, or a positional relationship between the operation device 6200 and the device 6060a (DVD recorder), which is an example of a second device.

The determination unit 6270 mainly determines whether the first device and the second device have a predetermined positional relationship. The case where the first device and the second device have a predetermined positional relationship refers to a case where the first device and the second device have a positional relationship in which the sound output from the first device and the sound output from the second device are likely to affect each other. For example, the case where the first device and the second device have a predetermined positional relationship includes, but not limited to, a case where the distance between the first device and the second device is smaller than a predetermined distance. Further, the case where the first device and the second device have a predetermined positional relationship includes, but not limited to, a case where the first device and the second device are installed in the same region. Further, the case where the first device and the second device have a predetermined positional relationship includes, but not limited to, a case where a member having a soundproof function (for example, a wall) is arranged between the first device and the second device.

For example, preferably, the determination unit 6270 determines a positional relationship between the operation device 6200 and the air conditioner 6010 or a positional relationship between the operation device 6200 and the device 6060a on the basis of the position-related information stored in the position-related information storage area 6240a of the storage unit 6240. Specifically, the determination unit 6270 preferably determines whether the installation locations of the operation device 6200 and the air conditioner 6010 are the same and whether the installation locations of the operation device 6200 and the device 6060a are the same on the basis of the position-related information stored in the position-related information storage area 6240a of the storage unit 6240.

For example, when the position-related information storage area 6240a stores the position-related information illustrated in FIG. 10A, the determination unit 6270 determines that the operation device 6200 and the air conditioner 6010 have a predetermined positional relationship, and determines that the operation device 6200 and the device 6060a does not have a predetermined positional relationship.

(2-1-5) Sound Output Control Unit

The sound output control unit 6280 controls on/off of sound output or an output sound volume of at least one of the operation device 6200 and the second device on the basis of the determination result of the determination unit 6270. In this embodiment, in particular, the sound output control unit 6280 controls on/off of sound output or an output sound volume of the operation device 6200 and on the basis of the determination result of the determination unit 6270.

The control performed by the sound output control unit 6280 will be described later.

(2-1-6) Voice Processing Unit

The voice processing unit 6230 processes a voice instruction accepted by the microphone element 6210a of the voice acceptance section 6210 to generate the signal 6000S. Further, the voice processing unit 6230 recognizes only a specific voice instruction among voice instructions accepted by the microphone element 6210a. The voice processing unit 6230 is, for example, an integrated circuit that executes these functions.

The voice processing unit 6230 performs A/D conversion on the voice instruction (other than the specific voice instruction) and, preferably, further performs voice compression using various voice data compression techniques (such as MP3) to generate the signal 6000S. In another embodiment, the voice processing unit 6230 may convert the voice instruction (other than the specific voice instruction) into text to generate the signal 6000S.

Further, when the voice acceptance section 6210 accepts a voice instruction, for example, the voice processing unit 6230 determines whether the spoken pattern of the accepted voice instruction matches the spoken pattern of a specific voice instruction word stored in the storage unit 6240 to recognize a specific voice instruction. The specific voice instruction indicates voice for requesting the operation device 6200 that the voice processing unit 6230 generate the signal 6000S in accordance with a voice instruction input to the voice acceptance section 6210 subsequently to the specific voice instruction and that the communication unit 6250 prepare to transmit the generated signal 6000S.

(2-1-7) Communication Unit

The communication unit 6250 is a functional unit for allowing the operation device 6200 to communicate with the analysis server 6020, the air conditioner server 6030, the device server 6070, the air conditioner 6010, the devices in the network-connected device group 6060, and so on (see FIG. 9).

The operation device 6200 is connected to the analysis server 6020, the air conditioner server 6030, the device server 6070, the air conditioner 6010, the devices in the network-connected device group 6060, and so on via a network 6080 that is an example of a communication line (see FIG. 8).

The network 6080 is the Internet, here, but may be any other WAN. The operation device 6200 is connected to a router 6082 via a wireless LAN, and is connected to the network 6080 via the router 6082 (see FIG. 8). The communication unit 6250 is, for example, a wireless LAN adapter that performs wireless communication with the router 6082. The router 6082 has a WAN-side interface and a LAN-side interface, and interconnects a WAN and a LAN. The operation device 6200 and the router 6082 may be connected via a wired LAN, rather than via a wireless LAN. The network 6080 may be a LAN.

The communication unit 6250 transmits the signal 6000S that is based on the voice accepted by the voice acceptance section 6210 (except for the specific voice instruction) to the analysis server 6020 via the network 6080 (see FIG. 9). The communication unit 6250 may transmit the signal 6000S to the air conditioner server 6030 or the device server 6070 in addition to the analysis server 6020. That is, the communication unit 6250 may transmit the signal 6000S to a plurality of addresses (for example, the analysis server 6020 and the air conditioner server 6030) (see FIG. 9).

Further, the communication unit 6250 receives the command information described above from the analysis server 6020, the air conditioner server 6030, or the device server 6070, for example, when the analysis server 6020, the air conditioner server 6030, or the device server 6070 generates a command for a device in accordance with the signal 6000S transmitted from the communication unit 6250.

As described above, the communication unit 6250 may receive information on the content of the current operations or the current operating states of the air conditioner 6010, the devices in the infrared-operated device group 6050, and the devices in the network-connected device group 6060, which are to be operated by the operation device 6200.

(2-1-8) Switch

The switch 6260 is a switch for switching the operating state of the voice acceptance section 6210.

The switch 6260 is a push button switch, but this is not limiting. By pressing the switch 6260, the operating state of the voice acceptance section 6210 is switched between a sleep state in which no voice is accepted and an active state in which voice is acceptable.

The operating state of the voice acceptance section 6210 may be switched between the sleep state and the active state each time the switch 6260 is pressed. Alternatively, the operating state of the voice acceptance section 6210 may be switched from the sleep state to the active state for a predetermined time period when the switch 6260 is pressed.

The operation device 6200 may not have the switch 6260, and the operating state of the voice acceptance section 6210 may be always set to the active state. It is preferable that the operation device 6200 be provided with the switch 6260 to prevent the voice acceptance section 6210 from accepting voice at an unintended timing (to prevent malfunction of the air conditioner 6010 or the devices in the infrared-operated device group 6050 and the network-connected device group 6060).

(2-2) Air Conditioner

The air conditioner 6010 is an air conditioner that can be operated by inputting a voice instruction to the voice acceptance section 6210 of the operation device 6200. Non-limiting examples of the voice instruction include voice such as “turn air conditioning on” and “set the set temperature to 25° C.”. The air conditioner 6010 may be configured to be operable using a typical remote control in addition to operation via voice.

The air conditioner 6010 mainly has an indoor unit 6012, an outdoor unit 6014, a connection pipe (not illustrated) that connects the indoor unit 6012 and the outdoor unit 6014 to each other, and a controller 6150 (see FIG. 8 and FIG. 9).

The air conditioner 6010 is an apparatus that performs air-conditioning of a space to be air-conditioned. The space to be air-conditioned is, for example, a room where the indoor unit 6012 is arranged in the building 6000B.

In the air conditioner 6010, the indoor unit 6012 and the outdoor unit 6014 are connected to each other via the connection pipe, thereby connecting an indoor heat exchanger (not illustrated) of the indoor unit 6012 and a compressor, an outdoor heat exchanger, an expansion valve, and the like (not illustrated) of the outdoor unit 6014 to each other via a pipe. Consequently, a refrigerant circuit is formed. In the air conditioner 6010, refrigerant is circulated in the refrigerant circuit, thereby cooling/heating the space where the indoor unit 6012 is installed.

The operational principle and the content of the operation of the air conditioner 6010 using a vapor compression refrigeration cycle are widely known to the public and will not be described here. The air conditioner 6010 does not need to be an air conditioner capable of both cooling/heating the space to be air-conditioned, and may be a cooling-only or heating-only air conditioner.

In this embodiment, the air conditioner 6010 is configured such that in the indoor heat exchanger of the indoor unit 6012, refrigerant flowing in the indoor heat exchanger and air in the space to be air-conditioned exchange heat; however, the air conditioner is not limited to such a device. For example, the air conditioner 6010 may be an apparatus configured such that in the indoor heat exchanger of the indoor unit 6012 (fan coil unit), cold water/hot water flowing in the indoor heat exchanger and air in the space to be air-conditioned exchange heat.

The controller 6150 is a control apparatus that controls the operation of the air conditioner 6010.

The controller 6150 includes a control board (not illustrated) included in the indoor unit 6012 and a control board (not illustrated) included in the outdoor unit 6014. CPUs on the control boards or the like of the indoor unit 6012 and the outdoor unit 6014, which constitute the controller 6150, execute various programs stored in storage devices on the control boards or the like to execute various processing operations. Further, the controller 6150 includes devices and the like such as a wireless LAN adapter that functions as a communication unit 6170 described below.

The controller 6150 mainly has a communication unit 6170, an air conditioner control unit 6190, and the voice output unit 6140.

The communication unit 6170 is used to allow the air conditioner 6010 to communicate with mainly the air conditioner server 6030 (see FIG. 9).

The air conditioner 6010 (the communication unit 6170) is connected to the air conditioner server 6030 via the network 6080 (see FIG. 8). The air conditioner 6010 is connected to the router 6082 via a wireless LAN, and is connected to the network 6080 via the router 6082 (see FIG. 8). The air conditioner 6010 and the router 6082 may be connected via a wired LAN, rather than via a wireless LAN.

The communication unit 6170 is, for example, a wireless LAN adapter that performs wireless communication with the router 6082. The communication unit 6170 has, as functional units, a transmission unit 6170a that transmits information, and a reception unit 6170b that receives information (see FIG. 9).

The transmission unit 6170a preferably transmits information 6000J on the state quantity for at least one of the air conditioner 6010 and the space to be air-conditioned to the air conditioner server 6030 (see FIG. 9). Non-limiting examples of the state quantity for the air conditioner 6010 include temperatures/pressures of refrigerant measured by sensors (not illustrated) at various locations in the refrigerant circuit, the number of revolutions of an inverter-controlled motor (not illustrated) of the compressor of the outdoor unit 6014, and the opening degree of the expansion valve of the outdoor unit 6014. The state quantity for the space to be air-conditioned, includes, but not limited to, the measured temperature of the space to be air-conditioned.

The reception unit 6170b receives, for example, a command 6000C generated on the basis of the result of analysis of the signal 6000S by the analysis server 6020. Preferably, the reception unit 6170b receives the command 6000C generated by the air conditioner server 6030 on the basis of the result of analysis of the signal 6000S by the analysis server 6020 and on the basis of information 6000J on the state quantity transmitted from the transmission unit 6170a to the air conditioner server 6030.

For example, but not limitation, the command 6000C is related to at least one of turning on/off of the operation of the air conditioner 6010, switching among the operating modes (cooling/heating/dehumidification/ventilation, etc.) of the air conditioner 6010, changing of the set temperature (the target temperature of the space to be air-conditioned), a target value of the number of revolutions of the inverter-controlled motor (not illustrated) of the compressor of the outdoor unit 6014, a target value of the opening degree of the expansion valve of the outdoor unit 6014, and a target value of the number of revolutions of an inverter-controlled fan motor of the indoor unit 6012.

The air conditioner control unit 6190 controls the operation of the air conditioner 6010 in accordance with the command 6000C received by the reception unit 6170b, a command from a typical remote control (not illustrated), or the like. For example, the air conditioner control unit 6190 controls the operation of the compressor and expansion valve of the outdoor unit 6014, a fan of the indoor unit 6012, and so on in accordance with the command 6000C received by the reception unit 6170b on the basis of the settings of the air conditioner 6010 (such as the set temperature), values measured by various sensors (not illustrated), and so on.

The voice output unit 6140 has a speaker (not illustrated). The voice output unit 6140 outputs information (second information) concerning the content of the operation and/or the state of the air conditioner 6010 by voice. Items of information to be output by voice from the voice output unit 6140 are stored in a storage device (not illustrated), and the voice output unit 6140 outputs information for a predetermined item by voice. For example, in this embodiment, the voice output unit 6140 outputs second information concerning the operation start, operation stop, operating mode change of the air conditioner 6010 by sound. For example, the voice output unit 6140 outputs information indicating “the operation starts” by voice for the start of the operation of the air conditioner 6010, outputs information indicating “the operation stops” by voice for the stop of the operation of the air conditioner 6010, and outputs information concerning a changed operating mode by voice for the change of the operating mode of the air conditioner 6010 (such as “the setting was changed to the cooling mode”). The items of information to be output by voice from the voice output unit 6140 and the content of the voice are illustrative and not limitative.

(2-3) Infrared-Operated Device Group

The devices 6050a, 6050b, . . . , and 6050n in the infrared-operated device group 6050 are devices that can be operated using infrared signals. The devices 6050a, 6050b, . . . , and 6050n in the infrared-operated device group 6050 include, for example, but not limitation, an electric fan, a lighting device, an audio device, and a microwave oven. The devices 6050a, 6050b, . . . , and 6050n in the infrared-operated device group 6050 may not be connected to the network 6080.

The devices 6050a, 6050b, . . . , and 6050n in the infrared-operated device group 6050 are devices that can be operated using infrared signals transmitted from 6040 in response to input of voice instructions to the operation device 6200. Operations available by infrared signals include, for example, turning on/off the devices 6050a, 6050b, . . . , and 6050n, setting the airflow volume for an electric fan, setting the brightness of a lighting device, and setting the sound volume of an audio device.

The devices 6050a, 6050b, . . . , and 6050n in the infrared-operated device group 6050 may be configured to be operable with a typical infrared remote control or switches on the main bodies of the devices 6050a, 6050b, . . . , and 6050n in addition to operation via voice (in addition to operation using infrared signals transmitted from 6040 in accordance with voice instructions).

(2-4) Network-Connected Device Group

The devices 6060a, 6060b, . . . , and 6060m in the network-connected device group 6060 are devices that can be operated using signals transmitted via the network 6080. The devices 6060a, 6060b, . . . , and 6060m in the network-connected device group 6060 include, for example, but not limited to, a television set, a DVD recorder, a washing machine, a refrigerator, a hot water supply apparatus, and so on. For example, in this embodiment, the device 6060a is a DVD recorder. The devices 6060a, 6060b, . . . , and 6060m in the network-connected device group 6060 each have a wireless LAN adapter (not illustrated) and are connected to the network 6080 via the router 6082 (see FIG. 8). The devices 6060a, 6060b, . . . , and 6060m in the network-connected device group 6060 are communicably connected to at least one of the analysis server 6020 and the device server 6070 via the network 6080 (see FIG. 8). The devices 6060a, 6060b, . . . , and 6060m in the network-connected device group 6060 and the router 6082 may be connected via a wired LAN, rather than via a wireless LAN.

The devices 6060a, 6060b, . . . , and 6060m in the network-connected device group 6060 are operated using signals transmitted from the analysis server 6020 or the device server 6070 in response to input of voice instructions to the operation device 6200. Operations available by signals transmitted from the analysis server 6020 or the device server 6070 include, for example, turning on/off the devices 6060a, 6060b, . . . , and 6060m, changing the channel or volume level of a television set, and setting a programmed recording on a DVD recorder. The devices 6060a, 6060b, . . . , and 6060m in the network-connected device group 6060 may be configured to be operable with a commonly available remote control or switches on the main bodies of the devices 6060a, 6060b, . . . , and 6060m, in addition to operation via voice (in addition to operation by signals transmitted via the network 6080 in accordance with voice instructions).

The device 6060a is an example of a second device, and has the voice output unit 6062. The voice output unit 6062 has a speaker (not illustrated). The voice output unit 6062 outputs information (second information) concerning the content of the operation and/or the state of the device 6060a by voice. Items of information to be output by voice from the voice output unit 6062 is stored in a storage device (not illustrated), and the voice output unit 6062 outputs information for a predetermined item by voice. For example, in this embodiment, the voice output unit 6062 outputs second information concerning the setting of a programed recording on the device 6060a by voice. For example, the voice output unit 6062 outputs information indicating “record the program on channel X from Y o‘clock to Z o’clock” by voice for the setting of a programed recording on the device 6060a. The items of information to be output by voice from the voice output unit 6062 and the content of the voice are illustrative and not limitative.

(2-5) Analysis Server

The analysis server 6020 is communicably connected to the operation device 6200, the air conditioner 6010, the air conditioner server 6030, the device server 6070, and 6040 via the network 6080. When the operation device 6200 accepts a voice instruction for the air conditioner 6010, a device in the infrared-operated device group 6050, or a device in the network-connected device group 6060, the communication unit 6250 transmits the signal 6000S that is based on the voice instruction to the analysis server 6020 via the network 6080 (see FIG. 9).

The analysis server 6020 is a computer that executes a program stored in a storage device to analyze the received signal 6000S. Specifically, for example, the analysis server 6020 performs voice recognition of a received voice signal. Further, the analysis server 6020 may recognize the meaning of the received signal 6000S of a text data format.

The storage device of the analysis server 6020 stores, in addition to the program, for example, a list of devices (the air conditioner 6010, the devices 6050a, 6050b, . . . , and 6050n in the infrared-operated device group 6050, and the devices 6060a, 6060b, . . . , and 6060m in the network-connected device group 6060) that can be operated by each operation device 6200. That is, the analysis server 6020 knows which device can be operated by each operation device 6200. In addition, for the devices 6060a, 6060b, . . . , and 6060m in the network-connected device group 6060, information as to whether the device 6060a, 6060b, . . . , or 6060m to be controlled is a direct control target of the analysis server 6020 (a control target of either of the analysis server 6020 and the device server 6070) is also stored.

For example, the analysis server 6020 analyzes the voice represented by the signal 6000S to determine a feature value for the voice, and generates text information from the feature value by using a voice recognition dictionary stored in the storage device, which includes an acoustic model, a linguistic model, and a pronunciation dictionary. Non-limiting examples of the text information generated by the analysis server 6020 include text information such as “turn the air conditioner on”, “set the set temperature of the air conditioner to 25 degrees”, “turn the lighting device off”, and “turn the television set on”.

When the generated text information is related to control of the air conditioner 6010 (for example, when the text information includes an air-conditioner-related keyword), the analysis server 6020 transmits the analysis result of the signal 6000S (i.e., the generated text information) to the air conditioner server 6030 via the network 6080 (see FIG. 9).

When the text information is related to control of the device 6050a, 6050b, . . . , or 6050n in the infrared-operated device group 6050 (for example, when the text information includes a keyword related to the infrared-operated device group 6050), the analysis server 6020 transmits a command to 6040 to provide an instruction to transmit an infrared signal corresponding to the analysis result of the signal 6000S (i.e., the generated text information). For example, when the text information is information concerning a lighting device included in the devices 6050a, 6050b, . . . , and 6050n in the infrared-operated device group 6050 (for example, “turn the lighting device off”), the analysis server 6020 transmits a command to 6040 to transmit an infrared signal for instructing the lighting device to turn off. The command directed to 6040 is transmitted from the analysis server 6020 to 6040 via the network 6080. When transmitting a command from the analysis server 6020 to a device in the infrared-operated device group 6050 (to 6040), the analysis server 6020 preferably transmits the command information described above to the operation device 6200.

When the text information is related to control of the device 6060a, 6060b, . . . , or 6060m in the network-connected device group 6060 (for example, when the text information includes a keyword related to the network-connected device group 6060), the analysis server 6020 transmits a command corresponding to the analysis result of the signal 6000S (i.e., the generated text information) to the device 6060a, 6060b, . . . , or 6060m in the network-connected device group 6060. For example, when the text information is information concerning a television set included in the devices 6060a, 6060b, . . . , and 6060m in the network-connected device group 6060 (for example, “turn the television set on”), the analysis server 6020 transmits a command to the television set to provide an instruction to turn on the switch. Commands directed to the devices 6060a, 6060b, . . . , and 6060m in the network-connected device group 6060 are transmitted from the analysis server 6020 to the devices 6060a, 6060b, . . . , and 6060m in the network-connected device group 6060 via the network 6080. When transmitting a command from the analysis server 6020 to a device in the network-connected device group 6060, the analysis server 6020 preferably transmits the command information described above to the operation device 6200.

When the text information is related to control of the device 6060a, 6060b, . . . , or 6060m in the network-connected device group 6060 and the device 6060a, 6060b, . . . , or 6060m to be controlled is not a direct control target of the analysis server 6020, the text information is transmitted to the device server 6070 that controls the corresponding device 6060a, 6060b, . . . , or 6060m. Then, a command is transmitted from the device server 6070 to the corresponding device 6060a, 6060b, . . . , or 6060m via the network 6080.

(2-6) Air Conditioner Server

The air conditioner server 6030 generates the command 6000C on the basis of the result of analysis of the signal 6000S by the analysis server 6020 (i.e., the text information generated by the analysis server 6020), which is transmitted from the analysis server 6020, and on the basis of the information 6000J on the state quantity for at least one of the air conditioner 6010 and the space to be air-conditioned, which is transmitted as appropriate from the transmission unit 6170a of the air conditioner 6010. Then, the air conditioner server 6030 transmits the command 6000C to the reception unit 6170b of the air conditioner 6010 via the network 6080. For example, without limitation, upon receipt of the command “turn the air conditioner on” as text information, the air conditioner server 6030 determines the operation of the components of the air conditioner 6010 on the basis of the current temperature and the like of the space to be air-conditioned, and transmits the command as the command 6000C. When the command 6000C is transmitted from the air conditioner server 6030 to the air conditioner 6010 via the network 6080, the air conditioner server 6030 preferably transmits the command information described above to the operation device 6200.

Here, without limitation, the air conditioner server 6030 generates the command 6000C on the basis of the information 6000J in addition to the result of analysis of the signal 6000S by the analysis server 6020. The air conditioner server 6030 may generate the command 6000C on the basis of only the result of analysis of the signal 6000S by the analysis server 6020.

Further, the air conditioner server 6030 accumulates signals 6000S transmitted from the operation device 6200 and performs various analysis operations by using the signals 6000S.

In this embodiment, without limitation, the device system 6000 includes the air conditioner server 6030. For example, when the air conditioner 6010 is capable of directly determining the content of the operation on the basis of the result of analysis of the signal 6000S by the analysis server 6020 (i.e., the text information generated by the analysis server 6020), the air conditioner server 6030 may not be disposed. The result of analysis of the signal 6000S by the analysis server 6020 may be transmitted directly to the reception unit 6170b of the air conditioner 6010 as the command 6000C.

(2-7) Device Server

The device server 6070 generates a command for the device 6060a, 6060b, . . . , or 6060m in the network-connected device group 6060 on the basis of the result of analysis of the signal 6000S by the analysis server 6020 (i.e., the text information generated by the analysis server 6020), which is transmitted from the analysis server 6020. Then, the device server 6070 transmits the command to the operation target among the devices 6060a, 6060b, . . . , and 6060m in the network-connected device group 6060 via the network 6080. When the command 6000C is transmitted from the device server 6070 to the air conditioner 6010 via the network 6080, the device server 6070 preferably transmits the command information described above to the operation device 6200.

In FIG. 8, the number of device servers 6070 is one. However, if there is a plurality of types of the devices 6060a, 6060b, . . . , and 6060m to be operated by the device server 6070 (rather than in accordance with commands from the analysis server 6020), a number of device servers 6070 equal to the number of types are preferably present.

In addition, when all of the devices 6060a, 6060b, . . . , and 6060m are operable with commands from the analysis server 6020, the device server 6070 may not be present.

(2-8) Infrared Transmitter

6040 has a storage unit (not illustrated) that stores an infrared signal pattern for control for each of the devices 6050a, 6050b, . . . , and 6050n in the infrared-operated device group 6050 or for each of the operations to be performed on the devices 6050a, 6050b, . . . , and 6050n in the infrared-operated device group 6050. 6040 transmits an infrared signal to the operation target among the devices 6050a, 6050b, . . . , and 6050n in the infrared-operated device group 6050 in accordance with a command transmitted from the analysis server 6020 via the network 6080 by using the infrared signal pattern stored in the storage unit.

(3) Control of Sound Output by Sound Output Control Unit

The sound output control unit 6280 controls on/off of sound output or an output sound volume of the voice output unit 6220 of the operation device 6200 on the basis of the determination result of the determination unit 6270.

The control of sound output by the sound output control unit 6280 is performed in the following respects.

1. If the sound output from the sound output unit of the second device is not heard or almost not heard in the place where the first device is operated (for example, the place where the first device is installed), the first device preferably outputs information by voice. With this configuration, even when the operator operates the second device at a position away from the second device by using the first device, the operator is able to confirm that the second device has been correctly operated.

2. If the sound output from the sound output unit of the second device is heard in the place where the first device is operated, the first device does not need to output information by voice. In particular, if the content of information output from the first device corresponds to the content of information output from the second device, preferably, the first device does not output the information by voice.

3. If the sound output from the sound output unit of the second device is heard in the place where the first device is operated, but if the content of information output from the first device corresponds to the content of information that is not output from the second device, preferably, the first device outputs the information by voice. With this configuration, a failure, such as information to be transmitted being unsuccessfully transmitted to the operator, is less likely to occur.

In the above respects, for example, the sound output control unit 6280 controls sound output of the operation device 6200 in the following way.

For example, as in FIG. 10A, the installation of the operation device 6200 and the air conditioner 6010 in the same room, Room 1, is assumed to be stored in the position-related information storage area 6240a of the storage unit 6240. At this time, the determination unit 6270 determines that the operation device 6200 and the air conditioner 6010 have a predetermined positional relationship (a positional relationship in which the sound output from the first device and the sound output from the second device are likely to affect each other).

In this case, for example, the sound output control unit 6280 preferably controls the operation device 6200 to output third information, which is not related to an operation to be performed on the air conditioner 6010, with a first sound volume and not to output first information, which is related to an operation to be performed on the air conditioner 6010. For example, when the sound-output item storage area 6240b of the storage unit 6240 stores the sound output content information illustrated in FIG. 11, the sound output control unit 6280 preferably controls the operation device 6200 to output information on an item not related to an operation to be performed on the air conditioner 6010 (i.e., information concerning acceptance of a specific voice instruction, recorder-activation operation, programmed-recording-on-recorder setting operation, and recorder-stop operation) with a first sound volume (in the example illustrated in FIG. 10A, since the operation device 6200 and the DVD recorder (the device 6060a) are placed in different rooms, control of sound output of information related to an operation to be performed on the device 6060a is not particularly necessary). In contrast, the sound output control unit 6280 preferably controls the operation device 6200 not to output information on an item related to an operation to be performed on the air conditioner 6010 (information concerning air-conditioner operation-start operation, air-conditioner operation-stop operation, air-conditioner operating-mode-change operation, and air-conditioner set-temperature-change operation) by sound.

As an example of the method for preventing the voice output unit 6220 from outputting first information by sound, the sound output control unit 6280 may control a switch of the speaker 6220a of the voice output unit 6220 to be turned off at the timing when the voice output unit 6220 outputs first information by voice. As another example, the sound output control unit 6280 may control the sound volume of the speaker 6220a to zero at the timing when the voice output unit 6220 outputs first information by voice. As another example, the sound output control unit 6280 may create a list of items of information to be actually output by voice from the voice output unit 6220, separately from the sound output content information, and store the list in the storage unit 6240, and the item of the first information may be removed from the list.

Instead of controlling the operation device 6200 not to output first information by voice, the sound output control unit 6280 may control the operation device 6200 to output first information, which is related to an operation to be performed on the air conditioner 6010, with a second sound volume lower than the output sound volume (first sound volume) of the third information, which is not related to an operation to be performed on the air conditioner 6010.

More preferably, the sound output control unit 6280 preferably controls the operation device 6200 to output, within the first information related to an operation to be performed on the air conditioner 6010, information that does not overlap in content with second information output by sound from the air conditioner 6010 (for example, in the example illustrated in FIG. 11, information concerning air-conditioner set-temperature-change operation) with a third sound volume (for example, the same sound volume as the first sound volume described above). Further, the sound output control unit 6280 preferably controls the operation device 6200 not to output, within the first information, information that overlaps in content with the second information (for example, in the example illustrated in FIG. 11, information concerning air-conditioner operation-start operation, air-conditioner operation-stop operation, and air-conditioner operating-mode-change operation) by sound or to output such information with a fourth sound volume (for example, the same sound volume as the second sound volume described above) lower than the third sound volume.

Then, as in FIG. 10B, the installation of the operation device 6200 and the air conditioner 6010 in different rooms is assumed to be stored in the position-related information storage area 6240a of the storage unit 6240. At this time, the determination unit 6270 determines that the operation device 6200 and the air conditioner 6010 do not have a predetermined positional relationship.

In this case, the sound output control unit 6280 preferably controls the operation device 6200 to output the first information related to an operation to be performed on the air conditioner 6010, and the third information, which is not related to an operation to be performed on the air conditioner 6010, at least by sound. That is, the sound output control unit 6280 preferably controls the operation device 6200 to output information on all the items among the sound-output items for the operation device 6200 in the sound-output item information (unless any other second device is installed in the same room as that of the operation device 6200) at least by sound. More preferably, the sound output control unit 6280 preferably controls the operation device 6200 to output the first information related to an operation to be performed on the air conditioner 6010, and the third information, which is not related to an operation to be performed on the air conditioner 6010, with a relatively high sound volume (for example, the first sound volume described above).

(4) Features

While the features of the device management system 6001 are described here, taking the air conditioner 6010 as an example of a second device, similar features are obtained even when the second device is the device 6060a.

(4-1)

The device management system 6001 according to the embodiment described above is a system that manages the operation device 6200 that is an example of a first device having the voice output unit 6220 that is an example of a first sound output unit that outputs a sound, and the air conditioner 6010 that is an example of a second device different from the first device and having the voice output unit 6140 that is an example of a second sound output unit that outputs a sound. The device management system 6001 includes the determination unit 6270 and the sound output control unit 6280. The determination unit 6270 determines a positional relationship between the operation device 6200 and the air conditioner 6010. The sound output control unit 6280 controls on/off of sound output or an output sound volume of at least one of the operation device 6200 and the air conditioner 6010 on the basis of the determination result of the determination unit 6270. Here, in particular, the sound output control unit 6280 controls on/off of sound output or an output sound volume of the operation device 6200 on the basis of the determination result of the determination unit 6270.

In the device management system 6001, in accordance with the positional relationship between the operation device 6200 and the air conditioner 6010, on/off control of output of sound or control of the sound volume of at least one device 6200 or 6010 is performed. Thus, failures, such as sounds output from both devices 6200 and 6010 being overlapped and noisy, or the sound output from each of the devices 6200 and 6010 being difficult to hear, can be less likely to occur.

(4-2)

In the device management system 6001 according to the embodiment described above, the operation device 6200 is a remote control device that controls the operation of the air conditioner 6010. The voice output unit 6220 outputs at least first information concerning an operation to be performed on the air conditioner 6010 by sound. The voice output unit 6140 outputs second information concerning the content of the operation and/or the state of the air conditioner 6010 by sound.

Here, the operation device 6200 is a remote control device of the air conditioner 6010 that provides notification by sound indicating that, for example, an operation is performed on the air conditioner 6010, and the air conditioner 6010 is a device that provides notification of information concerning the content of the operation and/or the state thereof by sound. In this case, on/off control of output of sound or control of the sound volume of at least one device is performed. Thus, failures, such as sounds output from both devices 6200 and 6010 being overlapped and noisy, or relatively loud sounds output from both devices 6200 and 6010 annoying the operator, can be less likely to occur.

(4-3)

In the device management system 6001 according to the embodiment described above, the voice output unit 6220 outputs the third information, which is not related to an operation to be performed on the air conditioner 6010, by sound. When the determination unit 6270 determines that the operation device 6200 and the air conditioner 6010 have a predetermined positional relationship, the sound output control unit 6280 controls the operation device 6200 to output the third information with a first sound volume and not to output the first information by sound or to output the first information with a second sound volume lower than the first sound volume.

Here, the case where the operation device 6200 and the air conditioner 6010 have a predetermined positional relationship refers to a case where the operation device 6200 and the air conditioner 6010 have a positional relationship in which the sound output from the operation device 6200 and the sound output from the air conditioner 6010 are likely to affect each other. The case where the operation device 6200 and the air conditioner 6010 have a predetermined positional relationship includes, for example, but not limitation, a case where the distance between the operation device 6200 and the air conditioner 6010 is smaller than a predetermined distance, and a case where the operation device 6200 and the air conditioner 6010 are arranged in the same region.

Here, when the operation device 6200 and the air conditioner 6010 are determined to have a predetermined positional relationship, within the information output from the operation device 6200, the first information related to an operation to be performed on the air conditioner 6010 is controlled so as not to be output by sound or to be output with a reduced sound volume. Thus, failures, such as sounds output from both devices 6200 and 6010 being overlapped and noisy, or relatively loud sounds output from both devices 6200 and 6010 annoying the operator, can be less likely to occur.

(4-4)

In the device management system 6001 according to the embodiment described above, when the determination unit 6270 determines that the operation device 6200 and the air conditioner 6010 do not have a predetermined positional relationship, the sound output control unit 6280 controls the operation device 6200 to output the first information and the third information at least by sound.

Here, when the operation device 6200 and the air conditioner 6010 are determined not to have a predetermined positional relationship, in other words, when the sound output from the operation device 6200 and the sound output from the air conditioner 6010 are determined not to affect each other, both the first information and the third information are output by sound. Thus, even when the operator operates the air conditioner 6010 at a position away from the air conditioner 6010 by using the operation device 6200, the operator easily confirms that operation for the air conditioner 6010 has been correctly operated.

(4-5)

In the device management system 6001 according to the embodiment described above, when the determination unit 6270 determines that the operation device 6200 and the air conditioner 6010 have a predetermined positional relationship, the sound output control unit 6280 controls the operation device 6200 to output information that is included in the first information and that does not overlap in content with the second information with a third sound volume and not to output information that is included in the first information and that overlaps in content with the second information by sound or to output the information with a fourth sound volume lower than the third sound volume.

Here, when the operation device 6200 and the air conditioner 6010 are determined to have a predetermined positional relationship, a sound that is included in the first information concerning an operation to be performed on the air conditioner 6010, which is output from the operation device 6200, the sound not being output as information from the air conditioner 6010, is output with a relatively high sound volume. In the device management system 6001, accordingly, a failure, such as information to be transmitted being unsuccessfully transmitted to the operator, can be less likely to occur.

(4-6)

The device management system 6001 according to the embodiment described above includes the storage unit 6240. The storage unit 6240 stores position-related information concerning the position of at least one of the operation device 6200 and the air conditioner 6010. Here, in particular, the storage unit 6240 stores position-related information concerning the positions of the operation device 6200 and the air conditioner 6010. The determination unit 6270 determines a positional relationship between the operation device 6200 and the air conditioner 6010 on the basis of the position-related information stored in the storage unit 6240.

Here, the positional relationship between both devices 6200 and 6010 is likely to be correctly understood on the basis of the position-related information stored in the storage unit 6240, and failures, such as sounds output from both devices 6200 and 6010 being overlapped and noisy, or the sound output from each of the devices 6200 and 6010 being difficult to hear, are less likely to occur with ease.

(5) Modifications

The following describes modifications of the embodiment described above. The modifications may be combined as appropriate so long as consistency is maintained between them.

(5-1) Modification 7A

In the device management system 6001 according to the embodiment described above, the determination unit 6270 determines a positional relationship between the first device and the second device on the basis of position-related information stored in the storage unit 6240. However, the method of determining the positional relationship by the determination unit 6270 is not limited to the method described above.

For example, the device management system 6001 may have a camera on the first device or the second device or near the first device or the second device, and the determination unit 6270 may determine that the other device appearing in an image captured with the camera (the second device when the camera is disposed on the first device side, or the first device when the camera is disposed on the second device side) is a device having a predetermined positional relationship with the device associated with the camera.

Further, for example, in the device management system 6001, the voice acceptance section 6210 may measure sounds output from second devices, and the determination unit 6270 may determine that a second device for which the level of the measured sound is greater than a predetermined value is a device having a predetermined positional relationship with the operation device 6200 (first device).

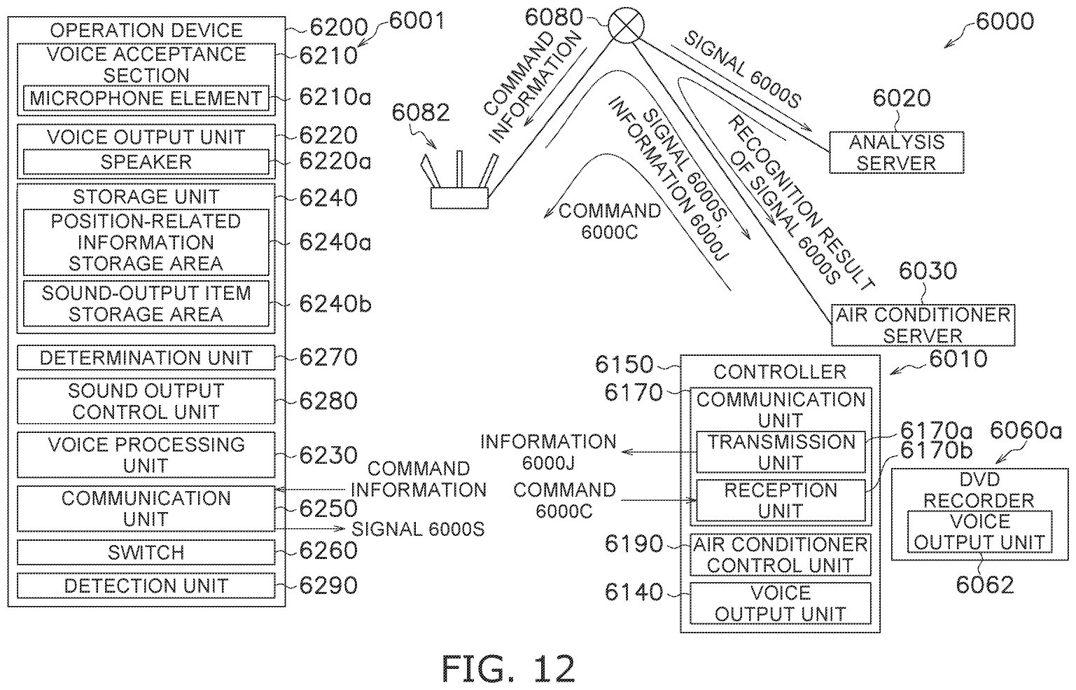

Further, for example, the device management system 6001 may include a detection unit that detects the position of at least one of the first device (the operation device 6200) and the second device by using GPS, indoor positioning technique such as Wi-Fi positioning using a plurality of wireless LAN access points, or the like. For example, when the operation device 6200, which is the first device, is a wearable (for example, wristwatch-type) device, the operation device 6200 may be provided with a detection unit 6290 (see FIG. 12) that detects the position of the operation device 6200. The determination unit 6270 may determine the positional relationship between the operation device 6200 and the air conditioner 6010 on the basis of the detection result of the detection unit 6290.

In the device management system 6001 having the configuration described above, the positional relationship between both devices 6200 and 6010 is likely to be correctly understood on the basis of the result of detecting the positions of the devices 6200 and 6010, and failures, such as sounds output from both devices 6200 and 6010 being overlapped and noisy, or the sound output from each of the devices 6200 and 6010 being difficult to hear, are less likely to occur with ease.

(5-2) Modification 7B

In the embodiment described above, without limitation, the device management system 6001 is a system capable of operating the air conditioner 6010, the devices in the infrared-operated device group 6050, and the devices in the network-connected device group 6060 via voice instructions.

For example, in the device management system 6001, some of the air conditioner 6010, the devices in the infrared-operated device group 6050, and the devices in the network-connected device group 6060 may not be operation targets. When some of the air conditioner 6010, the devices in the infrared-operated device group 6050, and the devices in the network-connected device group 6060 are no longer operation targets, a component that is no longer necessary (for example, 6040, the air conditioner server 6030, or the device server 6070) may be removed from the configuration of the device system 6000.

(5-3) Modification 7C

In the embodiment described above, without limitation, the analysis server 6020, the air conditioner server 6030, and the device server 6070 in the device system 6000 are separate servers. For example, one server may function as the analysis server 6020 and the air conditioner server 6030, or function as the analysis server 6020, the air conditioner server 6030, and the device server 6070.

Conversely, the function of each of the analysis server 6020, the air conditioner server 6030, and the device server 6070 described in the above embodiment may be achieved by a plurality of servers rather than by a single server.

(5-4) Modification 7D

In the device management system 6001 according to the embodiment described above, the air conditioner 6010 and the device 6060a (DVD recorder) are taken as examples of a second device. However, these devices are merely examples and are not to be limiting.

The second device may be any device having a sound output unit, and is not limited in product type. For example, the second device may be a device in the infrared-operated device group 6050 of the embodiment described above (such as an electric fan, a lighting device, an audio device, or a microwave oven) or a device in the network-connected device group 6060 other than a DVD recorder (such as a television set, a refrigerator, a washing machine, or a hot water supply apparatus) so long as the second device has a sound output unit.

(5-5) Modification 7E

In the device management system 6001 according to the embodiment described above, the air conditioner 6010 and the device 6060a (DVD recorder) are taken as examples of a second device, and the operation device 6200 serving as a remote control device that controls the operation of the air conditioner 6010 and the device 6060a is taken as an example of a first device. However, these devices are merely examples and are not to be limiting. For example, the first device and the second device may be devices that do not have a relationship in which one of them operates the other.

For example, as a specific example, the first device is an acoustic device installed in a theater or a concert hall and having a speaker as a sound output unit. The sound output unit of the acoustic device outputs music, lines in a movie, or the like as sounds. The second device is a mobile communication device such as a smartphone having a speaker that outputs a ringtone or the like. A detection unit of the smartphone detects the position of the smartphone by using, for example, the GPS function or the like of the smartphone, and a determination unit of the smartphone determines a positional relationship between the acoustic device and the smartphone on the basis of the result of detecting the position. For example, the determination unit of the smartphone determines whether the smartphone is in a theater or a concert hall on the basis of the result of detecting the position of the smartphone to determine the positional relationship between the acoustic device and the smartphone (whether the acoustic device and the smartphone are in the same space). Then, for example, a sound output control unit of the smartphone turns off sound output of the smartphone on the basis of the determination result of the determination unit of the smartphone.

With this configuration, failures, such as the sound output from the acoustic device overlapped with the ringtone or the like of the mobile communication device being noisy, or the sound output from the acoustic device being difficult to hear, can be less likely to occur.

(5-6) Modification 7F

In the embodiment described above, the signal 6000S that is based on a voice instruction is transmitted from the operation device 6200 to the analysis server 6020, and the analysis server 6020 performs recognition processing of the signal 6000S. However, the device management system 6001 is not limited to this configuration.

For example, the operation device 6200 may have a recognition function similar to that of the analysis server 6020, and the operation device 6200 may execute processing similar to that of the analysis server 6020 described above.

Alternatively, the operation device 6200 may have the function of the air conditioner server 6030 or the device server 6070 in addition to the function of the analysis server 6020.

(5-7) Modification 7G

The device management system 6001 according to the embodiment described above is a system capable of voice operation of the air conditioner 6010 and the like. However, this is not intended to be limiting. For example, the operation device 6200 of the device management system 6001 may be a device capable of operating the air conditioner 6010 and the like using button operation or text input, rather than voice input.

(5-8) Modification 7H

In the device management system 6001 according to the embodiment described above, the operation device 6200 is provided with the sound output control unit 6280 that controls sound output of the operation device 6200. However, the sound output control unit may be disposed in any other location within the device system 6000.

For example, in the embodiment described above, the voice output unit 6220 outputs information by sound in accordance with command information. Thus, the sound output control unit may be disposed in on the server side such as the analysis server 6020, the air conditioner server 6030, or the device server 6070. On the server side, such as the analysis server 6020, the air conditioner server 6030, or the device server 6070, control may be performed such that command information that should not be output by sound from the operation device 6200 is not transmitted to the operation device 6200.

Further, the determination unit 6270 may also not necessarily be mounted in the operation device 6200, and, for example, the server 6020, 6030, or 6070, any other server, or the like may determine a positional relationship between the operation device 6200 and the second device.

(5-9) Modification 71

In the device system of the embodiment described above, sound output of the operation device 6200 is controlled. However, this is not intended to be limiting, and a sound output control unit may be used to control sound output of the second device (for example, the air conditioner 6010 or the device 6060a).

For example, when the determination unit 6270 determines that the operation device 6200 and the second device have a predetermined positional relationship, the sound output control unit 6280 of the operation device 6200 may transmit a command to the second device (for example, the air conditioner 6010) to prohibit the voice output unit 6140 from performing output operation.

Further, for example, on the air conditioner server 6030 or the device server 6070 side, it may be determined whether the operation device 6200 and the second device have a predetermined positional relationship, and a command may be transmitted to the second device to prohibit the voice output unit from outputting voice.

(5-10) Modification 7J

In the embodiment described above, without limitation, the sound output units of the first device and the second device mainly output voice (verbal sounds). The sound output units of the first device and the second device may mainly output information by using a beep sound or the like.

### Fifth Embodiment

In the device management system 6001 according to the fifth embodiment, the determination unit 6270 determines a positional relationship between the first device and the second device, and the sound output control unit 6280 controls on/off of sound output or an output sound volume of at least one of the first device and the second device on the basis of the determination result of the determination unit 6270. For example, in an aspect, the determination unit 6270 determines a positional relationship between the operation device 6200 and the air conditioner 6010, and the sound output control unit 6280 control on/off of sound output or an output sound volume of the operation device 6200 on the basis of the determination result of the determination unit 6270.

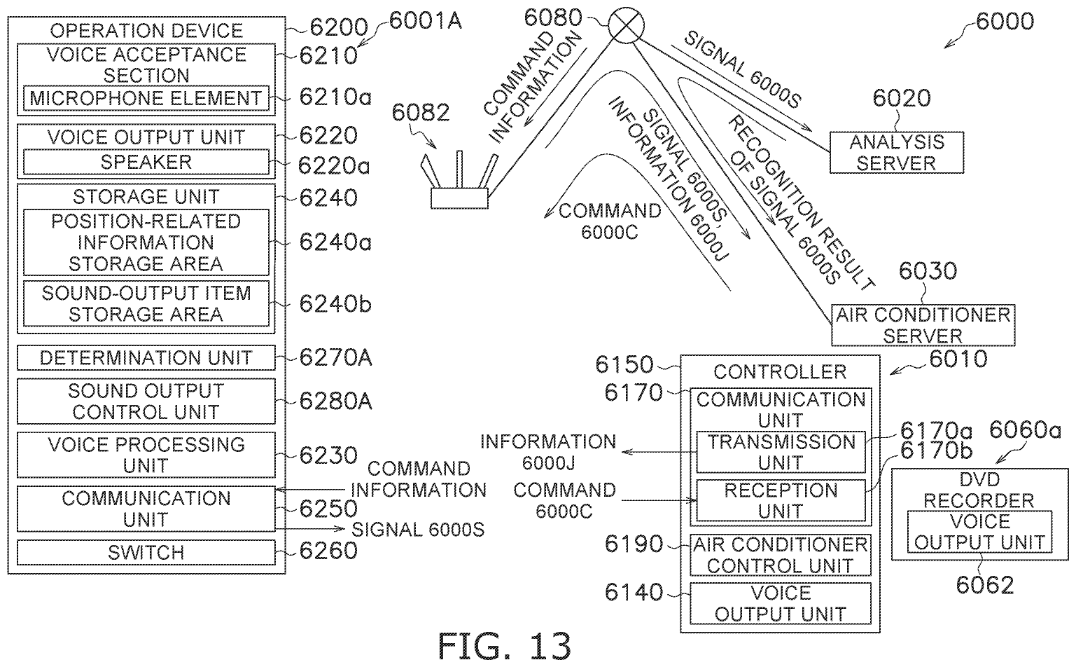

However, this is not limiting, and a device management system 6001A (see FIG. 13) may be configured as follows. The device management system 6001A is the same as that of the fourth embodiment, except for a determination unit 6270A and a sound output control unit 6280A. Thus, the difference between the device management system 6001A and the device management system 6001 (the determination unit 6270A and the sound output control unit 6280A) will be described mainly, and most of the rest will not be described.

In the device management system 6001A, the target determined by the determination unit 6270A is different from that of the determination unit 6270 of the fourth embodiment. Unlike the determination unit 6270, the determination unit 6270A determines the degree of interference of one of the sound output from the first device and the sound output from the second device with the other of the sound output from the first device and the sound output from the second device. The degree of interference of one of the sound output from the first device and the sound output from the second device with the other of the sound output from the first device and the sound output from the second device refers to the degree to which the sound output from one device interferes with the hearing of the sound output from the other device (for example, the degree to which the sound output from the first device interferes with the hearing of the sound output from the second device). The sound output control unit 6280A controls on/off of sound output or an output sound volume of at least one of the first device and the second device on the basis of the determination result of the determination unit 6270A.

A detailed description will be made hereinafter. In the following, a description will be made assuming that the operation device 6200 is an example of the first device and the air conditioner 6010 is an example of the second device.

In the device management system 6001A, the determination unit 6270A determines the degree of interference of one of the sound output from the voice output unit 6220 of the operation device 6200 and the sound output from the voice output unit 6140 of the air conditioner 6010, which is an example of the second device, with the other of the sound output from the voice output unit 6220 of the operation device 6200 and the sound output from the voice output unit 6140 of the air conditioner 6010. In particular, in the device management system 6001A of this embodiment, the determination unit 6270A determines the degree of interference of the sound output from the voice output unit 6140 of the air conditioner 6010 with the sound output from the voice output unit 6220 of the operation device 6200. However, in another embodiment, the determination unit 6270A (or a determination unit (not illustrated) disposed outside the operation device 6200) may determine the degree of interference of the sound output from the voice output unit 6220 of the operation device 6200 with the sound output from the voice output unit 6140 of the air conditioner 6010. Alternatively, the determination unit 6270A (or a determination unit (not illustrated) disposed outside the operation device 6200) may determine both the degree of interference of the sound output from the voice output unit 6140 of the air conditioner 6010 with the sound output from the voice output unit 6220 of the operation device 6200 and the degree of interference of the sound output from the voice output unit 6220 of the operation device 6200 with the sound output from the voice output unit 6140 of the air conditioner 6010.

In the device management system 6001A, furthermore, the sound output control unit 6280A controls on/off of sound output or an output sound volume of at least one of the operation device 6200 and the air conditioner 6010 on the basis of the determination result of the determination unit 6270A. For example, here, the sound output control unit 6280A controls on/off of sound output or an output sound volume of the air conditioner 6010 (more specifically, the voice output unit 6140 of the air conditioner 6010) on the basis of the determination result of the determination unit 6270A. The sound output control unit 6280A is configured to be capable of controlling on/off, the output sound volume, or the like of the voice output unit 6140 of the air conditioner 6010 via the air conditioner server 6030 or by communicating directly with the controller 6150. The sound output control unit 6280A controls on/off of sound output or an output sound volume of the air conditioner 6010 when the determination unit 6270A determines that the degree of interference of the sound output from the voice output unit 6140 of the air conditioner 6010 with the sound output from the voice output unit 6220 of the operation device 6200 (hereinafter sometimes referred to simply as degree of interference, for simplicity of description) is equal to a predetermined degree. The sound output control unit 6280A may control on/off of sound output or an output sound volume of the operation device 6200 when the determination unit 6270A determines that the degree of interference is equal to a predetermined degree.

The determination of whether the degree of interference is equal to a predetermined degree by the determination unit 6270A and the control of on/off of sound output or output sound volume by the sound output control unit 6280A are performed in the following way, for example.

In an example, in the device management system 6001A, the operation device 6200 attempts to acquire the sound output from the voice output unit 6140 of the air conditioner 6010 by using the microphone element 6210a, and the determination unit 6270A determines whether the degree of interference is equal to a predetermined degree on the basis of the sound acquired by the microphone element 6210a. In an embodiment, but not limitation, when a voice instruction is input to the microphone element 6210a of the voice acceptance section 6210 of the operation device 6200 from the voice output unit 6140 of the air conditioner 6010 to output a test sound, the operation device 6200 generates the signal 6000S based on the voice instruction, and transmits the signal 6000S from the communication unit 6250 to the analysis server 6020. The analysis server 6020 executes voice recognition processing of the received signal 6000S. Then, the analysis server 6020 or the air conditioner server 6030 generates the command 6000C for the operation target air conditioner 6010 (a command for requesting the voice output unit 6140 to output a test sound) on the basis of the result of the voice recognition processing of the analysis server 6020, and transmits the command 6000C to the air conditioner 6010. Upon receipt of the command 6000C, the voice output unit 6140 of the air conditioner 6010 outputs a test sound for a predetermined time period. On the other hand, the microphone element 6210a of the operation device 6200 attempts to acquire the test sound output from the voice output unit 6140 of the air conditioner 6010.

For example, if the test sound output from the voice output unit 6140 of the air conditioner 6010 is successfully acquired, the determination unit 6270A determines that the degree of interference is equal to a predetermined degree. Alternatively the determination unit 6270A may determine that the degree of interference is equal to a predetermined degree not only when the test sound is successfully acquired but also when the sound level of the acquired test sound is determined to be greater than a predetermined volume. Then, the sound output control unit 6280 performs control to turn off sound output of the air conditioner 6010 or control to decrease the output sound volume on the basis of the determination result of the determination unit 6270A (when the degree of interference is determined to be equal to a predetermined degree). In this aspect, the sound output from the voice output unit 6140 of the air conditioner 6010 is not heard or is relatively weak around the operation device 6200, and thus interference with hearing of the sound output from the voice output unit 6220 of the operation device 6200 is less likely to occur.

In another aspect, the device management system 6001A may attempt to acquire the sound output from the voice output unit 6140 of the air conditioner 6010 by using a microphone element (not illustrated) placed at a position different from that of the microphone element 6210a (for example, within a room where the air conditioner 6010 and the operation device 6200 are installed and at a position away from the air conditioner 6010 and the operation device 6200), and the determination unit 6270A may perform determination similar to that described above on the basis of the result of the sound acquired by the microphone element (not illustrated). In this aspect, the sound output from the voice output unit 6140 of the air conditioner 6010 is not heard or is relatively weak around the installation location of the microphone element (for example, in a space where the user of the device management system 6001 mainly performs activities), and thus interference with hearing of the sound output from the voice output unit 6220 of the operation device 6200 is less likely to occur.

In still another aspect, the device management system 6001A attempts to acquire an output sound of information (second information) concerning the content of the operation and/or the state of the air conditioner 6010, which is output from the voice output unit 6140 of the air conditioner 6010 at the timing when the voice output unit 6220 outputs information (first information) concerning an operation to be performed on the air conditioner 6010 by voice, by using a microphone element (the microphone element 6210a or a microphone element (not illustrated) different from the microphone element 6210a). If the microphone element acquires the sound output from the voice output unit 6140, the determination unit 6270A may determine that the degree of interference is equal to a predetermined degree. In this case, the sound output control unit 6280A may execute control to shift the timing of sound output of the air conditioner 6010 on the basis of the determination result of the determination unit 6270A, instead of performing control to turn off sound output of the air conditioner 6010 or control to decrease the output sound volume on the basis of the determination result of the determination unit 6270A. In this aspect, the sound output from the voice output unit 6140 of the air conditioner 6010 overlapped with the sound output from the voice output unit 6220 of the operation device 6200 is not heard around the installation location of the microphone element, and thus interference with hearing of the sound output from the voice output unit 6220 of the operation device 6200 is less likely to occur.

In still another aspect, the determination unit 6270A may determine the degree of interference without measurement of sounds on the basis of the positional relationship between the first device and the second device or the aspect exemplified in Modification 7A. For example, when the distance between the first device and the second device is smaller than a predetermined distance, the determination unit 6270A may determine that the degree of interference of one of the sound output from the first device and the sound output from the second device with the other of the sound output from the first device and the sound output from the second device is equal to a predetermined degree. In addition, for example, when the first device and the second device are arranged in the same room, the determination unit 6270A may determine that the degree of interference of one of the sound output from the first device and the sound output from the second device with the other of the sound output from the first device and the sound output from the second device is equal to a predetermined degree.

When the determination unit 6270A determines that the degree of interference of one of the sound output from the first device and the sound output from the second device with the other of the sound output from the first device and the sound output from the second device is equal to a predetermined degree, as in the fourth embodiment, the sound output control unit 6280A may control the first device (for example, the operation device 6200 as an example of a remote control device) to output the third information described above (information not related to an operation to be performed on the second device) with a first sound volume and not to output the first information described above (information related to an operation to be performed on the second device) by sound or to output the first information with a second sound volume lower than the first sound volume.

Alternatively, when the determination unit 6270A determines that the degree of interference of one of the sound output from the first device and the sound output from the second device with the other of the sound output from the first device and the sound output from the second device is not equal to the predetermined degree, as in the fourth embodiment, the sound output control unit 6280A may control the first device (for example, the operation device 6200 as an example of a remote control device) to output the first information and the third information described above at least by sound.

Alternatively, when the determination unit 6270A determines that the degree of interference of one of the sound output from the first device and the sound output from the second device with the other of the sound output from the first device and the sound output from the second device is equal to a predetermined degree, as in the fourth embodiment, the sound output control unit 6280A may control the first device (for example, the operation device 6200 as an example of a remote control device) to output information that is included in the first information described above and that does not overlap in content with the second information output by sound from the second device (information concerning the content of the operation and/or the state of the second device) with a third sound volume and not to output information that is included in the first information described above and that overlaps in content with the second information described above by sound or to output the information with a fourth sound volume lower than the third sound volume.

In the fifth embodiment, the storage unit 6240 may store interference-related information concerning the degree of interference of one of the sound output from the first device and the sound output from the second device with the other of the sound output from the first device and the sound output from the second device. The determination unit 6270A may determine the degree of interference of one of the sound output from the first device and the sound output from the second device with the other of the sound output from the first device and the sound output from the second device on the basis of the interference-related information stored in the storage unit 6240.

The configurations of the fourth embodiment and its modifications may be applied to the device management system 6001A according to the fifth embodiment so long as consistency is maintained between them.

### Other Embodiments

The embodiments and modifications described above for purposes of illustration may be combined as appropriate so long as consistency is maintained between them.

<Additional Remarks>

While embodiments have been described, it will be understood that various changes in the form or in the details may be made without departing from the spirit and scope of the claims.

### INDUSTRIAL APPLICABILITY

The air conditioner according to the first aspect through the seventeenth aspect is suitable for use as an air conditioner that can be operated via voice.

The air conditioner according to the eighteenth aspect through the twenty-seventh aspect and the operation apparatus according to the twenty-eighth aspect through the thirtieth aspect are suitable for use as an air conditioner that is voice-operable and an operation apparatus that enables an air conditioner to be operated via voice.

The air-conditioning system according to the thirty-first aspect through the thirty-ninth aspect and the air conditioner according to the fortieth aspect are suitable for use as an air-conditioning system that enables an air conditioner to be operated via voice and an air conditioner that is voice-operable.

The communication system according to the forty-first aspect through the forty-fourth aspect and the transmission apparatus according to the forty-fifth aspect through the forty-sixth aspect are suitable for use as a communication system and a transmission apparatus that are capable of reducing the occurrence of communication failures regardless of the state of traffic of a communication line and that are capable of transmitting desired information without time and labor.

The control system according to the forty-seventh aspect through the fifty-sixth aspect is suitable for use as a high-reliability control system.

The control system according to the fifty-seventh aspect through the sixty-third aspect is suitable for use as a high-convenience device control system.

The device management system according to the sixty-fourth aspect through the seventy-first aspect is suitable since even when a plurality of devices that output sounds are present, failures, such as the sounds output from the devices being overlapped and noisy, or the sound output from each of the devices being difficult to hear, can be less likely to occur.

The device management system according to the seventy-second aspect through the eighty-fourth aspect is suitable for use as a system capable of accurately recognizing the surroundings of an air conditioner.

### REFERENCE SIGNS LIST

1010 air conditioner
1012, 1012′ indoor unit
1018 controller (air conditioner control unit)
1020 analysis server (analysis apparatus)
1030 air conditioner server (command generation apparatus)
1080 network
1100, 1100′ main body
1120, 1120′ blow-out port
1200 operation unit (operation apparatus)
1210 voice acceptance section
1210a microphone element
1220 notification unit
1230a transmission unit
1230b reception unit
1240 voice processing unit (voice compression unit)
1250 command transmission unit
1260 switch
1300 cable unit
1000C command
1000J information
1000S signal
2010 air conditioner
2010a air-conditioning system
2020 analysis server (analysis apparatus)
2030 air conditioner server (command generation apparatus)
2080 network
2150 controller
2160 first information reception unit
2170a transmission unit (second information transmission unit, state-quantity information
transmission unit)
2170b reception unit (command receiving unit)
2180 processing unit
2190 air conditioner control unit
2200 operation unit (voice acceptance unit)
2210 voice acceptance section
2220 notification unit
2250 first information transmission unit
2000C command
2000J information
2000S1 first information
2000S2 second information
3001 device operation/communication system
3020 analysis server (reception apparatus)
3022 recognition unit
3024 communication unit (reception unit, signal output unit)
3080 network (communication line)
3200 operation/communication device (transmission apparatus, reception apparatus)
3210 voice acceptance section
3220 voice output unit
3222 setting unit
3224 voice database (storage unit)
3230 voice processing unit (text conversion unit)
3240 switching unit
3250 communication unit (transmission unit, reception unit)
3270 determination unit
3300 operation/communication device (reception apparatus, transmission apparatus)
6001 device management system
6010 air conditioner (second device)
6060a DVD recorder (second device)
6062 voice output unit (second sound output unit)
6140 voice output unit (second sound output unit)
6200 operation device (first device)
6220 voice output unit (first sound output unit)
6240 storage unit
6270 determination unit
6280 sound output control unit
6290 detection unit

### CITATION LIST

1. An air conditioner including an indoor unit having a main body having formed therein a blow-out port through which air-conditioned air is blown out toward a space to be air-conditioned, the air conditioner comprising:
an electronic controller including a microphone that accepts input of a voice instruction, the electronic controller being arranged outside the main body;
a cable that communicably connects the indoor unit and the electronic controller to each other;
a transmitter that transmits a signal that is based on the voice instruction accepted by the microphone, the signal being transmitted externally of the air conditioner;
a receiver that receives a command corresponding to the signal transmitted from the transmitter from externally of the air conditioner; and
an air conditioner controller that controls an operation of the air conditioner in accordance with the command.

2. An air-conditioning system comprising:
an air conditioner including a controller; and
a microphone including a voice acceptance section that accepts a voice instruction for the air conditioner, and
a first information transmitter that transmits first information corresponding to the voice instruction accepted by the voice acceptance section to the controller via wireless communication,
the controller including
a first information receiver that receives the first information transmitted from the first information transmitter,
a processor that executes specific processing on the first information accepted by the first information receiver to generate second information having a smaller information amount than the first information,
a second information transmitter that transmits the second information, the second information being transmitted externally of the air conditioner,
a command receiver that receives a command corresponding to the second information transmitted from the second information transmitter from externally of the air conditioner, and
an air conditioner controller that controls an operation of the air conditioner in accordance with the command.

3. A communication system comprising:
a transmission apparatus including a microphone that accepts input of voice, a processor that converts the voice accepted by the microphone into a text data format, and a transmitter that transmits data based on the voice accepted by the microphone via a communication line, the processor being configured to switch a format of the data transmitted from the transmitter between a voice data format and the text data format; and
a reception apparatus including a receiver that receives the data transmitted from the transmitter of the transmission apparatus.

4. A device management system that manages a first device including a first speaker that outputs a sound, and a second device different from the first device, the second device including a second speaker that outputs a sound, the device management system comprising:
a processor that determines a positional relationship between the first device and the second device; and
the processor controlling on/off of sound output or an output sound volume of at least one of the first device and the second device based on a determination result of the processor.
